(19) United States
(12) Patent Application Publication
(10) Pub. No.: US 2014/0075567 A1
(43) Pub. Date: Mar. 13, 2014

(54) Service Processor Configurations for Enhancing or Augmenting System Software of a Mobile Communications Device

(71) Applicant: Headwater Partners I LLC, Redwood Shores, CA (US)

(72) Inventors: Gregory G. Raleigh, Woodside, CA (US); James Fitzgerald, San Francisco, CA (US); Nathaniel Hunsperger, San Francisco, CA (US); James Lavine, Corte Madera, CA (US); Vien-Phuong Nguyen, Newark, CA (US); Jose Tellado, Mountain View, CA (US)

(73) Assignee: Headwater Partners I LLC, Redwood Shores, CA (US)

(21) Appl. No.: 14/083,324

(22) Filed: Nov. 18, 2013

Related U.S. Application Data
(63) Continuation-in-part of application No. 12/380,780, filed on Mar. 2, 2009.
Application No. 12/380,780 is a continuation-in-part of application No. 13/674,808, filed on Nov. 12, 2012, now Pat. No. 8,634,821.
Application No. 13/674,808 is a continuation-in-part of application No. 13/247,998, filed on Sep. 28, 2011.
Application No. 13/247,998 is a continuation-in-part of application No. 13/374,959, filed on Jan. 24, 2012, now Pat. No. 8,606,911.
Application No. 13/674,808 is a continuation of application No. 12/694,455, filed on Jan. 27, 2010, now Pat. No. 8,402,111.
Application No. 13/247,998 is a continuation-in-part of application No. 12/380,759, filed on Mar. 2, 2009, now Pat. No. 8,270,310.
Application No. 12/380,759 is a continuation-in-part of application No. 12/380,779, filed on Mar. 2, 2009.
Application No. 12/380,779 is a continuation-in-part of application No. 12/380,758, filed on Mar. 2, 2009.
Application No. 12/380,758 is a continuation-in-part of application No. 12/380,778, filed on Mar. 2, 2009, now Pat. No. 8,321,526.
Application No. 12/380,778 is a continuation-in-part of application No. 12/380,768, filed on Mar. 2, 2009.
Application No. 12/380,768 is a continuation-in-part of application No. 12/380,767, filed on Mar. 2, 2009, now Pat. No. 8,355,337.
Application No. 12/380,767 is a continuation-in-part of application No. 12/380,780, filed on Mar. 2, 2009.
Application No. 12/380,780 is a continuation-in-part of application No. 12/380,755, filed on Mar. 2, 2009, now Pat. No. 8,331,901.
Application No. 12/380,755 is a continuation-in-part of application No. 12/380,756, filed on Mar. 2, 2009, now Pat. No. 8,250,207.
Application No. 12/380,756 is a continuation-in-part of application No. 12/380,770, filed on Mar. 2, 2009, now abandoned.
Application No. 12/380,770 is a continuation-in-part of application No. 12/380,772, filed on Mar. 2, 2009.
Application No. 12/380,772 is a continuation-in-part of application No. 12/380,782, filed on Mar. 2, 2009, now Pat. No. 8,270,952.
Application No. 12/380,782 is a continuation-in-part of application No. 12/380,783, filed on Mar. 2, 2009.
Application No. 12/380,783 is a continuation-in-part of application No. 12/380,757, filed on Mar. 2, 2009, now Pat. No. 8,326,958.
Application No. 12/380,757 is a continuation-in-part of application No. 12/380,781, filed on Mar. 2, 2009, now Pat. No. 8,229,812.
Application No. 12/380,781 is a continuation-in-part of application No. 12/380,774, filed on Mar. 2, 2009, now Pat. No. 8,630,192.
Application No. 12/380,774 is a continuation-in-part of application No. 12/380,773, filed on Mar. 2, 2009.
Application No. 12/380,773 is a continuation-in-part of application No. 12/380,769, filed on Mar. 2, 2009.
Application No. 12/380,769 is a continuation-in-part of application No. 12/380,777, filed on Mar. 2, 2009, now Pat. No. 8,583,781.
Application No. 12/380,777 is a continuation-in-part of application No. 12/695,019, filed on Jan. 27, 2010, now Pat. No. 8,275,830.
Application No. 12/695,019 is a continuation-in-part of application No. 12/695,020, filed on Jan. 27, 2010, now Pat. No. 8,406,748.
Application No. 12/695,020 is a continuation-in-part of application No. 12/694,445, filed on Jan. 27, 2010, now Pat. No. 8,391,834.
Application No. 12/694,445 is a continuation-in-part of application No. 12/694,451, filed on Jan. 27, 2010, now Pat. No. 8,548,428.
Application No. 12/694,451 is a continuation-in-part of application No. 12/694,455, filed on Jan. 27, 2010, now Pat. No. 8,402,111.
Application No. 12/694,455 is a continuation-in-part of application No. 12/695,021, filed on Jan. 27, 2010, now Pat. No. 8,346,225.
Application No. 12/695,021 is a continuation-in-part of application No. 12/695,980, filed on Jan. 28, 2010, now Pat. No. 8,340,634.
Application No. 12/695,980 is a continuation-in-part of application No. 13/134,028, filed on May 25, 2011, now Pat. No. 8,589,541.
Application No. 13/134,028 is a continuation-in-part of application No. 13/134,005, filed on May 25, 2011, now Pat. No. 8,635,335.
Application No. 13/134,005 is a continuation-in-part of application No. 13/229,580, filed on Sep. 9, 2011, now Pat. No. 8,626,115.
Application No. 13/229,580 is a continuation-in-part of application No. 13/237,827, filed on Sep. 20, 2011.
Application No. 13/237,827 is a continuation-in-part of application No. 13/239,321, filed on Sep. 21, 2011.
Application No. 13/239,321 is a continuation-in-part of application No. 13/248,028, filed on Sep. 28, 2011.
Application No. 13/248,028 is a continuation-in-part of application No. 13/248,025, filed on Sep. 28, 2011.
Application No. 13/374,959 is a continuation-in-part of application No. 12/380,759, filed on Mar. 2, 2009, now Pat. No. 8,270,310.
Application No. 12/380,759 is a continuation-in-part of application No. 12/380,779, filed on Mar. 2, 2009.
Application No. 12/380,779 is a continuation-in-part of application No. 12/380,758, filed on Mar. 2, 2009.
Application No. 12/380,758 is a continuation-in-part of application No. 12/380,778, filed on Mar. 2, 2009, now Pat. No. 8,321,526.
Application No. 12/380,778 is a continuation-in-part of application No. 12/380,768, filed on Mar. 2, 2009.
Application No. 12/380,768 is a continuation-in-part of application No. 12/380,767, filed on Mar. 2, 2009, now Pat. No. 8,355,337.
Application No. 12/380,767 is a continuation-in-part of application No. 12/380,780, filed on Mar. 2, 2009.
Application No. 12/380,780 is a continuation-in-part of application No. 12/380,755, filed on Mar. 2, 2009, now Pat. No. 8,331,901.
Application No. 12/380,755 is a continuation-in-part of application No. 12/380,756, filed on Mar. 2, 2009, now Pat. No. 8,250,207.
Application No. 12/380,756 is a continuation-in-part of application No. 12/380,770, filed on Mar. 2, 2009, now abandoned.
Application No. 12/380,770 is a continuation-in-part of application No. 12/380,772, filed on Mar. 2, 2009.
Application No. 12/380,772 is a continuation-in-part of application No. 12/380,782, filed on Mar. 2, 2009, now Pat. No. 8,270,952.
Application No. 12/380,782 is a continuation-in-part of application No. 12/380,783, filed on Mar. 2, 2009.
Application No. 12/380,783 is a continuation-in-part of application No. 12/380,757, filed on Mar. 2, 2009, now Pat. No. 8,326,958.
Application No. 12/380,757 is a continuation-in-part of application No. 12/380,781, filed on Mar. 2, 2009, now Pat. No. 8,229,812.
Application No. 12/380,781 is a continuation-in-part of application No. 12/380,774, filed on Mar. 2, 2009, now Pat. No. 8,630,192.
Application No. 12/380,774 is a continuation-in-part of application No. 12/380,773, filed on Mar. 2, 2009.
Application No. 12/380,773 is a continuation-in-part of application No. 12/380,769, filed on Mar. 2, 2009.
Application No. 12/380,769 is a continuation-in-part of application No. 12/380,777, filed on Mar. 2, 2009, now Pat. No. 8,583,781.
Application No. 12/380,777 is a continuation-in-part of application No. 12/695,019, filed on Jan. 27, 2010, now Pat. No. 8,275,830.
Application No. 12/695,019 is a continuation-in-part of application No. 12/695,020, filed on Jan. 27, 2010, now Pat. No. 8,406,748.
Application No. 12/695,020 is a continuation-in-part of application No. 12/694,445, filed on Jan. 27, 2010, now Pat. No. 8,391,834.
Application No. 12/694,445 is a continuation-in-part of application No. 12/694,451, filed on Jan. 27, 2010, now Pat. No. 8,548,428.
Application No. 12/694,451 is a continuation-in-part of application No. 12/694,455, filed on Jan. 27, 2010, now Pat. No. 8,402,111.
Application No. 12/694,455 is a continuation-in-part of application No. 12/695,021, filed on Jan. 27, 2010, now Pat. No. 8,346,225.
Application No. 12/695,021 is a continuation-in-part of application No. 12/695,980, filed on Jan. 28, 2010, now Pat. No. 8,340,634.
Application No. 12/695,980 is a continuation-in-part of application No. 13/134,005, filed on May 25, 2011, now Pat. No. 8,635,335.
Application No. 13/134,005 is a continuation-in-part of application No. 13/134,028, filed on May 25, 2011, now Pat. No. 8,589,541.
Application No. 13/134,028 is a continuation-in-part of application No. 13/229,580, filed on Sep. 9, 2011, now Pat. No. 8,626,115.
Application No. 13/229,580 is a continuation-in-part of application No. 13/237,827, filed on Sep. 20, 2011.
Application No. 13/237,827 is a continuation-in-part of application No. 13/239,321, filed on Sep. 21, 2011.
Application No. 13/239,321 is a continuation-in-part of application No. 13/247,998, filed on Sep. 28, 2011.
Application No. 13/247,998 is a continuation-in-part of application No. 13/248,028, filed on Sep. 28, 2011.
Application No. 13/248,028 is a continuation-in-part of application No. 13/248,025, filed on Sep. 28, 2011.
Application No. 13/248,025 is a continuation-in-part of application No. 13/253,013, filed on Oct. 4, 2011.
Application No. 13/253,013 is a continuation-in-part of application No. 13/309,556, filed on Dec. 1, 2011.
Application No. 13/309,556 is a continuation-in-part of application No. 13/309,463, filed on Dec. 1, 2011.
Application No. 12/695,019 is a continuation-in-part of application No. 12/380,778, filed on Mar. 2, 2009, now Pat. No. 8,321,526.
Application No. 12/380,778 is a continuation-in-part of application No. 12/380,771, filed on Mar. 2, 2009, now Pat. No. 8,023,425.
Application No. 12/695,020 is a continuation-in-part of application No. 12/380,780, filed on Mar. 2, 2009.
Application No. 12/694,445 is a continuation-in-part of application No. 12/380,780, filed on Mar. 2, 2009.
Application No. 12/694,451 is a continuation-in-part of application No. 12/380,780, filed on Mar. 2, 2009.
Application No. 12/694,455 is a continuation-in-part of application No. 12/380,780, filed on Mar. 2, 2009.
Application No. 12/695,021 is a continuation-in-part of application No. 12/380,780, filed on Mar. 2, 2009.
Application No. 12/695,980 is a continuation-in-part of application No. 12/380,780, filed on Mar. 2, 2009.
Application No. 12/380,780 is a continuation-in-part of application No. 12/695,019, filed on Jan. 27, 2010, now Pat. No. 8,275,830.
Application No. 12/695,019 is a continuation-in-part of application No. 12/695,021, filed on Jan. 27, 2010, now Pat. No. 8,346,225.
Application No. 13/134,028 is a continuation-in-part of application No. 12/380,759, filed on Mar. 2, 2009, now Pat. No. 8,270,310.
Application No. 12/380,759 is a continuation-in-part of application No. 12/380,779, filed on Mar. 2, 2009.
Application No. 12/380,779 is a continuation-in-part of application No. 12/380,758, filed on Mar. 2, 2009.
Application No. 12/380,758 is a continuation-in-part of application No. 12/380,778, filed on Mar. 2, 2009, now Pat. No. 8,321,526.
Application No. 12/380,778 is a continuation-in-part of application No. 12/380,768, filed on Mar. 2, 2009.
Application No. 12/380,768 is a continuation-in-part of application No. 12/380,767, filed on Mar. 2, 2009, now Pat. No. 8,355,337.
Application No. 12/380,767 is a continuation-in-part of application No. 12/380,780, filed on Mar. 2, 2009.
Application No. 12/380,780 is a continuation-in-part of application No. 12/380,755, filed on Mar. 2, 2009, now Pat. No. 8,331,901.
Application No. 12/380,755 is a continuation-in-part of application No. 12/380,756, filed on Mar. 2, 2009, now Pat. No. 8,250,207.
Application No. 12/380,756 is a continuation-in-part of application No. 12/380,770, filed on Mar. 2, 2009, now abandoned.
Application No. 12/380,770 is a continuation-in-part of application No. 12/380,772, filed on Mar. 2, 2009.
Application No. 12/380,772 is a continuation-in-part of application No. 12/380,782, filed on Mar. 2, 2009, now Pat. No. 8,270,952.
Application No. 12/380,782 is a continuation-in-part of application No. 12/380,783, filed on Mar. 2, 2009.
Application No. 12/380,783 is a continuation-in-part of application No. 12/380,757, filed on Mar. 2, 2009, now Pat. No. 8,326,958.
Application No. 12/380,757 is a continuation-in-part of application No. 12/380,781, filed on Mar. 2, 2009, now Pat. No. 8,229,812.
Application No. 12/380,781 is a continuation-in-part of application No. 12/380,774, filed on Mar. 2, 2009, now Pat. No. 8,630,192.
Application No. 12/380,774 is a continuation-in-part of application No. 12/380,771, filed on Mar. 2, 2009, now Pat. No. 8,023,425.
Application No. 12/380,771 is a continuation-in-part of application No. 12/380,773, filed on Mar. 2, 2009.
Application No. 12/380,773 is a continuation-in-part of application No. 12/380,769, filed on Mar. 2, 2009.
Application No. 12/380,769 is a continuation-in-part of application No. 12/380,777, filed on Mar. 2, 2009, now Pat. No. 8,583,781.
Application No. 12/380,777 is a continuation-in-part of application No. 12/695,019, filed on Jan. 27, 2010, now Pat. No. 8,275,830.
Application No. 12/695,019 is a continuation-in-part of application No. 12/695,020, filed on Jan. 27, 2010, now Pat. No. 8,406,748.
Application No. 12/695,020 is a continuation-in-part of application No. 12/694,445, filed on Jan. 27, 2010, now Pat. No. 8,391,834.
Application No. 12/694,445 is a continuation-in-part of application No. 12/694,451, filed on Jan. 27, 2010, now Pat. No. 8,548,428.
Application No. 12/694,451 is a continuation-in-part of application No. 12/694,455, filed on Jan. 27, 2010, now Pat. No. 8,402,111.
Application No. 12/694,455 is a continuation-in-part of application No. 12/695,021, filed on Jan. 27, 2010, now Pat. No. 8,346,225.
Application No. 12/695,021 is a continuation-in-part of application No. 12/695,980, filed on Jan. 28, 2010, now Pat. No. 8,340,634.
Application No. 12/695,980 is a continuation-in-part of application No. 13/134,005, filed on May 25, 2011, now Pat. No. 8,635,335.
Application No. 13/134,005 is a continuation-in-part of application No. 12/380,759, filed on Mar. 2, 2009, now Pat. No. 8,270,310.
Application No. 12/380,759 is a continuation-in-part of application No. 12/380,779, filed on Mar. 2, 2009.
Application No. 12/380,779 is a continuation-in-part of application No. 12/380,758, filed on Mar. 2, 2009.
Application No. 12/380,758 is a continuation-in-part of application No. 12/380,778, filed on Mar. 2, 2009, now Pat. No. 8,321,526.
Application No. 12/380,778 is a continuation-in-part of application No. 12/380,768, filed on Mar. 2, 2009.
Application No. 12/380,768 is a continuation-in-part of application No. 12/380,767, filed on Mar. 2, 2009, now Pat. No. 8,355,337.
Application No. 12/380,767 is a continuation-in-part of application No. 12/380,780, filed on Mar. 2, 2009.
Application No. 12/380,780 is a continuation-in-part of application No. 12/380,755, filed on Mar. 2, 2009, now Pat. No. 8,331,901.
Application No. 12/380,755 is a continuation-in-part of application No. 12/380,756, filed on Mar. 2, 2009, now Pat. No. 8,250,207.
Application No. 12/380,756 is a continuation-in-part of application No. 12/380,770, filed on Mar. 2, 2009, now abandoned.
Application No. 12/380,770 is a continuation-in-part of application No. 12/380,772, filed on Mar. 2, 2009.
Application No. 12/380,772 is a continuation-in-part of application No. 12/380,782, filed on Mar. 2, 2009, now Pat. No. 8,270,952.
Application No. 12/380,782 is a continuation-in-part of application No. 12/380,783, filed on Mar. 2, 2009.
Application No. 12/380,783 is a continuation-in-part of application No. 12/380,757, filed on Mar. 2, 2009, now Pat. No. 8,326,958.
Application No. 12/380,757 is a continuation-in-part of application No. 12/380,781, filed on Mar. 2, 2009, now Pat. No. 8,229,812.
Application No. 12/380,781 is a continuation-in-part of application No. 12/380,774, filed on Mar. 2, 2009, now Pat. No. 8,630,192.
Application No. 12/380,774 is a continuation-in-part of application No. 12/380,771, filed on Mar. 2, 2009, now Pat. No. 8,023,425.
Application No. 12/380,771 is a continuation-in-part of application No. 12/380,773, filed on Mar. 2, 2009.
Application No. 12/380,773 is a continuation-in-part of application No. 12/380,769, filed on Mar. 2, 2009.
Application No. 12/380,769 is a continuation-in-part of application No. 12/380,777, filed on Mar. 2, 2009, now Pat. No. 8,583,781.
Application No. 12/380,777 is a continuation-in-part of application No. 12/695,019, filed on Jan. 27, 2010, now Pat. No. 8,275,830.
Application No. 12/695,019 is a continuation-in-part of application No. 12/695,020, filed on Jan. 27, 2010, now Pat. No. 8,406,748.
Application No. 12/695,020 is a continuation-in-part of application No. 12/694,445, filed on Jan. 27, 2010, now Pat. No. 8,391,834.
Application No. 12/694,445 is a continuation-in-part of application No. 12/694,451, filed on Jan. 27, 2010, now Pat. No. 8,548,428.
Application No. 12/694,451 is a continuation-in-part of application No. 12/694,455, filed on Jan. 27, 2010, now Pat. No. 8,402,111.
Application No. 12/694,455 is a continuation-in-part of application No. 12/695,021, filed on Jan. 27, 2010, now Pat. No. 8,346,225.
Application No. 12/695,021 is a continuation-in-part of application No. 12/695,930, filed on Jan. 28, 2010, now Pat. No. 8,365,621.
Application No. 13/229,580 is a continuation-in-part of application No. 12/380,759, filed on Mar. 2, 2009, now Pat. No. 8,270,310.
Application No. 12/380,759 is a continuation-in-part of application No. 12/380,779, filed on Mar. 2, 2009.
Application No. 12/380,779 is a continuation-in-part of application No. 12/380,758, filed on Mar. 2, 2009.
Application No. 12/380,758 is a continuation-in-part of application No. 12/380,778, filed on Mar. 2, 2009, now Pat. No. 8,321,526.
Application No. 12/380,778 is a continuation-in-part of application No. 12/380,768, filed on Mar. 2, 2009.
Application No. 12/380,768 is a continuation-in-part of application No. 12/380,767, filed on Mar. 2, 2009, now Pat. No. 8,355,337.
Application No. 12/380,767 is a continuation-in-part of application No. 12/380,780, filed on Mar. 2, 2009.
Application No. 12/380,780 is a continuation-in-part of application No. 12/380,755, filed on Mar. 2, 2009, now Pat. No. 8,331,901.
Application No. 12/380,755 is a continuation-in-part of application No. 12/380,756, filed on Mar. 2, 2009, now Pat. No. 8,250,207.
Application No. 12/380,756 is a continuation-in-part of application No. 12/380,770, filed on Mar. 2, 2009, now abandoned.
Application No. 12/380,770 is a continuation-in-part of application No. 12/380,772, filed on Mar. 2, 2009.
Application No. 12/380,772 is a continuation-in-part of application No. 12/380,782, filed on Mar. 2, 2009, now Pat. No. 8,270,952.
Application No. 12/380,782 is a continuation-in-part of application No. 12/380,783, filed on Mar. 2, 2009.
Application No. 12/380,783 is a continuation-in-part of application No. 12/380,757, filed on Mar. 2, 2009, now Pat. No. 8,326,958.
Application No. 12/380,757 is a continuation-in-part of application No. 12/380,781, filed on Mar. 2, 2009, now Pat. No. 8,229,812.
Application No. 12/380,781 is a continuation-in-part of application No. 12/380,774, filed on Mar. 2, 2009, now Pat. No. 8,630,192.
Application No. 12/380,774 is a continuation-in-part of application No. 12/380,771, filed on Mar. 2, 2009, now Pat. No. 8,023,425.
Application No. 12/380,771 is a continuation-in-part of application No. 12/380,773, filed on Mar. 2, 2009.
Application No. 12/380,773 is a continuation-in-part of application No. 12/380,769, filed on Mar. 2, 2009.
Application No. 12/380,769 is a continuation-in-part of application No. 12/380,777, filed on Mar. 2, 2009, now Pat. No. 8,583,781.
Application No. 12/380,777 is a continuation-in-part of application No. 12/695,019, filed on Jan. 27, 2010, now Pat. No. 8,275,830.
Application No. 12/695,019 is a continuation-in-part of application No. 12/695,020, filed on Jan. 27, 2010, now Pat. No. 8,406,748.
Application No. 12/695,020 is a continuation-in-part of application No. 12/694,445, filed on Jan. 27, 2010, now Pat. No. 8,391,834.
Application No. 12/694,445 is a continuation-in-part of application No. 12/694,451, filed on Jan. 27, 2010, now Pat. No. 8,548,428.
Application No. 12/694,451 is a continuation-in-part of application No. 12/694,455, filed on Jan. 27, 2010, now Pat. No. 8,402,111.
Application No. 12/694,455 is a continuation-in-part of application No. 12/695,021, filed on Jan. 27, 2010, now Pat. No. 8,346,225.
Application No. 12/695,021 is a continuation-in-part of application No. 12/695,980, filed on Jan. 28, 2010, now Pat. No. 8,340,634.
Application No. 12/695,980 is a continuation-in-part of application No. 13/134,005, filed on May 25, 2011, now Pat. No. 8,635,335.
Application No. 13/134,005 is a continuation-in-part of application No. 13/134,028, filed on May 25, 2011, now Pat. No. 8,589,541.
Application No. 13/237,827 is a continuation-in-part of application No. 12/380,759, filed on Mar. 2, 2009, now Pat. No. 8,270,310.
Application No. 12/380,759 is a continuation-in-part of application No. 12/380,779, filed on Mar. 2, 2009.
Application No. 12/380,779 is a continuation-in-part of application No. 12/380,758, filed on Mar. 2, 2009.
Application No. 12/380,758 is a continuation-in-part of application No. 12/380,778, filed on Mar. 2, 2009, now Pat. No. 8,321,526.
Application No. 12/380,778 is a continuation-in-part of application No. 12/380,768, filed on Mar. 2, 2009.
Application No. 12/380,768 is a continuation-in-part of application No. 12/380,767, filed on Mar. 2, 2009, now Pat. No. 8,355,337.
Application No. 12/380,767 is a continuation-in-part of application No. 12/380,780, filed on Mar. 2, 2009.
Application No. 12/380,780 is a continuation-in-part of application No. 12/380,755, filed on Mar. 2, 2009, now Pat. No. 8,331,901.
Application No. 12/380,755 is a continuation-in-part of application No. 12/380,756, filed on Mar. 2, 2009, now Pat. No. 8,250,207.
Application No. 12/380,756 is a continuation-in-part of application No. 12/380,770, filed on Mar. 2, 2009, now abandoned.
Application No. 12/380,770 is a continuation-in-part of application No. 12/380,772, filed on Mar. 2, 2009.
Application No. 12/380,772 is a continuation-in-part of application No. 12/380,782, filed on Mar. 2, 2009, now Pat. No. 8,270,952.
Application No. 12/380,782 is a continuation-in-part of application No. 12/380,783, filed on Mar. 2, 2009.
Application No. 12/380,783 is a continuation-in-part of application No. 12/380,757, filed on Mar. 2, 2009, now Pat. No. 8,326,958.
Application No. 12/380,757 is a continuation-in-part of application No. 12/380,781, filed on Mar. 2, 2009, now Pat. No. 8,229,812.
Application No. 12/380,781 is a continuation-in-part of application No. 12/380,774, filed on Mar. 2, 2009, now Pat. No. 8,630,192.
Application No. 12/380,774 is a continuation-in-part of application No. 12/380,773, filed on Mar. 2, 2009.
Application No. 12/380,773 is a continuation-in-part of application No. 12/380,769, filed on Mar. 2, 2009.
Application No. 12/380,769 is a continuation-in-part of application No. 12/380,777, filed on Mar. 2, 2009, now Pat. No. 8,583,781.
Application No. 12/380,777 is a continuation-in-part of application No. 12/695,019, filed on Jan. 27, 2010, now Pat. No. 8,275,830.
Application No. 12/695,019 is a continuation-in-part of application No. 12/695,020, filed on Jan. 27, 2010, now Pat. No. 8,406,748.
Application No. 12/695,020 is a continuation-in-part of application No. 12/694,445, filed on Jan. 27, 2010, now Pat. No. 8,391,834.
Application No. 12/694,445 is a continuation-in-part of application No. 12/694,451, filed on Jan. 27, 2010, now Pat. No. 8,548,428.
Application No. 12/694,451 is a continuation-in-part of application No. 12/694,455, filed on Jan. 27, 2010, now Pat. No. 8,402,111.
Application No. 12/694,455 is a continuation-in-part of application No. 12/695,021, filed on Jan. 27, 2010, now Pat. No. 8,346,225.
Application No. 12/695,021 is a continuation-in-part of application No. 12/695,980, filed on Jan. 28, 2010, now Pat. No. 8,340,634.
Application No. 12/695,980 is a continuation-in-part of application No. 13/134,005, filed on May 25, 2011, now Pat. No. 8,635,335.
Application No. 13/134,005 is a continuation-in-part of application No. 13/134,028, filed on May 25, 2011, now Pat. No. 8,589,541.
Application No. 13/134,028 is a continuation-in-part of application No. 13/229,580, filed on Sep. 9, 2011, now Pat. No. 8,626,115.
Application No. 13/239,321 is a continuation-in-part of application No. 12/380,759, filed on Mar. 2, 2009, now Pat. No. 8,270,310.
Application No. 12/380,759 is a continuation-in-part of application No. 12/380,779, filed on Mar. 2, 2009.
Application No. 12/380,779 is a continuation-in-part of application No. 12/380,758, filed on Mar. 2, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/387,243, filed on Sep. 28, 2010.
(60) Provisional application No. 61/387,247, filed on Sep. 28, 2010.
(60) Provisional application No. 61/389,547, filed on Oct. 4, 2010.
(60) Provisional application No. 61/407,358, filed on Oct. 27, 2010.
(60) Provisional application No. 61/418,507, filed on Dec. 1, 2010.
(60) Provisional application No. 61/418,509, filed on Dec. 1, 2010.
(60) Provisional application No. 61/420,727, filed on Dec. 7, 2010.
(60) Provisional application No. 61/422,565, filed on Dec. 13, 2010.
(60) Provisional application No. 61/422,572, filed on Dec. 13, 2010.
(60) Provisional application No. 61/422,574, filed on Dec. 13, 2010.
(60) Provisional application No. 61/435,564, filed on Jan. 24, 2011.
(60) Provisional application No. 61/472,606, filed on Apr. 6, 2011.
(60) Provisional application No. 61/435,564, filed on Jan. 24, 2011.
(60) Provisional application No. 61/472,606, filed on Apr. 6, 2011.
(60) Provisional application No. 61/550,906, filed on Oct. 24, 2011.
(60) Provisional application No. 61/589,830, filed on Jan. 23, 2012.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/270,353, filed on Jul. 6, 2009.
(60) Provisional application No. 61/264,126, filed on Nov. 24, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/275,208, filed on Aug. 25, 2009.
(60) Provisional application No. 61/237,753, filed on Aug. 28, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/252,151, filed on Oct. 15, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/270,353, filed on Jul. 6, 2009.
(60) Provisional application No. 61/252,153, filed on Oct. 15, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/264,120, filed on Nov. 24, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/252,151, filed on Oct. 15, 2009.
(60) Provisional application No. 61/252,153, filed on Oct. 15, 2009.
(60) Provisional application No. 61/206,354, filed on Jan. 28, 2009.
(60) Provisional application No. 61/206,944, filed on Feb. 4, 2009.
(60) Provisional application No. 61/207,393, filed on Feb. 10, 2009.
(60) Provisional application No. 61/207,739, filed on Feb. 13, 2009.
(60) Provisional application No. 61/270,353, filed on Jul. 6, 2009.
(60) Provisional application No. 61/348,022, filed on May 25, 2010.
(60) Provisional application No. 61/381,159, filed on Sep. 9, 2010.
(60) Provisional application No. 61/381,162, filed on Sep. 9, 2010.
(60) Provisional application No. 61/384,456, filed on Sep. 20, 2010.
(60) Provisional application No. 61/385,020, filed on Sep. 21, 2010.
(60) Provisional application No. 61/387,243, filed on Sep. 28, 2010.
(60) Provisional application No. 61/387,247, filed on Sep. 28, 2010.
(60) Provisional application No. 61/389,547, filed on Oct. 4, 2010.
(60) Provisional application No. 61/407,358, filed on Oct. 27, 2010.
(60) Provisional application No. 61/418,507, filed on Dec. 1, 2010.
(60) Provisional application No. 61/418,509, filed on Dec. 1, 2010.
(60) Provisional application No. 61/420,727, filed on Dec. 7, 2010.
(60) Provisional application No. 61/422,565, filed on Dec. 13, 2010.
(60) Provisional application No. 61/422,572, filed on Dec. 13, 2010.
(60) Provisional application No. 61/422,574, filed on Dec. 13, 2010.
(60) Provisional application No. 61/435,564, filed on Jan. 24, 2011.
(60) Provisional application No. 61/472,606, filed on Apr. 6, 2011.
(60) Provisional application No. 61/348,022, filed on May 25, 2010.
(60) Provisional application No. 61/381,159, filed on Sep. 9, 2010.
(60) Provisional application No. 61/381,162, filed on Sep. 9, 2010.
(60) Provisional application No. 61/384,456, filed on Sep. 20, 2010.
(60) Provisional application No. 61/385,020, filed on Sep. 21, 2010.
(60) Provisional application No. 61/387,243, filed on Sep. 28, 2010.
(60) Provisional application No. 61/387,247, filed on Sep. 28, 2010.
(60) Provisional application No. 61/389,547, filed on Oct. 4, 2010.
(60) Provisional application No. 61/407,358, filed on Oct. 27, 2010.
(60) Provisional application No. 61/418,507, filed on Dec. 1, 2010.
(60) Provisional application No. 61/418,509, filed on Dec. 1, 2010.
(60) Provisional application No. 61/420,727, filed on Dec. 7, 2010.
(60) Provisional application No. 61/422,565, filed on Dec. 13, 2010.
(60) Provisional application No. 61/422,572, filed on Dec. 13, 2010.
(60) Provisional application No. 61/422,574, filed on Dec. 13, 2010.
(60) Provisional application No. 61/435,564, filed on Jan. 24, 2011.
(60) Provisional application No. 61/472,606, filed on Apr. 6, 2011.
(60) Provisional application No. 61/381,159, filed on Sep. 9, 2010.
(60) Provisional application No. 61/381,162, filed on Sep. 9, 2010.
(60) Provisional application No. 61/384,456, filed on Sep. 20, 2010.
(60) Provisional application No. 61/385,020, filed on Sep. 21, 2010.
(60) Provisional application No. 61/387,243, filed on Sep. 28, 2010.
(60) Provisional application No. 61/387,247, filed on Sep. 28, 2010.
(60) Provisional application No. 61/389,547, filed on Oct. 4, 2010.
(60) Provisional application No. 61/407,358, filed on Oct. 27, 2010.
(60) Provisional application No. 61/418,507, filed on Dec. 1, 2010.
(60) Provisional application No. 61/418,509, filed on Dec. 1, 2010.
(60) Provisional application No. 61/420,727, filed on Dec. 7, 2010.
(60) Provisional application No. 61/422,565, filed on Dec. 13, 2010.
(60) Provisional application No. 61/422,572, filed on Dec. 13, 2010.
(60) Provisional application No. 61/422,574, filed on Dec. 13, 2010.
(60) Provisional application No. 61/435,564, filed on Jan. 24, 2011.
(60) Provisional application No. 61/472,606, filed on Apr. 6, 2011.
(60) Provisional application No. 61/384,456, filed on Sep. 20, 2010.
(60) Provisional application No. 61/385,020, filed on Sep. 21, 2010.
(60) Provisional application No. 61/387,243, filed on Sep. 28, 2010.
(60) Provisional application No. 61/387,247, filed on Sep. 28, 2010.
(60) Provisional application No. 61/389,547, filed on Oct. 4, 2010.
(60) Provisional application No. 61/407,358, filed on Oct. 27, 2010.
(60) Provisional application No. 61/418,507, filed on Dec. 1, 2010.
(60) Provisional application No. 61/418,509, filed on Dec. 1, 2010.
(60) Provisional application No. 61/420,727, filed on Dec. 7, 2010.
(60) Provisional application No. 61/422,565, filed on Dec. 13, 2010.
(60) Provisional application No. 61/422,572, filed on Dec. 13, 2010.
(60) Provisional application No. 61/422,574, filed on Dec. 13, 2010.
(60) Provisional application No. 61/435,564, filed on Jan. 24, 2011.
(60) Provisional application No. 61/472,606, filed on Apr. 6, 2011.

(51) Int. Cl. G06F 21/64

(52) U.S. Cl. CPC G06F 21/64
USPC 726/26

(57) ABSTRACT

A device comprising non-volatile memory capable of being partitioned into first and second partitions, the first partition for storing device system software, the second partition for storing a service processor and having one or more system execution properties for enhancing or augmenting the device system software, and comprising one or more processors for verifying integrity of the device system software using a first security element, verifying integrity of the service processor using a second security element, obtaining the service processor from the non-volatile memory, executing the obtained service processor, and updating, installing, removing, or modifying the service processor in the second partition of the non-volatile memory without affecting the device system software in the first partition.

### CROSS REFERENCE TO OTHER APPLICATIONS

This application is a continuation-in-part of: U.S. application Ser. No. 12/380,780 (Attorney Docket No. RALEP007), filed Mar. 2, 2009, entitled AUTOMATED DEVICE PROVISIONING AND ACTIVATION; U.S. application Ser. No. 13/674,808 (Attorney Docket No. RALEP027C1), filed Nov. 12, 2012, entitled DEVICE ASSISTED SERVICES INSTALL; U.S. application Ser. No. 13/247,998 (Attorney Docket No. RALEP038), filed Sep. 28, 2011, entitled SECURE DEVICE DATA RECORDS; and U.S. application Ser. No. 13/374,959 (Attorney Docket No. RALEP046), filed Jan. 24, 2012, entitled FLOW TAGGING FOR SERVICE POLICY IMPLEMENTATION.

This document incorporates by reference for all purposes the following non-provisional U.S. patent applications: U.S. application Ser. No. 12/380,780 (Attorney Docket No. RALEP007), filed Mar. 2, 2009, entitled AUTOMATED DEVICE PROVISIONING AND ACTIVATION; U.S. application Ser. No. 12/695,019 (Attorney Docket No. RALEP022), filed Jan. 27, 2010, entitled DEVICE ASSISTED CDR CREATION, AGGREGATION, MEDIATION AND BILLING, now U.S. Pat. No. 8,275,830 (issued Sep. 25, 2012); U.S. application Ser. No. 12/695,020 (Attorney Docket No. RALEP024), filed Jan. 27, 2010, entitled ADAPTIVE AMBIENT SERVICES, now U.S. Pat. No. 8,406,748 (issued Mar. 26, 2013); U.S. application Ser. No. 12/694,445 (Attorney Docket No. RALEP025), filed Jan. 27, 2010, entitled SECURITY TECHNIQUES FOR DEVICE ASSISTED SERVICES, now U.S. Pat. No. 8,391,834 (issued Mar. 5, 2013); U.S. application Ser. No. 12/694,451 (Attorney Docket No. RALEP026), filed Jan. 27, 2010, entitled DEVICE GROUP PARTITIONS AND SETTLEMENT PLATFORM, now U.S. Pat. No. 8,548,428 (issued Oct. 1, 2013); U.S. application Ser. No. 12/694,455 (Attorney Docket No. RALEP027), filed Jan. 27, 2010, entitled DEVICE ASSISTED SERVICES INSTALL, now U.S. Pat. No. 8,402,111 (issued Mar. 19, 2013); U.S. application Ser. No. 12/695,021 (Attorney Docket No. RALEP029), filed Jan. 27, 2010, entitled QUALITY OF SERVICE FOR DEVICE ASSISTED SERVICES, now U.S. Pat. No. 8,346,225 (issued Jan. 1, 2013); U.S. application Ser. No. 12/695,980 (Attorney Docket No. RALEP030), filed Jan. 28, 2010, entitled ENHANCED ROAMING SERVICES AND CONVERGED CARRIER NETWORKS WITH DEVICE ASSISTED SERVICES AND A PROXY, now U.S. Pat. No. 8,340,634 (issued Dec. 25, 2012); U.S. application Ser. No. 13/134,028 (Attorney Docket No. RALEP032), filed May 25, 2011, entitled DEVICE-ASSISTED SERVICES FOR PROTECTING NETWORK CAPACITY; U.S. application Ser. No. 13/229,580 (Attorney Docket No. RALEP033), filed Sep. 9, 2011, entitled WIRELESS NETWORK SERVICE INTERFACES; U.S. application Ser. No. 13/237,827 (Attorney Docket No. RALEP034), filed Sep. 20, 2011, entitled ADAPTING NETWORK POLICIES BASED ON DEVICE SERVICE PROCESSOR CONFIGURATION; U.S. application Ser. No. 13/253,013 (Attorney Docket No. RALEP035), filed Oct. 4, 2011, entitled SYSTEM AND METHOD FOR PROVIDING USER NOTIFICATIONS; U.S. application Ser. No. 13/239,321 (Attorney Docket No. RALEP036), filed Sep. 21, 2011, entitled SERVICE OFFER SET PUBLISHING TO DEVICE AGENT WITH ON-DEVICE SERVICE SELECTION; U.S. application Ser. No. 13/248,028 (Attorney Docket No. RALEP037), filed Sep. 28, 2011, entitled ENTERPRISE ACCESS CONTROL AND ACCOUNTING ALLOCATION FOR ACCESS NETWORKS; U.S. application Ser. No. 13/247,998 (Attorney Docket No. RALEP038), filed Sep. 28, 2011, entitled SECURE DEVICE DATA RECORDS; U.S. application Ser. No. 13/309,556 (Attorney Docket No. RALEP040), filed Dec. 1, 2011, entitled END USER DEVICE THAT SECURES AN ASSOCIATION OF APPLICATION TO SERVICE POLICY WITH AN APPLICATION CERTIFICATE CHECK; U.S. application Ser. No. 13/309,463 (Attorney Docket No. RALEP041), filed Dec. 1, 2011, entitled SECURITY, FRAUD DETECTION, AND FRAUD MITIGATION IN DEVICE-ASSISTED SERVICES SYSTEMS; U.S. application Ser. No. 13/248,025 (Attorney Docket No. RALEP043), filed Sep. 28, 2011, entitled SERVICE DESIGN CENTER FOR DEVICE ASSISTED SERVICES; and U.S. application Ser. No. 13/374,959 (Attorney Docket No. RALEP046), filed Jan. 24, 2012, entitled FLOW TAGGING FOR SERVICE POLICY IMPLEMENTATION; U.S. application Ser. No. 13/441,821 (Attorney Docket No. RALEP047A), filed Apr. 6, 2012, entitled MANAGING SERVICE USER DISCOVERY AND SERVICE LAUNCH OBJECT PLACEMENT ON A DEVICE; U.S. application Ser. No. 13/134,005 (Attorney Docket No. RALEP049), filed May 25, 2011, entitled SYSTEM AND METHOD FOR WIRELESS NETWORK OFFLOADING; U.S. application Ser. No. 13/802,483 (Attorney Docket No. RALEP063), filed Mar. 13, 2013, entitled MOBILE DEVICE ACTIVATION VIA DYNAMICALLY SELECTED ACCESS NETWORK; U.S. application Ser. No. 13/748,152 (Attorney Docket No. RALEP106), filed Jan. 23, 2013, entitled SERVICE PLAN DESIGN, USER INTERFACES, APPLICATION PROGRAMMING INTERFACES, AND DEVICE MANAGEMENT; U.S. application Ser. No. 13/842,172 (Attorney Docket No. RALEP104), filed Mar. 15, 2013, entitled NETWORK SERVICE PLAN DESIGN; and U.S. application Ser. No. 13/947,099 (Attorney Docket No. RALEP118), filed Jul. 21, 2013, entitled VIRTUALIZED POLICY & CHARGING SYSTEM.

This document incorporates by reference for all purposes the following provisional patent applications: U.S. Provisional Application No. 61/206,354 (Attorney Docket No. RALEP001+), filed Jan. 28, 2009, entitled SERVICES POLICY COMMUNICATION SYSTEM AND METHOD; U.S. Provisional Application No. 61/206,944 (Attorney Docket No. RALEP002+), filed Feb. 4, 2009, entitled SERVICES POLICY COMMUNICATION SYSTEM AND METHOD; U.S. Provisional Application No. 61/207,393 (Attorney Docket No. RALEP003+), filed Feb. 10, 2009, entitled SERVICES POLICY COMMUNICATION SYSTEM AND METHOD; and U.S. Provisional Application No. 61/207,739 (Attorney Docket No. RALEP004+), entitled SERVICES POLICY COMMUNICATION SYSTEM AND METHOD, filed Feb. 13, 2009; U.S. Provisional Application No. 61/270,353 (Attorney Docket No. RALEP022+), filed on Jul. 6, 2009, entitled DEVICE ASSISTED CDR CREATION, AGGREGATION, MEDIATION AND BILLING; U.S. Provisional Application No. 61/275,208 (Attorney Docket No. RALEP023+), filed Aug. 25, 2009, entitled ADAPTIVE AMBIENT SERVICES; and U.S. Provisional Application No. 61/237,753 (Attorney Docket No. RALEP024+), filed Aug. 28, 2009, entitled ADAPTIVE AMBIENT SERVICES; U.S. Provisional Application No. 61/252,151 (Attorney Docket No. RALEP025+), filed Oct. 15, 2009, entitled SECURITY TECHNIQUES FOR DEVICE ASSISTED SERVICES; U.S. Provisional Application No. 61/252,153 (Attorney Docket No. RALEP026+), filed Oct. 15, 2009, entitled DEVICE GROUP PARTITIONS AND SETTLEMENT PLATFORM; U.S. Provisional Application No. 61/264,120 (Attorney Docket No. RALEP027+), filed Nov. 24, 2009, entitled DEVICE ASSISTED SERVICES INSTALL; U.S. Provisional Application No. 61/264,126 (Attorney Docket No. RALEP028+), filed Nov. 24, 2009, entitled DEVICE ASSISTED SERVICES ACTIVITY MAP; U.S. Provisional Application No. 61/348,022 (Attorney Docket No. RALEP031+), filed May 25, 2010, entitled DEVICE ASSISTED SERVICES FOR PROTECTING NETWORK CAPACITY; U.S. Provisional Application No. 61/381,159 (Attorney Docket No. RALEP032+), filed Sep. 9, 2010, entitled DEVICE ASSISTED SERVICES FOR PROTECTING NETWORK CAPACITY; U.S. Provisional Application No. 61/381,162 (Attorney Docket No. RALEP033+), filed Sep. 9, 2010, entitled SERVICE CONTROLLER INTERFACES AND WORKFLOWS; U.S. Provisional Application No. 61/384,456 (Attorney Docket No. RALEP034+), filed Sep. 20, 2010, entitled SECURING SERVICE PROCESSOR WITH SPONSORED SIMS; U.S. Provisional Application No. 61/389,547 (Attorney Docket No. RALEP035+), filed Oct. 4, 2010, entitled USER NOTIFICATIONS FOR DEVICE ASSISTED SERVICES; U.S. Provisional Application No. 61/385,020 (Attorney Docket No. RALEP036+), filed Sep. 21, 2010, entitled SERVICE USAGE RECONCILIATION SYSTEM OVERVIEW; U.S. Provisional Application No. 61/387,243 (Attorney Docket No. RALEP037+), filed Sep. 28, 2010, entitled ENTERPRISE AND CONSUMER BILLING ALLOCATION FOR WIRELESS COMMUNICATION DEVICE SERVICE USAGE ACTIVITIES; U.S. Provisional Application No. 61/387,247 (Attorney Docket No. RALEP038+), filed September 28, entitled SECURED DEVICE DATA RECORDS, 2010; U.S. Provisional Application No. 61/407,358 (Attorney Docket No. RALEP039+), filed Oct. 27, 2010, entitled SERVICE CONTROLLER AND SERVICE PROCESSOR ARCHITECTURE; U.S. Provisional Application No. 61/418,507 (Attorney Docket No. RALEP040+), filed Dec. 1, 2010, entitled APPLICATION SERVICE PROVIDER INTERFACE SYSTEM; U.S. Provisional Application No. 61/418,509 (Attorney Docket No. RALEP041+), filed Dec. 1, 2010, entitled SERVICE USAGE REPORTING RECONCILIATION AND FRAUD DETECTION FOR DEVICE ASSISTED SERVICES; U.S. Provisional Application No. 61/420,727 (Attorney Docket No. RALEP042+), filed Dec. 7, 2010, entitled SECURE DEVICE DATA RECORDS; U.S. Provisional Application No. 61/422,565 (Attorney Docket No. RALEP043+), filed Dec. 13, 2010, entitled SERVICE DESIGN CENTER FOR DEVICE ASSISTED SERVICES; U.S. Provisional Application No. 61/422,572 (Attorney Docket No. RALEP044+), filed Dec. 13, 2010, entitled SYSTEM INTERFACES AND WORKFLOWS FOR DEVICE ASSISTED SERVICES; U.S. Provisional Application No. 61/422,574 (Attorney Docket No. RALEP045+), filed Dec. 13, 2010, entitled SECURITY AND FRAUD DETECTION FOR DEVICE ASSISTED SERVICES; U.S. Provisional Application No. 61/435,564 (Attorney Docket No. RALEP046+), filed Jan. 24, 2011, entitled FRAMEWORK FOR DEVICE ASSISTED SERVICES; U.S. Provisional Application No. 61/472,606 (Attorney Docket No. RALEP047+), filed Apr. 6, 2011, entitled MANAGING SERVICE USER DISCOVERY AND SERVICE LAUNCH OBJECT PLACEMENT ON A DEVICE; U.S. Provisional Application No. 61/550,906 (Attorney Docket No. RALEP048+), filed Oct. 24, 2011, entitled SECURITY FOR DEVICE-ASSISTED SERVICES; U.S. Provisional Application No. 61/589,830 (Attorney Docket No. RALEP052+), filed Jan. 23, 2012, entitled METHODS AND APPARATUS TO PRESENT INFORMATION ABOUT VOICE, MESSAGING, AND DATA SERVICES ON WIRELESS MOBILE DEVICES; U.S. Provisional Application No. 61/610,876 (Attorney Docket No. RALEP062+), filed Mar. 14, 2012, entitled METHODS AND APPARATUS FOR APPLICATION PROMOTION AND SPONSORSHIP; U.S. Provisional Application No. 61/610,910 (Attorney Docket No. RALEP063+), filed Mar. 14, 2012, entitled WIFI ACTIVATION BACKUP PROCESS; U.S. Provisional Application No. 61/658,339 (Attorney Docket No. RALEP100+), filed Jun. 11, 2012, entitled MULTI-DEVICE MASTER SERVICES ACCOUNTS, SERVICE PLAN SHARING AND ASSIGNMENTS, AND DEVICE MANAGEMENT FROM A MASTER DEVICE; U.S. Provisional Application No. 61/667,927 (Attorney Docket No. RALEP101+), filed Jul. 3, 2012, entitled FLEXIBLE MULTI-DEVICE MASTER SERVICE ACCOUNTS, SERVICE PLAN SHARING AND ASSIGNMENTS, AND DEVICE MANAGEMENT; U.S. Provisional Application No. 61/674,331 (Attorney Docket No. RALEP102+), filed Jul. 21, 2012, entitled SERVICE CONTROLLER FOR MANAGING CLOUD-BASED POLICY; U.S. Provisional Application No. 61/724,267 (Attorney Docket No. RALEP106+), filed Nov. 8, 2012, entitled FLEXIBLE SERVICE PLAN DESIGN, USER INTERFACE AND DEVICE MANAGEMENT; U.S. Provisional Application No. 61/724,837 (Attorney Docket No. RALEP107+), filed Nov. 9, 2012, entitled SERVICE PLAN DISCOVERY, CUSTOMIZATION, AND MANAGEMENT; U.S. Provisional Application No. 61/724,974 (Attorney Docket No. RALEP108+), filed Nov. 10, 2012, entitled SERVICE PLAN DISCOVERY, CUSTOMIZATION, AND MANAGEMENT; U.S. Provisional Application No. 61/732,249 (Attorney Docket No. RALEP109+), filed Nov. 30, 2012, entitled APPLICATION PROGRAMMING INTERFACES FOR SMART SERVICES; U.S. Provisional Application No. 61/734,288 (Attorney Docket No. RALEP110+), filed Dec. 6, 2012, entitled INTERMEDIATE NETWORKING DEVICE SERVICES; and U.S. Provisional Application No. 61/745,548 (Attorney Docket No. RALEP111+), filed Dec. 22, 2012, entitled SERVICE PLAN DESIGN, USER INTERFACES, APPLICATION PROGRAMMING INTERFACES, AND DEVICE MANAGEMENT; U.S. Provisional Application No. 61/756,332 (Attorney Docket No. RALEP112+), filed Jan. 24, 2013, entitled MOBILE HOTSPOT; U.S. Provisional Application No. 61/758,964 (Attorney Docket No. RALEP113+), filed Jan. 30, 2013, entitled MOBILE HOTSPOT; U.S. Provisional Application No. 61/765,978 (Attorney Docket No. RALEP114+), filed Feb. 18, 2013, entitled ENHANCED CURFEW AND PROTECTION ASSOCIATED WITH A DEVICE GROUP; U.S. Provisional Application No. 61/785,988 (Attorney Docket No. RALEP115+), filed Mar. 14, 2013, entitled AUTOMATED CREDENTIAL PORTING FOR MOBILE DEVICES; U.S. Provisional Application No. 61/794,116 (Attorney Docket No. RALEP116+), filed Mar. 15, 2013, entitled ENHANCED INTERMEDIATE NETWORKING DEVICE; U.S. Provisional Application No. 61/792,765 (Attorney Docket No. RALEP117+), filed Mar. 15, 2013, entitled DEVICE GROUP AND SERVICE PLAN MANAGEMENT; U.S. Provisional Application No. 61/793,894 (Attorney Docket No. RALEP118+), filed Mar. 15, 2013, entitled SIMPLIFIED POLICY DESIGN, MANAGEMENT, AND IMPLEMENTATION; U.S. Provisional Application No. 61/799,710 (Attorney Docket No. RALEP119+), filed Mar. 15, 2013, entitled AMBIENT OR SPONSORED SERVICES; U.S. Provisional Application No. 61/801,074 (Attorney Docket No. RALEP120+), filed Mar. 15, 2013, entitled DEVICE GROUP AND SERVICE PLAN MANAGEMENT; and U.S. Provisional Application No. 61/822,850 (Attorney Docket No. RALEP121+), filed May 13, 2013, entitled MOBILE DEVICE AND SERVICE MANAGEMENT.

### BACKGROUND

With the advent of mass market digital communications and content distribution, many access networks such as wireless networks, cable networks and DSL (Digital Subscriber Line) networks are pressed for user capacity, with, for example, EVDO (Evolution-Data Optimized), HSPA (High Speed Packet Access), LTE (Long Term Evolution), WiMAX (Worldwide Interoperability for Microwave Access), and Wi-Fi (Wireless Fidelity) wireless networks increasingly becoming user capacity constrained. Although wireless network capacity will increase with new higher capacity wireless radio access technologies, such as MIMO (Multiple-Input Multiple-Output), and with more frequency spectrum being deployed in the future, these capacity gains are likely to be less than what is required to meet growing digital networking demand.

Similarly, although wire line access networks, such as cable and DSL, can have higher average capacity per user, wire line user service consumption habits are trending toward very high bandwidth applications that can quickly consume the available capacity and degrade overall network service experience. Because some components of service provider costs go up with increasing bandwidth, this trend will also negatively impact service provider profits.

### BRIEF DESCRIPTION OF THE DRAWINGS

Various embodiments of the invention are disclosed in the following detailed description and the accompanying drawings.

FIG. 1 illustrates a high level diagram of an advanced wireless service platform end-to-end DDR reporting and processing system in accordance with some embodiments.

FIG. 2A illustrates a process for booting, executing, and updating the DDR firmware in accordance with some embodiments.

FIG. 2B illustrates a nonvolatile memory configuration based on a security level in accordance with some embodiments.

FIG. 2C illustrates another non-volatile memory configuration into partitions in accordance with some embodiments.

FIG. 2D illustrates another non-volatile memory configuration into partitions in accordance with some embodiments.

FIG. 2E illustrates another non-volatile memory configuration into partitions in accordance with some embodiments.

FIG. 3 illustrates an architecture for a secure embedded DDR Processor in an APU implementation in accordance with some embodiments.

FIG. 4 illustrates another architecture for a secure embedded DDR Processor in an APU implementation along with a modem bus driver in accordance with some embodiments.

FIG. 5 illustrates another architecture for a secure embedded DDR Processor in an APU implementation along with a modem bus driver in accordance with some embodiments.

FIG. 6 illustrates an architecture for a secure embedded DDR Processor in an MPU implementation in accordance with some embodiments.

FIG. 7 illustrates another architecture for a secure embedded DDR Processor in an MPU implementation in accordance with some embodiments.

FIG. 8 illustrates an architecture for a secure embedded DDR Processor in an APU and a Data Path Security Verifier (DPSV) in an MPU implementation in accordance with some embodiments.

FIG. 9 illustrates an architecture for a secure embedded DDR Processor in a Subscriber Identity Module (SIM) and a Data Path Security Verifier (DPSV) in an MPU implementation in accordance with some embodiments.

FIG. 10 illustrates another architecture for a secure embedded DDR Processor in a Subscriber Identity Module (SIM) and a Data Path Security Verifier (DPSV) in an MPU implementation in accordance with some embodiments.

FIG. 11 illustrates another architecture for a secure embedded DDR Processor in a Subscriber Identity Module (SIM) and a Data Path Security Verifier (DPSV) in an MPU implementation in accordance with some embodiments.

FIG. 12 illustrates a secure boot sequence flow diagram in accordance with some embodiments.

FIG. 13 illustrates a functional diagram for passing DDR Service Processor mailbox messages between secure and unsecure memory regions in accordance with some embodiments.

FIG. 14 illustrates a flow diagram for a DDR Processor Service Controller session authentication and verification in accordance with some embodiments.

FIG. 15 illustrates a flow diagram for secure device data records for implementing device assisted services (DAS) in accordance with some embodiments.

FIG. 16 illustrates an advanced wireless service platform end-to-end DDR reporting and processing system in accordance with some embodiments.

FIG. 17A illustrates a non-volatile memory configuration into partitions and a chipset (comprising one or more processors) program (or executable) configuration in accordance with some embodiments.

FIG. 17B illustrates a non-volatile memory configuration into partitions and a chipset program configuration in accordance with some embodiments.

FIG. 18 illustrates a wireless network architecture for providing device assisted services (DAS) install techniques in accordance with some embodiments.

FIG. 19 illustrates a block diagram of a communications device in accordance with some embodiments.

FIG. 20 illustrates operations of one or more processors of a communications device in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Disclosed herein is a communications device comprising one or more non-volatile memories capable of being partitioned into at least a first partition and a second partition. The first partition is for storing at least a portion of device system software, where the at least a portion of device system software is associated with a first security element. The second partition is for storing at least a portion of a service processor, where the at least a portion of the service processor has one or more system execution properties enabling the at least a portion of the service processor to enhance or augment the device system software. The at least a portion of the service processor is associated with a second security element. The second partition may have lower security than the first partition. The second partition may be a subpartition of the first partition. The first partition may contain a symlink to the second partition. The first partition and the second partition may be associated with or linked to each other using one or more hooks, one or more callbacks, one or more symlinks, or based on software code instructions. The first partition may be part of a system partition. The second partition may be associated with a service provider, a carrier, a mobile virtual network operator (MVNO), or a mobile virtual network enabler (MVNE). The second partition may be at least a portion of a carrier partition or at least a portion of an OEM partition. The second partition may be at least a portion of a user partition or at least a portion of a data partition.

The first security element or the second security element may comprise a certificate, a key, a hash, a chained hash, a credential, or a signature. The one or more non-volatile memories may be configured to store the first security element or the second security element, or both security elements. The first security element or the second security element may be stored in a system file. The first security element and/or the second security element may be managed by or associated with an original equipment manufacturer (OEM), a carrier, a system installation function, a recovery function, or a combination of these.

The service processor may comprise a kernel or framework component. A component of the service processor may be associated with a system user identifier (ID), a system group ID, or a combination of these. The at least a portion of the service processor may at least assist in implementing a service policy or a service plan. If so, the service policy or a service plan may at least assist to manage at least an aspect of the communications device, monitor usage of a network or of a service by the communications device, account for usage of the network or of the service by the communications device, control usage of the network or of the service by the communications device, provide a notification through a user interface of the communications device, or a combination of these.

The communications device further comprises one or more processors configured to execute one or more instructions that, when executed by the one or more processors, cause the one or more processors to verify an integrity of the at least a portion of device system software using the first security element, verify an integrity of the at least a portion of the service processor using the second security element, obtain the at least a portion of the service processor from the one or more non-volatile memories, execute the obtained at least a portion of the service processor, thereby enhancing or augmenting the device system software, and update, install, remove, or modify the at least a portion of the service processor in the second partition of the one or more non-volatile memories without affecting the at least a portion of the device system software in the first partition.

Verifying the integrity of the at least a portion of the service processor using the second security element may comprise signing, encrypting, decrypting, or hashing the at least a portion of the service processor using the second security element. Verifying the integrity of the at least a portion of the service processor using the second security element may comprise verifying the integrity of the at least a portion of the service processor using the second security element before, during, or after a download of the at least a portion of the service processor. Verifying the integrity of the at least a portion of the service processor using the second security element may comprise verifying the integrity of the at least a portion of the service processor using the second security element before, during, or after an installation of the at least a portion of the service processor. Verifying the integrity of the at least a portion of the service processor using the second security element may comprise verifying the integrity of the at least a portion of the service processor using the second security element before, during, or after an update of the at least a portion of the service processor. Verifying the integrity of the at least a portion of the service processor using the second security element may comprise verifying the integrity of the at least a portion of the service processor using the second security element before, during, or after a launch, a load, or an execution of the at least a portion of the service processor.

Update, installing, removing, or modifying the at least a portion of the service processor in the second partition of the one or more non-volatile memories without affecting the at least a portion of the device system software in the first partition may comprise updating or modifying a first version of the service processor to provide a second version of the service processor without updating or modifying the system software. Update, installing, removing, or modifying the at least a portion of the service processor in the second partition of the one or more non-volatile memories without affecting the at least a portion of the device system software in the first partition may comprise installing or removing the at least a portion of the service processor or a second portion of the service processor without updating or modifying the system software.

When executed by the one or more processors, the one or more instructions may further cause the one or more processors to create the second partition during an installation of the at least a portion of the service processor.

The at least a portion of the service processor may be a first portion of the service processor, and the one or more non-volatile memories may be further capable of being partitioned into a third partition, the third partition for storing a second portion of the service processor. If so, the second portion of the service processor may be associated with a third security element. When executed by the one or more processors, the one or more instructions may further cause the one or more processors to update, install, remove, or modify the second portion of the service processor in the third partition of the one or more non-volatile memories without affecting the first portion of the service processor in the second partition.

When executed by the one or more processors, the one or more instructions may further cause the one or more processors to update or modify the at least a portion of device system software using the first security element.

Also disclosed herein is a non-transitory computer-readable storage medium storing one or more machine-executable instructions that, when executed by one or more processors of a communications device, cause the one or more processors to: verify an integrity of at least a portion of device system software using a first security element, the at least a portion of the device system software being stored in a first partition of one or more non-volatile memories, verify an integrity of at least a portion of a service processor using a second security element, the at least a portion of the service processor being stored in a second partition of the one or more non-volatile memories, the at least a portion of the service processor having one or more system execution properties enabling the at least a portion of the service processor to enhance or augment the device system software, obtain the at least a portion of the service processor from the one or more non-volatile memories, execute the obtained at least a portion of the service processor, thereby enhancing or augmenting the device system software, and update, install, remove, or modify the at least a portion of the service processor in the second partition of the one or more non-volatile memories without affecting the at least a portion of the device system software in the first partition.

In some embodiments, secure device data records (DDRs) are provided. In some embodiments, secure DDRs for device assisted services are provided. In some embodiments, secure DDRs for device assisted services are provided for service usage monitoring of a wireless communication device (e.g., firmware based monitoring of network service usage, such as based on a 5-tuple of a source address, port address, destination address, destination port, and protocol). In some embodiments, secure DDRs for device-assisted services are provided for service usage monitoring of a wireless connection and other input/output (I/O) connections or ports of a wireless communication device (e.g., firmware-based monitoring of network service usage, such as based on a 5-tuple of a source address, port address, destination address, destination port, and protocol). In some embodiments, a system for secure DDRs includes a processor of a wireless communication device for wireless communication with a wireless network, in which the processor is configured with a secure execution environment, and in which the secure execution environment is configured to: monitor service usage of the wireless communication device with the wireless network; and generate a plurality of device data records of the monitored service usage of the wireless communication device with the wireless network, in which each device data record is associated with a unique sequence order identifier; and a memory coupled to the processor and configured to provide the processor with instructions. In some embodiments, a system for secure DDRs includes a processor of a wireless communication device for wireless communication with a wireless network, in which the processor is configured with a secure execution environment, the secure execution environment configured to: monitor service usage of the wireless communication device with one or more of the networks and I/O connections for the device including but not limited to a wide area wireless network (e.g., 2G, 3G, 4G, etc.), a Wi-Fi network or connection, a USB network or connection, an Ethernet network or connection, a FireWire connection, a Bluetooth connection, a near field communication (NFC) connection or another I/O connection or port; and generate a plurality of device data records of the monitored service usage of the wireless communication device with the wireless network, in which each device data record is associated with a unique sequence order identifier; and a memory coupled to the processor and configured to provide the processor with instructions. In some embodiments, the secure execution environment including the secure DDR processor is located in an application processor, in a modem processor, and/or in a subscriber identity module (SIM).

In many of the disclosed embodiments, a secure device data record processing system acts on communications that flow over a wide area wireless network connection to the device (e.g., a 2G, 3G, or 4G connection) or a wide area wireless modem (e.g., a 2G, 3G, or 4G modem). As would be understood by one of ordinary skill in the art, the secure device data record processing system can also act on communications that flow over one or more additional I/O networks, connections, ports or modems (e.g., a Wi-Fi network, connection, port, or modem; a USB network, connection, port, or modem; an Ethernet network, connection, port, or modem; a FireWire network, connection, port, or modem; a Bluetooth network, connection, port, or modem; a near field communication (NFC) network, connection, port, or modem; or another I/O connection, port, or modem).

In some embodiments, a system for secure DDRs includes a processor of a wireless communication device for wireless communication with a wireless network, in which the processor is configured with a secure execution environment, and in which the secure execution environment is configured to: monitor service usage of the wireless communication device with the wireless network (and possibly one or more additional I/O connections for the device); and generate a plurality of device data records of the monitored service usage of the wireless communication device with the wireless network (and possibly one or more additional I/O connections for the device), in which each device data record is one of an ordered sequence of device data records with each sequential device data record providing an accounting of service usage over a service usage interval spanned by the device data record, and in which each device data record is associated with a secured unique sequence order identifier; and a memory coupled to the processor and configured to provide the processor with instructions. In this manner, communication activity (for example text, SMS, voice, data) over a device wireless access network connection (or other I/O port communication connection) is securely monitored and reported to a network server for further processing to determine if device access service policies are being properly enforced, or to determine of malicious software in the device operating environment is accessing the network (or other I/O connection or port). In some embodiments, the secure execution including the secure DDR processor environment is located in an application processor, in a modem processor, and/or in a subscriber identity module (SIM).

In some embodiments, a communication channel for delivering secure device data records to a network server for further analysis and processing includes a secure message receipt feedback loop, and if the secure message feedback loop is interrupted, a device environment security error condition is detected and acted on. In some embodiments, the ordered sequence of device data records is communicated to a service controller using a signed or encrypted communication channel. In some embodiments, the service controller observes the device data records to determine compliance with a device-based access network (or other I/O connections or ports) access policy. In some embodiments, the service controller also observes the integrity of the ordered sequence of device data records to determine if device data records have been tampered with, omitted or added. In some embodiments, if the service controller determines that the device data records have not been tampered with, omitted or added, the service controller sends back a signed or encrypted device data record receipt message. In some embodiments, if the service processor determines that the device data records have been tampered with or omitted, the service controller sends back an error message or does not send back a signed or encrypted device data record receipt message. In some embodiments, if the system for secure DDRs receives an error message from the service controller, or does not receive a signed or encrypted device data record receipt message within a certain period of time or within a certain number of transmitted device data records or within a certain amount of communication information processed, then (i) a device configuration error message can be generated for delivery to a security administrator or server, or (ii) one or more of the wireless network connections (or other I/O connection or port) for the wireless communication device are either blocked or restricted to a pre-determined set of safe destinations. In this manner, if a device service processor, the device operating environment, device operating system or device software is tampered with in a manner that produces wireless network (or other I/O port) access service usage characteristics that are not compliant with expected policy or allowed policy, a device configuration error message can be generated or device wireless network access (or other I/O connection access) can be restricted or blocked. Such embodiments can be helpful in securing device based network access (or I/O control) policies and can also be helpful in identifying device software that has been tampered with or any malware that is present on the device. In some embodiments, the restriction on wireless network access (or other I/O access) results in access to a limited number of network destinations or resources sufficient to allow further analysis or troubleshooting of the device configuration error condition.

Various techniques for providing device assisted services (DAS), are disclosed in co-pending U.S. patent application Ser. No. 12/380,780 (Attorney Docket No. RALEP007), entitled AUTOMATED DEVICE PROVISIONING AND ACTIVATION, filed on Mar. 2, 2009, published as U.S. Pub. No. 2010/0192212; U.S. application Ser. No. 12/695,019 (Attorney Docket No. RALEP022), filed Jan. 27, 2010, entitled DEVICE ASSISTED CDR CREATION, AGGREGATION, MEDIATION AND BILLING, now U.S. Pat. No. 8,275,830 (issued Sep. 25, 2012); and U.S. application Ser. No. 12/694,445 (Attorney Docket No. RALEP025), filed Jan. 27, 2010, entitled SECURITY TECHNIQUES FOR DEVICE ASSISTED SERVICES, now U.S. Pat. No. 8,391,834 (issued Mar. 5, 2013), which are hereby incorporated by reference for all purposes.

In some embodiments, a DDR processor is provided for wireless communication devices (e.g., for assisting in implementation of device assisted services (DAS) for wireless network service usage for wireless communication devices, such as a cellular phone, smart phone, laptop, PDA, gaming device, music device, tablet, computer, and/or any other device with wireless communication access) as described herein with respect to various embodiments. In some embodiments, a secure DDR processor (e.g., implemented/executed in a secure execution environment) is provided. In some embodiments, a DDR processor is secured using various techniques described herein. In some embodiments, the DDR processor includes a DDR generator. In some embodiments, the DDR processor generates DDRs. In some embodiments, the DDR processor reports DDRs to a network element (e.g., a service controller, a DDR network storage system, and/or another network element). In some embodiments, the secure DDR processor reports the DDRs to a device element/function, such as a service processor, which aggregates the DDRs (e.g., and can include other service usage and/or other information) in a report (e.g., or service processor reports) that is communicated to a network element. In some embodiments, DDRs as well as service processor reports are generated and communicated to a network element. In some embodiments, a DDR processor is secured using various techniques described herein.

In some embodiments, DDRs include device assisted and/or device based monitored service usage (e.g., based on various criteria, such as for a specified time interval, and/or event) as described herein with respect to various embodiments. In some embodiments, DDRs are periodically reported. In some embodiments, DDRs are reported based on an event and/or a request from a network element (e.g., a service controller or another network element/function). In some embodiments, DDRs are communicated to a device service processor (e.g., or another device element/function), which aggregates such DDRs and periodically provides service usage reports including such DDRs or providing such service usage reports based on a request and/or an event. In some embodiments, each DDR includes a unique identifier (e.g., a unique sequence identifier). In some embodiments, a missing DDR can be detected using the unique identifiers (e.g., sequence count and/or time stamp information associated with each DDR allows for detection of a potentially suspicious service usage event, such as a missing, delayed, and/or compromised device data record determined using the sequence count and/or time stamp information, and responsive/corrective actions can be performed upon detection of the suspicious service usage event, as described herein). In some embodiments DDRs could also contain a chained hash (e.g. checksum of output from a CBC cipher) to aid in DDR tamper detection. In some embodiments, if a DDR is not received within a certain time period, then an access controller is activated to limit network access until DDRs are properly generated and reported (e.g., a network element, such as a service controller, sends a keep alive signal to the device to implement a time out period for verifying receipt of properly generated and validated DDRs from the device, and if the keep alive signal is not received within a specified time period, then the device based secured access controller can implement the restricted network access control function).

In some embodiments, a DDR network storage system is provided as described herein with respect to various embodiments. In some embodiments, a service controller is provided that includes the DDR network storage system and a DDR reconciliation function (e.g., for reconciling DDR records and/or DDR reports or other device based and/or network based service usage reports, such as CDRs, micro CDRs, and/or IPDRs or other service usage reports). In some embodiments, a network based reconciliation function reconciles DDRs (e.g., aggregated DDRs and/or DDR reports) with one or more network based service usage measures. In some embodiments, the network based reconciliation function reconciles DDRs with two or more network based service usage measures. In some embodiments, the network based reconciliation function reconciles DDRs with two or more network based service usage measures (e.g., CDRs, FDRs, IPDRs, DPI based measures including traffic related events, such as NBS and/or QoS, and/or other network based service usage measures). In some embodiments, the network based reconciliation function reconciles two or more device based service usage measures (e.g., DDRs, service processor reports, and/or other device based service usage measures including traffic related events, such as NBS and/or QoS) with a network based service usage measure. In some embodiments, the network based reconciliation function reconciles two or more device based service usage measures with two or more network based service usage measures. In some embodiments, the network based reconciliation function reconciles two or more device based service usage measures, in which one of the device based service usage measures is secured (e.g., deemed as secured and/or trusted based on various techniques described herein, such as for secure DDRs) and one or more of the other device based service usage measures is not secured (e.g., not completely trusted, such as a service processor reports generated by a service processor that is not implemented in a secure execution environment). In some embodiments, the reconciliation function reconciles based on various different reporting formats, such as time measure intervals, units of measure, and/or other different criteria used by different device and network based various service usage measures.

In some embodiments, a secure access controller is provided as described herein with respect to various embodiments. In some embodiments, the DDR processor includes the secure access controller. In some embodiments, the secure access control ensures that a wireless communication device with DAS does not have open network access until and/or unless the device is properly generating and reporting secure DDRs.

In some embodiments, the DDR processor includes a network busy state (NBS) monitoring and reporting function that is secured as described herein with respect to various embodiments. In some embodiments, a network element aggregates NBS information received from one or more wireless communication devices from the same sector and/or from various sectors within the service vicinity and establishes either the same network busy state rules (e.g., access control, charging and notification) and/or changes the exiting NBS rules appropriately.

In some embodiments, a secured boot sequence is provided. In some embodiments, the secured boot sequence ensures that the DDR processor is secured and properly generating DDRs prior to providing open network access control to the wireless communication device. In some embodiments, the secured boot sequence includes using the secure access controller to restrict network access until the secured boot sequence is completed. In some embodiments, the secure boot sequence includes verifying DDR ACK and receipt frames.

In some embodiments, a processor of a wireless communication device for wireless communication with a wireless network is provided, in which the processor is configured with a secure software or firmware instruction execution environment, and in which a program in the secure software or firmware instruction execution environment is configured to: monitor service usage of the wireless communication device with the wireless network; generate a plurality of device data records (DDRs) of the monitored service usage of the wireless communication device with the wireless network, in which the device data records are secure device data records for the monitored service usage, in which each device data record forms a portion of an ordered sequence of device data records with each sequential device data record providing an accounting of service usage over a service usage interval spanned by the device data record, and in which each device data record is associated with a unique sequence order identifier that is also secured.

In some embodiments, the sequence of device data records forms a contiguous and uninterrupted reporting of device service usage while the device is active on the network. In some embodiments, the secure software or firmware instruction execution environment is located and configured such that the network can only be accessed through a data path that is monitored by the program in the secure software or firmware instruction execution environment. In some embodiments, the secure software or firmware instruction execution environment is located in a modem processor (e.g., MPU). In some embodiments, the secure software or firmware instruction execution environment is located in an application processor (e.g., APU). In some embodiments, the secure software or firmware instruction execution environment is located in a subscriber identity module (SIM) (e.g., SIM card). In some embodiments, the secure software or firmware instruction execution environment is located in a combination of an APU, MPU, and/or SIM.

In some embodiments, the device data records are secured using various cryptographic techniques described herein, such as using one or more of the following: encryption, digital signatures, and integrity checks.

In some embodiments, a DDR processor located in a secure execution environment is configured to communicate a sequence of device data records to a device data record storage function, such as within a network element (e.g., a service controller), in which the plurality of secure device data records in combination with the unique sequence identifier provides traceability to identify if one or more usage records have been tampered with or omitted from the sequence of data records transmitted to the storage function. In some embodiments, the unique sequence identifier includes one or more of the following: sequence count, time stamp, start time indicator, stop time indicator, contiguous time interval identifier, and aggregate usage count at the beginning or end of the record, reference time, or elapsed time at the beginning or end of the record.

In some embodiments, the generation of a new device data record is determined by one or more of the following: a predetermined time, elapsed period of time, elapsed period of time since last report, maximum limit on elapsed period of time since last report, amount of one or more aspects of aggregate data usage, amount of one or more aspects of data usage since last report, maximum limit for one or more aspects of data usage since last report, a location or change in location, a network (e.g. roaming) or change of network, a number or chance of number of devices sharing a plan, expiration of a plan, a request to generate a DDR, a limit on maximum amount of memory or storage media required to contain or process DDR information prior to transmission, device power on or power off, modem or device subsystem power on or power off, modem or device subsystem entering or exiting a power save state, device or device subsystem authentication with a network element or server, or a detected event triggered by one or more service usage activities or detection of a service usage record tampering or fraud event or transition to a new network busy state and/or QoS traffic event.

In some embodiments, the DDR processor, service processor, or another device based element/function transmits DDRs based on one or more of the following: maximum time increment, maximum service usage increment, polling from service processor, and/or polling from service controller. In some embodiments, a maximum time increment on DDR transmissions is established to ensure minimal or no services can be hijacked once service controller authentication takes place. In some embodiments, at least a portion of the restricted set of network service activities includes access to the service controller or other network elements necessary to manage the ability of the device to access the network once the service controller authenticates with the service processor and conforms proper operation of the secure DDR generator. In some embodiments, at least a portion of the restricted set of network service activities includes access to a minimum set of roaming network service activities required to initiate the process for a roaming network to authenticate access privileges for the device. In some embodiments, at least a portion of the restricted set of network service activities includes access to a minimum set of roaming network service activities required to initiate the process for a corporate network to authenticate access privileges for the device. In some embodiments, at least a portion of the restricted set of network service activities includes access to a minimum set of roaming network service activities required to initiate the process for an MVNO network to authenticate access privileges for the device. In some embodiments, at least a portion of the more permissive set of service activities is able to access at least a subset of the services available on a roaming network. In some embodiments, at least a portion of the more permissive set of service activities is able to access at least a subset of the services available on an MVNO network. In some embodiments, at least a portion of the more permissive set of service activities is able to access at least a subset of the services available on a corporate network. In some embodiments, at least a portion of the more permissive set of service activities is able to access carrier provisioning services.

In some embodiments, the device data record service usage information includes measurement of one or more of the following: voice service (e.g., VOIP) usage records; text service usage records; data network service usage records; data network flow data records; data network general purpose, aggregate or bulk service usage records; service usage classified at least in part by far end destination; service usage records classified at least in part by layer 3 network communications information such as IP address or ATM address; service usage classified at least in part by layer 4 network communications information such as IP address and port combinations; data network service usage records comparable to network based flow data records such as network based FDRs, CDRs or IPDRs; service usage classified at least in part by time of day; service usage classified at least in part by geographic location; service usage classified at least in part by the active network servicing the device; service usage classified at least in part by a roaming network connected to the device; service usage classified at least in part by network busy state or network congestion; service usage classified at least in part by QoS, service usage records classified at least in part by layer 7 network communications information such as server name, domain name, URL, referrer host or application service flow information; service usage classified at least in part by network communications protocol such as TCP, UDP, DNS, SMTP, IMAP, POP, FTP, HTTP, HTML, VOIP; service usage classified at least in part by the application name or the application identifier assigned by the operating system or another application identifier unique to the application acquiring or requesting service (e.g., device user identifier, such as Android user ID on an Android based device); and service usage classified at least in part by service activity. In some embodiments, the device data record service usage information includes measurement (and/or classification) of one or more of the following: based on data rate (e.g. streaming) or remote logical network (e.g. APN).

In some embodiments, the DDR processor located in the secure execution environment is configured to send the device data records to a network element (e.g., storage function located in the network). In some embodiments, the DDR processor located in the secure execution environment is configured to provide a secure communication channel between the secure software or firmware instruction execution environment and the storage function located in the network (e.g., a network element, such as a service controller), in which the communication channel security protocol is configured to avoid tampering with the secure device data records (DDRs). In some embodiments, the DDR processor located in the secure execution is configured to perform an authentication sequence or process with a network element (e.g., a service controller) in which a secure device data record sequence initiation message is sent to a network destination followed by authentication protocol exchange sequences to authenticate the network element before transmitting the secure data records.

In some embodiments, the DDR processor (or one or more other service processor components) located in the secure execution environment is configured to perform the following: send the device data record sequence to a network element (e.g., via a secure channel); implement a secure access controller for restricting network access to a predetermined subset of available network destinations; receive a secure message from a trusted network element (e.g., either directly from the network element or from another function on the device that forwards the secure messages from the network element to the DDR processor in the secure execution environment); if a validated (e.g., properly secured and configured) message is received that acknowledges receipt of one or more secure device data records or acknowledges an access network authentication sequence, then the secure access controller allows unrestricted or less restricted access to the network; if a validated message is not received that acknowledges receipt of one or more secure device data records or acknowledges an access network authentication sequence, then the secure access controller restricts access to a predetermined set of network destinations or functions until a validated message is received that acknowledges receipt of one or more secure device data records or acknowledges an access network authentication sequence.

In some embodiments, the DDR processor located in the secure execution environment is configured with an access controller that restricts access to a predetermined set of network destinations or functions if a predetermined maximum amount of time passes between: the time that a first message acknowledging receipt of one or more secure device data records or an authentication sequence is received by the DDR processor in the secure execution environment and the time that a second message acknowledging receipt of one or more secure device data records or an authentication sequence is received by the DDR processor in the secure execution environment; or the time that one or more secure device data records are sent by the DDR processor in the secure execution environment and the time that a message acknowledging receipt of one or more secure device data records or an authentication sequence is received by DDR processor in the secure execution environment; and the access controller otherwise allows unrestricted or less restricted access to the network.

In some embodiments, the DDR processor located in the secure execution environment is configured to send the device data record to the device data record storage function located in the network by first sending it to a second program function located on the device that then forwards the device data record to the device data record storage function located in the network. In some embodiments, the DDR processor located in the secure execution environment is configured to provide a second service usage report sequence in addition to the secure device data record sequence. In some embodiments, another client function/element (e.g., a service processor function/element or agent) is configured to provide a second service usage report sequence in addition to the secure device data record sequence. In some embodiments, the second service usage report sequence includes service usage classification that is different at least in part from the secure device data records. In some embodiments, the difference between device data usage classification includes at least in part that one record includes one or more of the following: application information, layer 7 network information, service flow association information, user defined input information, network busy state information, active network information or other information while the other record does not.

In some embodiments, the DDR processor located in the secure execution environment is configured to send the device data record sequence and the second device data record sequence in a manner that allows for simplified reconciliation of the two records. In some embodiments, the DDR processor located in the secure execution environment is configured to provide the second service usage report sequence in a manner that provides approximate alignment of a measurement interval start time and stop time spanned by one or more of the second service usage reports and the measurement interval spanned by one or more of the secure device data records.

In some embodiments, the DDR processor located in the secure execution environment is configured to: be based on the monitoring of service usage of the wireless communication device with the wireless communication network, create and record characterizations of network performance; analyze the characterizations of network performance and reduce the performance characterizations into one or more network performance statistics that characterize in summary form the performance level or congestion level of the network as experienced by the device; generate a plurality of network performance report messages that include a sequence of the network performance statistics created at different times; in which the network performance report messages are secured network performance reports; and send the secured network performance reports to the storage function located in the network.

In some embodiments, a processor of a network device configured as a device data record storage and processing function, for wireless communication with a wireless network in wireless communication with a plurality of wireless communication devices, with each wireless device including a secure device data record generator, in which the processor of the network device is further configured to: provide individual secure communication channels between each of the plurality of secure device data record processor and the network device, in which the communication channel security protocol is configured so that tampering with the device data records may be detected; receive over the secure communications channel a plurality of device data records from each of the secure device data record processors, in which the plurality of secure device data records are service usage records of monitored service usage of the wireless communication device with the wireless network, and in which each device data record forms a portion of an ordered sequence of device data records with each sequential device data record providing an uninterrupted accounting of service usage over the service usage interval spanned by the device data record, and in which the sequence of device data records forms a contiguous and uninterrupted reporting of device service usage, and in which each device data record is associated with a unique sequence order identifier; provide a device data record storage function in which the device data record sequence for each device is stored; for each device, analyze the stored sequence of device data records to determine if one or more of the device data records have been compromised by verifying that the information in the service usage record is properly configured according to the secure communication channel protocol; for each device, determine if one or more of the device data records have been removed or blocked from the device data record sequence originally transmitted from the device by determining if the secure contiguous sequence identifiers for the aggregate sequence are all present in the sequence; and if any device data record has been compromised, delayed, removed or added, set a fraud detection error flag for that device to restrict network access and also signals network apparatus or a network administrator to take further action.

In some embodiments, the secure device data records included in the device data record sequence include a secure network performance report that characterizes the network performance or congestion at the time the secure device data record was generated. In some embodiments, the device data record sequence is used at least in part as a record of service usage that forms an input factor in the business logic or rules used to compute a service usage bill. In some embodiments, the device data record sequence is used at least in part as a record of service usage that forms an input factor in the business logic or rules used to determine if one or more device access network service policies are being properly enforced. In some embodiments, the device data record sequence is used at least in part as a record of service usage that forms an input factor in updating an end user service usage notification message, service usage notification display or service purchase message trigger event (for example based on usage analytics).

In some embodiments, the network device processor is further configured to receive a device data record sequence from a second device program function that forwards the device data record after receiving it from the secure device data record generator. In some embodiments, the network device processor is further configured to receive a second service usage data record sequence from a second device program function. In some embodiments, the two device data record sequences possess service usage classification that is different at least in part (e.g., use of classification parameters; layer 3/4 and/or layer 7) over the same (or approximately the same or overlapping) time span. In some embodiments, the network device processor is further configured to compare the two data record sequences and determine if the two sequences of service usage reports match one another to within an allowable tolerance limit.

In some embodiments, the secure device data record(s) can accompany the corresponding layer-7 classification information (e.g., one or more of domain names, application identifier, HTTP information, associative classification, roaming state, device state and/or other information as described herein) with the n-tuple classification information (e.g., one or more of source address, port address, destination address, destination port, network type, roaming state and protocol—wherein n is between 1 and 7) received from the Service Processor included in the DDR report, which, for example, can be sent to the Service Controller (e.g., or another network element) to assist in the service usage reconciliation and/or verification, using various techniques described herein. In some embodiments, one or more of the service usage reconciliation and/or verification operations using the layer-7 classification information and the 5-tuple classification information are performed locally in the client (e.g., in a secure execution area). In some embodiments, one or more of the service usage reconciliation and/or verification operations using the layer-7 classification information and the 5-tuple classification information are performed locally in the client (e.g., in a secure execution area), and one or more of the service usage reconciliation and/or verification operations using the layer-7 classification information and the 5-tuple classification information are performed in the network (e.g., at one or more network elements, such as the Service Controller).

In some embodiments, a portion of the matching criteria is determining if the two sequences of service usage reports match in the reported network performance levels or network congestion levels. In some embodiments, the tolerance limit is based on total data usage over the usage interval spanned by the two data record sequences.

In some embodiments, the network device processor is further configured to identify the amount of service usage for one or more classification categories in the second service usage record sequence that can be reconciled with service usage for one or more classification categories in the secure device data record sequence. In some embodiments, a criteria in the classification category reconciliation includes determining if the two sequences of service usage reports match in the reported network performance levels or network congestion levels.

In some embodiments, the network device processor is further configured to identify the amount of service usage from the second service usage record sequence that cannot be reconciled with known service usage classifications in the secure device data record sequence. In some embodiments, a criteria in the classification category reconciliation includes determining if the two sequences of service usage reports match in the reported network performance levels or network congestion levels.

In some embodiments, a minimum tolerance limit is placed on the amount, relative amount or percentage of service usage for one or more classification categories in the second service usage record sequence that can be matched to or correlated with one or more classification categories in the secure device data record sequence. In some embodiments, when the minimum tolerance limit is not met a fraud detection error flag for that device is set to restrict network access and also signals network apparatus or a network administrator to take further action.

In some embodiments, a maximum tolerance limit is placed on the amount, relative amount or percentage of service usage for one or more classification categories in the second service usage record sequence that cannot be matched to or correlated with one or more classification categories in the secure device data record sequence. In some embodiments, when the maximum tolerance limit is exceeded a fraud detection error flag for that device is set to restrict network access and also signals network apparatus or a network administrator to take further action.

In some embodiments, the network device processor is further configured to determine if the service usage report spanned by the secure device data record sequence is consistent to within predetermined tolerance limits with one or more device service usage enforcement policies intended to be in place. In some embodiments, if the tolerance limits are exceeded a fraud detection error flag for that device is set to restrict network access and also signals network apparatus or a network administrator to take further action. In some embodiments, the network device processor is further configured to determine if the service usage report spanned by the second device service usage report sequence is consistent to within predetermined tolerance limits with one or more device service usage enforcement policies intended to be in place. In some embodiments, if the tolerance limits are exceeded a fraud detection error flag for that device is set to restrict network access and also signals network apparatus or a network administrator to take further action.

In some embodiments, the network device processor is further configured to provide one or more secure messages to each of multiple device programs running in a secure software or firmware instruction execution environment, in which the secure messages either acknowledge receipt of one or more secure device data records or acknowledge an access network authentication sequence. In some embodiments, the network device processor is further configured to send, for each device, a series of secure messages that directly or implicitly instruct the programs running in a secure software or firmware instruction execution environment to allow unrestricted or less restricted network access for a period of time that is either predetermined or is specified in a message from the network device processor to the program running in a secure software or firmware instruction execution environment. In some embodiments, the network device processor is further configured to send, for each device, a secure message that instructs the program running in a secure software or firmware instruction execution environment to restrict network access to a predetermined set of network destinations or functions.

In some embodiments, a secure network busy state (NBS) monitoring and reporting is provided. In some embodiments, the secure NBS monitoring and reporting facilitates NBS charging and control enforcement. In some embodiments, a processor of a wireless communication device for wireless communication with a wireless network, in which the processor is configured with a secure software or firmware instruction execution environment, and in which a DDR processor in the secure execution environment is configured to: monitor service usage of the wireless communication device with the wireless network; based on the monitoring of service usage of the wireless communication device with the wireless communication network, create and record characterizations of network performance; analyze the characterizations of network performance and reduce the performance characterizations into one or more network performance statistics that provide indications of the performance level or congestion level of the network as experienced by the device; generate a plurality of network performance report messages that include a sequence of the network performance statistics created at different times; in which the network performance report messages are secured network performance reports; and send the secured network performance reports to the storage function located in the network.

In some embodiments, the measures of network busy state or network congestion are formed by observing one or more of: the number of network access attempts, the number of access successes the number of access failures, the delay between access attempt and access success, network throughput data rate, data error rate, packet error rate, packet repeat rate, one way or round trip delay, one way or round trip delay jitter, TCP traffic back off parameters, TCP window parameters, modem channel quality, modem channel power, modem channel signal to noise ratio, modem over the air data rate, or network throughput data rate versus modem over the air data rate, and the sub network of the network that the device is connected to.

In some embodiments, the measures of service usage are obtained from observing the network traffic generated by the service usage of the device user. In some embodiments, the measures of service usage are obtained from: communicating one or more network traffic sequences between the device and a network function; and using the subset of service usage monitoring that includes the network traffic sequences to create and record characterizations of network performance.

In some embodiments, a processor of a network device configured as a device secure network performance record storage and processing function, for wireless communication with a wireless network in wireless communication with a plurality of wireless communication devices, with each wireless device including a secure network performance record generator, in which the processor of the network device is further configured to: provide individual secure communication channel between each of the plurality of secure network performance record generators and the network device, in which the communication channel security protocol is configured so that tampering with the secure network performance record may be detected; receive over the secure communications channel a plurality of secure network performance records from each of the secure network performance record generators, in which the plurality of secure network performance record are network performance statistics that provide indications of the performance level or congestion level of the network as experienced by the device; provide a device secure network performance record function in which the secure network performance record sequence for each device is stored; determine the sub network of the network that each device is connected to, and analyze the secure network performance records received from multiple devices connected to the same sub network to determine an aggregate characterization of the performance level or congestion level for the sub network, and perform the same operation to determine an aggregate characterization of the performance level or congestion level for other sub networks connected to the network; store the results of the aggregate characterization of the performance level or congestion level for each sub network that is characterized, and make the stored results available to other network devices or functions; and if any device data record has been compromised, delayed or removed, set a fraud detection error flag for that device to restrict network access and also signals network apparatus or a network administrator to take further action.

In some embodiments, a network performance characterization system is provided. In some embodiments, the network performance characterization system includes a processor of a wireless communication device for wireless communication with a wireless network, in which the processor is configured with a secure software or firmware instruction execution environment, and in which a program in the secure software or firmware instruction execution environment is configured to: communicate a plurality of traffic sequences between the device and a network device, in which the traffic sequences are secured; and initiate each traffic sequence based on one or more of the following: a pre-determined time or time interval, a service usage event or service usage condition that arises on the device, and as a response to a message communicated from the network device; and a processor of the network device in secure communication with the program (e.g., DDR processor) in the secure execution environment is configured to: monitor the plurality of the secure traffic sequences between service usage of the wireless communication device with the wireless network; use the monitoring results of the secure traffic sequences, create and record characterizations of network performance; analyze the characterizations of network performance and reduce the performance characterizations into one or more network performance statistics that provide indications of the performance level or congestion level of the network as experienced by the device; generate a plurality of network performance reports that include a sequence of the network performance statistics created at different times; in which the network performance reports are stored in a network performance report storage function; and the network performance report storage function is made available to other network devices or functions.

In some embodiments, the DDRs are applied to one or more of the following activities: service billing, service control, and/or access control; service usage measurement (e.g., fraud resistant and scalable device measurement of service usage); verifying monitored service usage; verifying that service usage control policies are properly implemented on the device; and a source of performance monitoring and/or measurement.

In some embodiments, the DDRs are communicated to a network element based on a configured time interval; based on a configured usage size (e.g., buffer size limit or predefine size limit for a device or based on other criteria); when modem resources reach a predefined threshold (e.g., usage threshold, such as out of memory or approaching a threshold limit usage of memory); in response to a request from a service processor executed on an application processor of the wireless communication device; in response to a request from a service controller (e.g., either directly or indirectly through a service processor executed on an application/general processor of the wireless communication device).

In some embodiments, a reconciliation process is provided for reconciling a plurality of device data records and service processor usage reports for monitored wireless communication devices to verify reported service usage for each of the monitored wireless communication devices, which includes one or more of the following: reconcile the received device data records from each of the plurality of monitored wireless communication devices and service processor usage reports for a predefined time period or based on a comparison for each received service processor usage report and associated device data records or based on a predefined service usage amount/bulk usage amount or based on a predefined period of time or based on a service policy verification setting; verify that the monitored wireless communication device has not been tampered with or compromised (e.g., missing, modified, delayed, and/or unreconciled DDRs or a discrepancy between received micro-CDRs and DDRs outside of tolerances); verify that the monitored wireless communication device's service usage is compliant with an associated service policy and/or service plan; verify that the monitored wireless communication device properly implemented a traffic control policy of an associated service policy/service plan for a period of time (e.g., QoS, NBS, throttling); verify an accuracy of the received service usage measures using the received plurality of device data records and service processor usage reports for each of the monitored wireless communication devices; and reconcile using a tolerance threshold. In some embodiments, the tolerance threshold (e.g., fixed amount, percentage based) accounts for variances between the received device data records and service processor usage reports for synchronized monitored time periods, including one or more of the following: a service provider configured tolerances, a configured tolerance in the reconciliation process for unclassified service usage in the received device data records and/or service usage that cannot be correlated with known service activities, redirected service usage activities for content distribution network services, and/or other possible differences and/or variations.

In some embodiments, a reconciliation engine performs one or more of the following: determine one or more patterns to account for synchronization errors or traffic classification errors over time (e.g., training period, periodic refining using heuristics); determine if the received device data records are properly associated within policy service usage activities (e.g., reverse DNS lookup, white list, or web crawler); perform a classification operation on the received plurality of device data records that is similar to a service processor classification (e.g., layer 7 service usage activity classification, such as reported in micro-CDRs/uCDRs), then group the received plurality of device data records usage into service usage activity classifications used by the service processor; determine the service processor usage reports' service usage measures for each service activity classification, then determine a percentage of each service usage activity that can be verified by classifying the received device data records' service usage measures; implement adaptive ambient techniques for reconciliation (e.g., using threshold based comparison techniques, for example, with DDRs and the use of reverse DNS for packet classification, then using the ratio of allowed usage for host sponsored service vs. ALL whitelisted host names, vs. all unknown host names, vs. synchronization error tolerance, perform a comparison (with acceptable percentage of error) and identify potential fraud scenarios; perform reconciliation for one or more of the following classified services: sponsored services, user (e.g. open access) services, carrier services, network protection services (e.g., services that can be classified as background and thus be delayed in order to protect network bandwidth/resources for foreground/higher priority services) that are a part of the service plan classification definition; and reconcile using a third service usage measure (e.g., network based CDRs, FDRs, and/or IPDRs). In some embodiments, the secure device data record(s) can accompany the corresponding layer-7 classification information (e.g., domain names, application identifier, HTTP information, associative classification, and/or other information as described herein) with the 5-tuple classification information (e.g., source address, port address, destination address, destination port, and protocol) received from the Service Processor included in the DDR report, which, for example, can be sent to the Service Controller (e.g., or another network element) to assist in the service usage reconciliation and/or verification, using various techniques described herein.

In some embodiments, DDRs include one or more of the following: 5-tuple classification information, including a source address, a port address, a destination address, a destination port, and a protocol (e.g., inbound and outbound) and byte counts, and the tolerance threshold accounts for one or more of the following: usage measurement differences, time synchronization differences and/or information that is classified by the service processor with the advantage of information not available in the DDR processor classifier (e.g. application information, associative information, simpler classification implementations/algorithms in the DDR processor, etc.). In some embodiments, the service processor usage reports include one or more of the following that is not included in the received device data records: layer 7 monitored service usage information (e.g., domain names, application identifier, HTTP information, associative classification, and/or other information as described herein), and only a certain percentage of the received device data records are identified as associated traffic with a service usage activity, and for each service usage activity an allowance for unclassified traffic that varies by activity is provided (e.g., Amazon is “closed” while CNN is very diverse), in which a sum of all unclassified allowances does not exceed a total of unclassified received device data records information, and relaxing the tolerance for a first time interval and tightening the tolerance for a second time interval, in which the second time interval is longer than the first time interval. In some embodiments, the secure device data record(s) can accompany the corresponding layer-7 classification information (e.g., domain names, application identifier, HTTP information, associative classification, and/or other information as described herein) with the 5-tuple classification information (e.g., source address, port address, destination address, destination port, and protocol) received from the Service Processor included in the DDR report, which, for example, can be sent to the Service Controller (e.g., or another network element) to assist in the service usage reconciliation and/or verification, using various techniques described herein. In some embodiments, the DDR processor (or DDR processor classifier) obtains (or generates—for example via flow tagging) at least a subset of the corresponding layer-7 classification information (e.g., domain names, application identifier, HTTP information, associative classification, and/or other information as described herein).

Advanced Wireless Service Platform (AWSP)

In some embodiments, an Advanced Wireless Service Platform (AWSP) is provided. In some embodiments, AWSP provides an enhanced networking technology platform that supports existing services (for example text, SMS, voice) and also provides for various new Internet and data service capabilities for wireless networks (e.g., 4G, 3G, and/or 2G networks), as described herein with respect to various embodiments. In some embodiments, wireless devices, processor(s), firmware (e.g., DDR firmware, as described herein with respect to various embodiments), and software provide an enhanced role in wireless network service policies for charging, access control and service notification to implement AWSP, as described herein with respect to various embodiments.

In some embodiments, AWSP supports a wide range of services, devices, and applications for consumer, enterprise, and machine to machine markets, as described herein with respect to various embodiments. In some embodiments, AWSP supports various device types, including the following: 4G and 3G smart phones, 4G and 3G feature phones, 4G and 3G USB dongles and cards, 4G-to-Wi-Fi and 3G-to-Wi-Fi bridge devices, 4G and 3G notebook and netbook computing devices, 4G and 3G slate computing devices, 4G and 3G consumer electronics devices (e.g., cameras, personal navigation devices, music players, and home power meters), and machine to machine devices (e.g., various types of consumer and industrial devices with minimal user interface (UI) capabilities such as geo-location tracking devices, parking meters, and vending machines).

In some embodiments, AWSP includes a device data record (DDR) processor (or alternatively or in addition a second service processor component/module/function). In some embodiments, the DDR processor includes firmware that is integrated into a secure hardware execution environment within an AWSP compliant processor (e.g., a processor or set of processors that are compatible with, support, approved for and/or certified for AWSP, such as through a wireless carrier AWSP chipset certification program). In some embodiments, the AWSP compliant processor is certified to qualify the processor for proper services delivery over AWSP, as described herein with respect to various embodiments.

In some embodiments, the term chipset refers to one or more chips (for example general purpose processors, signal processors, APU, MPU, RAM or non-volatile memories) comprising at least one processor.

In some embodiments, a DDR Firmware Developer's Kit (DDR FDK) is provided. In some embodiments, the DDR FDK includes firmware code (e.g., written in C), detailed DDR Processor specifications, detailed chipset Secure Execution Environment (SEE) specifications, DDR Processor chipset test criteria, and DDR Processor chipset certification procedures. For example, an approved chipset partner can integrate the DDR firmware into a Chipset Certification Device (CCD) for approved or certified processor(s) (e.g., chipsets that have been approved or certified under an AWSP Chipset Certification Program). In some embodiments, the CCD includes an approved chipset partner chipset Board Support Package (BSP) for a smart phone/feature phone device that includes the chipset submitted to the AWSP Chipset Certification Program. In some embodiments, the CCD includes a smart phone/feature phone device that includes the Approved Chipset Partner chipset submitted to the AWSP Chipset Certification Program. In some embodiments, various Operating Systems (OSs) are supported (e.g., Linux, Android, Apple, Microsoft, Palm/HP, Symbian, and/or various other operating systems and/or platforms).

In some embodiments, enhanced functionality includes integration of a Service Processor (service processor) kernel program and service processor application program (or alternatively service processor kernel or application software/elements/functions/executables/images). In some embodiments, in addition to the DDR firmware, a Service Processor Software Developers Kit (service processor SDK) is provided. In some embodiments, the service processor SDK includes software and descriptive information for integrating the service processor SDK kernel program and application software with a device OEM as described herein with respect to various embodiments. In some embodiments, an Approved Chipset Partner CCD connects to either Wireless Carrier's 3G (EVDO/UMTS) network or Wireless Carrier's 4G LTE network using a mutually agreeable WWAN wireless modem chipset that is certified for operation on Wireless Carrier's network.

Service Processor Overview

In some embodiments, the service processor 115 includes various components, such as device agents, that perform service policy implementation or management functions. In some embodiments, these functions include service policy or implementation verification, service policy implementation tamper prevention, service allowance or denial, application access control, traffic control, network access control services, active network detection, time synchronization, various network authentication services, service control plane communication, device heartbeat services, service billing, transaction billing, simplified activation services and/or other service implementations or service policy implementations. It will be apparent to those of ordinary skill in the art that the division in functionality between one device agent and another is a design choice, that the functional lines can be re-drawn in any technically feasible way that the product designers see fit, and that the placing divisions on the naming and functional breakouts for device agents aids in understanding, although in more complex embodiments, for example, it can make sense to the product designer to break out device agent functionality specifications in some other manner in order to manage development specification and testing complexity and workflow.

In some embodiments, the service processor comprises one or more components (or alternatively agents, modules, functions, objects, executables, programs, elements, images). In some embodiments, the service processor comprises one or more components from the list: service processor application, service processor service, service processor kernel, service processor library, service processor system, service processor framework, service processor hook, service processor API, service processor bootstrap, service processor shim, service processor DDR (or alternatively called DDR processor). In some embodiments, a subset of the service processor functionality is grouped as part of a service processor package (or alternatively service processor client, service processor .zip, service processor .tar, service processor partition, service processor image, service processor executable, etc.), for example to simplify one or more of: the delivery, installation, security, memory partition, software upgrade or integration with a OS provider, OEM provider or service provider/carrier/MVNO. In some embodiments, a subset of the service processor functionality is integrated with a System/OS/OEM/Carrier software (or alternatively program/image/release—for example one or more of a hook, API, bootstrap, shim, library, kernel). In some embodiments, the subset service processor functionality is integrated with the System/OS/OEM/Carrier software and the associated subset service processor functionality software is not considered part of the service processor client (or alternatively DAS client). For example, the service processor client may include the service processor application, service processor kernel and the OS/OEM software may include the service processor DDR (or DDR processor). For example, the service processor client may include one or more of: service processor application, service processor kernel, service processor shim and the OS/OEM software may include one or more of service processor hook, service processor API, service processor bootstrap. Other partitions of service processor functionality between a service processor client and a service processor functionality integrated with the System/OS/OEM/Carrier software are possible as would be appreciated by a person having ordinary skill in the art.

The embodiments in this detailed description are often described in the context of the DDR processor (or alternatively service processor DDR), but the embodiments described may be applied to one or more of the service processor components (for example one or more of service processor application, service processor kernel, etc.), as would be appreciated by a person having ordinary skill in the art.

The embodiments in this detailed description are often described in the context of data services (alternatively called service activities or communication activities), but the embodiments described may be applied to one or more of voice, voice over IP (VOIP), text, SMS, as would be appreciated by a person having ordinary skill in the art.

In some embodiments, the DDR Processor is implemented within secure firmware embedded in either an applications processor unit (APU) or a modem processor unit (MPU). In some embodiments, the DDR Processor is provided as part of the device firmware build installed by an OEM at time of manufacture. In some embodiments, the DDR Processor at least assists in monitoring incoming and outgoing IP packets and gathers various statistics (e.g., Device Data Records (DDRs)). In some embodiments, a DDR is, in part, a record of the amount of data transmitted or service usage consumed along an IP flow. In some embodiments, an IP flow is specified by a source address, a destination address, a source port, a destination port, and a protocol type. In some embodiments, the secure device data record can also accompany the corresponding layer-7 classification information (e.g., domain names, application identifier, HTTP information, associative classification, and/or other information as described herein) with an IP flow (e.g., source address, port address, destination address, destination port, and protocol) received from the Service Processor. In some embodiments, DDRs also include other types of classification for network service usage, as described herein with respect to various embodiments. In some embodiments, DDRs also include various statistics related to or based on network service usage, as described herein with respect to various embodiments. In some embodiments, DDRs are used in 2G, 3G, and 4G wireless networks in both home and roaming network conditions for various service usage accounting, access control, and service policy enforcement verification functions, as described herein with respect to various embodiments.

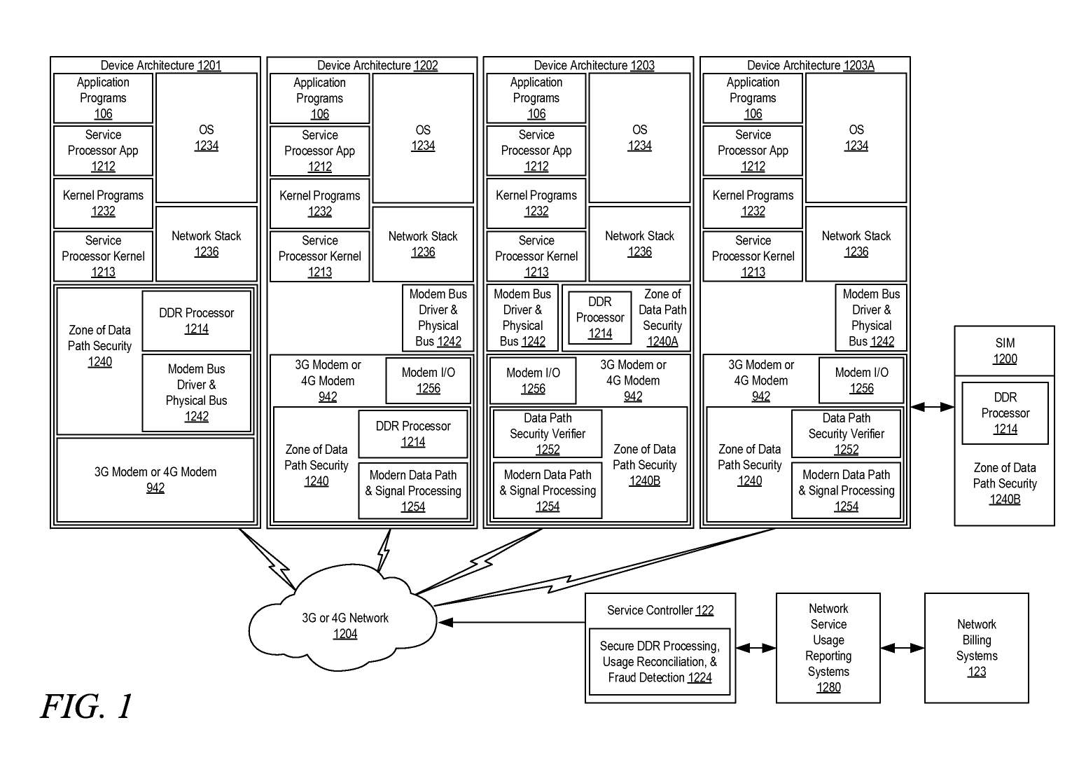

FIG. 1 illustrates a high level diagram of an advanced wireless service platform end-to-end DDR reporting and processing system in accordance with some embodiments. In FIG. 1, four DDR implementation options are shown for securely embedding a DDR processor (e.g., DDR processor firmware and/or functionality) into an APU chipset or an MPU chipset. Each of these four options is described at a high level below and in more detail in following sections.

In some embodiments, a wireless communication device includes a DDR processor 1214 in a secure execution environment. In some embodiments, the DDR processor 1214 includes a DDR generator function (e.g., a function for generating secure DDRs, which can be reported to another element/function in the device and/or to a network element/function, such as a service controller 122) as described herein with respect to various embodiments. Various architectures are provided for implementing the DDR Processor in a secure execution environment.

Device architecture 1201 includes the DDR processor 1214 in a zone of data path security 1240 (e.g., located in an application/general processor unit (APU)) as shown. Application programs 106 are monitored (e.g., service usage based monitoring) using a service processor application program 1212 and/or service processor kernel program 1213. Kernel programs 1232 are monitored using a service processor kernel program 1213. An operating system (OS) 1234 resides above a network stack 1236 for network access, which is monitored by the DDR processor 1214 for any network access through a modem bus driver and physical bus 1242. As shown, 3G or 4G wireless network access is provided through a 3G or 4G modem 942 to a 3G or 4G network 1204, respectively. This device architecture and similar device architectures are described herein in more detail below.

Device architecture 1202 includes the DDR processor 1214 in a zone of data path security 1240 (e.g., located in a modem processor unit (MPU)) as shown. Device architecture 1202 is similar to device architecture 1201 except that in device architecture 1202 the zone of data path security 1240 is located in 3G or 4G modem 942. Network communication via the modem 942 through modem bus driver and physical bus 1242 and modem I/O 1256 is monitored using the DDR processor 1214 for any network access through a modem data path and signal processing 1254. This device architecture and similar device architectures are described herein in more detail below.

Device architecture 1203 includes the DDR processor 1214 in a zone of data path security 1240A (e.g., located in an APU or another processor/memory, such as a SIM card)) as shown. Device architecture 1203 is similar to device architecture 1201 except that in device architecture 1203 the APU's modem bus driver and physical bus does not need to be in a secure zone and instead a data path security verifier 1252 is included in the zone of data path security 1240B in the MPU to restrict network access to only traffic that has been monitored by the DDR Processor 1214 within APU. This device architecture and similar device architectures are described herein in more detail below.

Device architecture 1203A includes the DDR processor 1214 in a zone of data path security 1240B (e.g., located on SIM 1200) as shown. Device architecture 1203A is similar to device architectures 1201 and 1202, except that in device architecture 1203A, as in device architecture 1203, there are two zones of data path security. Zone of data path security 1240A is located in 3G or 4G modem 942, and zone of data path security 1240B is located on SIM 1200. In device architecture 1203A, modem bus driver and physical bus 1242 does not need to be in a secure zone, and instead data path security verifier 1252 is included in zone of data path security 1240A in the MPU to restrict network access to only traffic that has been monitored by the DDR Processor 1214 within SIM 1200. This device architecture and similar device architectures are described herein in more detail below. Device architecture 1203A enables a carrier to have complete control of the DDR processor functionalities, because the SIM is considered in the industry to be a “carrier-owned” entity on the device.

As would be appreciated by a person having ordinary skill in the art, DDR processor 1214 may be embedded in a secure zone of any other functional processor with a companion MPU to enforce network access. Such functional processors in which DDR processor 1214 may be embedded include, for example, video processors, audio processors, display processors, location (e.g., GPS) processors, and other special-purpose processors as well as general-purpose processors such as digital signal processors (DSPs), microprocessors, etc.

In some embodiments, a Service Controller 122 is provided as shown. In some embodiments, Service Controller 122 is provided as an AWSP network server cloud system. In some embodiments, Service Controller 122 is provided as an AWSP network server cloud system that is used to perform one or more of the following: collect device service usage reports; manage certain aspects of device based network service policy; ascertain the Network Busy State (NBS) for various base stations on the network (e.g., wireless network(s)); manage the user notification and service plan selection UI processes configured on the device(s) (e.g., wireless communication device(s)); and manage certain aspects of service fraud detection. In some embodiments, the service controller 122 includes a secure DDR processing, usage reconciliation, and fraud detection function 1224 as shown. In some embodiments, the service controller 122 communicates monitored service usage (e.g., reconciled service usage based on processed and reconciled secure DDRs) to network service usage reporting systems 1280. In some embodiments, the reported service usage is aggregated and communicated to network billing systems 123 (e.g., for billing for the reported service usage).

In some embodiments, the Service Controller 122 communicates with various device-based elements of the AWSP system. In some embodiments, the Service Controller 122 communicates with various device-based elements of the AWSP system, including the following: the DDR Processor 1214 and a Service Processor. In some embodiments, the service processor 115 includes a service processor application 1212 (e.g., an application space or framework space program) and a service processor kernel 1213 (e.g., a kernel space or driver space program). In some embodiments, the service processor application 1212 and the service processor kernel 1213 execute or perform in an OS partition (or equivalent) on an application processor unit (APU) of a device (e.g., a wireless communication device). In some embodiments, the Service Processor is not generally in a secure execution area.

In some embodiments, the Service Processor performs various functions for the carrier network including collecting Network Busy State (NBS) information, service usage classification and reporting, certain network service policy enforcement functions, and/or certain user notification functions and roaming access policy enforcement functions, as described herein with respect to various embodiments. In some embodiments, the Service Processor also logs and reports device service usage information that assists a carrier (e.g., a service provider for a wireless network service or other services) in determining how to provide users with optimized services, information, and/or content.

In some embodiments, the DDR Processor 1214 communicates DDRs to the Service Controller 122. In some embodiments, the DDR Processor 1214 communicates DDRs to the Service Controller 122 via the Internet, a carrier network, and/or other network. In some embodiments, the DDR Processor 1214 does not send DDRs directly to the Service Controller 122, but instead the DDR Processor 1214 forwards the DDRs to the Service Processor. The Service Processor then forwards or relays the DDRs to the Service Controller 122 and, in some embodiments, along with additional service usage reports and/or other service policy management and user notification communications generated by or received by the Service Processor.

For example, the APU OS execution environment is generally not considered secure or trusted even though the Service Processor can be protected by the OS and/or other security elements within the system. In addition, the network data path between the DDR Processor 1214 to the Service Processor is generally not considered to be secure or trusted and neither is the data path between the Service Processor and the Service Controller 122. Accordingly, in some embodiments, the DDR Processor 1214 and the Service Controller 122 use cryptographic techniques to provide a secure link from the DDR Processor 1214 to the Service Controller 122. In some embodiments, the DDR Processor 1214 is considered secure and trusted based on various implementations and techniques as described herein with respect to various embodiments. In some embodiments, various techniques for securing the service usage monitoring and control performed by the DDR Processor 1214 on a network data path, and securing the DDR reporting channel from the DDR Processor 1214 to the Service Controller 122 are described herein with respect to various embodiments.

In some embodiments, a secure access controller function within the DDR Processor 1214 is employed as described below to ensure that if the DDR flow is tampered with or blocked, then the device network access data path connection managed by the DDR Processor 1214 is restricted to only those network destinations required to manage the DDR Processor 1214 communication with the Service Controller 122. In some embodiments, the access controller function within the DDR Processor 1214 receives feedback from the Service Controller 122 to restrict access or allow full access. For example, the restricted access list (e.g., a list of host names, IP addresses, and/or other identifiers for an access list) can either be pre-provisioned within the DDR Processor SEE or configured through the secure path as described in more detail herein.

In some embodiments, a secure, reliable, and trusted transmission of DDRs from the DDR processor 1214 is provided by DDR reporting techniques, including the following: (1) the DDR Processor firmware is securely loaded and executed in a Secure Execution Environment (SEE); (2) the data path between the DDR Processor to the wireless modem antenna connection (e.g., a 3G or 4G network modem antenna connection) is secured to prevent fraudulent software or firmware from forming data paths that circumvent the DDR Processor data path processing; (3) the DDRs transmitted from the DDR Processor 1214 to the Service Controller 122 are integrity checked in a manner that protects them from being tampered with or replayed; and (4) an authentication process between the DDR Processor 1214 and the Service Controller 122 combined with a set of unique DDR report sequence identifiers and authentication session keep alive timers are used to maintain and verify the secure connection between the DDR Processor 1214 and the Service Controller 122. For example, if the secure session or the flow of DDR records between the DDR Processor 1214 and the Service Controller 122 are interrupted, then the secure access control function in the DDR Processor 1214 can restrict access to the modem data path to the network destinations necessary to re-establish a securely authenticated session between the DDR Processor 1214 and the Service Controller 122.

In some embodiments, the DDR Processor 1214 also includes a secure Network Busy State Monitor function (e.g., NBS Monitor) as similarly described herein with respect to various embodiments. In some embodiments, the NBS Monitor logs and reports various network and modem performance parameters and also computes and reports a measure of network congestion referred to herein as the Network Busy State (NBS). In some embodiments, the NBS is a measure that indicates the level of network congestion at a give base station sector over a given measurement time interval. In some embodiments, all of this information is included in a Network Busy State Report (NBSR) that is part of the DDR message reports sent to the Service Controller 122 via the Service Processor 115.

Overview of Secure Image Programming, Secure Boot, Secure Execution, and Secure Firmware Update

In some embodiments, the term “secure” refers to having one or more of rights, permissions, privileges, properties, authority, protection, etc. associated with one or more of elements, such as a process/thread/program execution, memory, access to system resources, communication with other system/user processes, etc. For example, a secure memory could refer to a secure partition (or alternatively secure directory, file) of an on-chip or off-chip RAM, ROM or non-volatile memory. For example, a root user or system user may have permission to write a software component in a secure partition but a third-party app may not. For example, a secure process/thread/program could refer to a system process/thread/program which may have high execution priority and protection from being killed by the system in low memory situations or from being killed by other process (such as users and root-enabled applications) or run as a persistent application which prevents the OS from placing this process in the background, or higher priority at boot time. For example, a secure process/thread/program may have monitor or control the actions of other applications (for example, prevent launch or monitor data usage, such as to manage an active service plan). For example, a secure process/thread/program may have access to system resources, such as the camera, network access, or the ability to read/write/install/remove software components of a secure system partition. For example, a secure process may have permissions to share data with an OS/Kernel module or execute in the same process/thread/program with a OS/Kernel module or being called (for example with a hook or callback or API) and inherit at least a subset of the OS/Kernel permissions/properties/etc. In some embodiments, the term secure refers to software or hardware security. In some embodiments, secure process/memory/execution/etc. is assisted with one or more of a key, certificate, password or credential (for example application identifier). In some embodiments, there is two or more levels of security, for example a system security and a device user security (for example system apps vs. third-party apps may be stored in different partitions or execute with different levels of access to system resources or privileges). In some embodiments, there are at least 3 levels of security, for example a system/OS/OEM level, a carrier/service provider/MVNO level and a device-user level. In some embodiments, the at least 3 levels of security enable a carrier/service provider/MVNO to integrate functionality/components with a device OS/OEM platform having access to a subset of the OS/OEM platform memory/execution resources necessary to augment the OS/OEM functionality without being deleted/overwritten by a use of the device.

In some embodiments, the DDR Processor and USB driver execute in a secure environment on the application processor chipset, such as DDR secure execution memory 1245. In some embodiments, the secure environment ensures no unauthorized ability to replace or modify the DDR Processor code or modem bus driver/controller code (e.g., a USB driver/controller or another device I/O driver/controller, such as a 2G/3G/4G modem driver/controller, an SDIO driver/controller, an Ethernet driver/controller, a FireWire driver/controller, a Wi-Fi driver/controller, a Bluetooth driver/controller, or a near field communication driver/controller). In some embodiments, the secure environment also ensures that the data path from the DDR Processor to the physical modem bus driver (e.g., USB port, Ethernet port, FireWire port, Wi-Fi port, Bluetooth port, NFC port, or another I/O bus port) is isolated from firmware outside the secure environment. That is, no firmware outside the secure environment has the ability to affect the accurate gathering of statistics by the DDR Processor. In some embodiments, the secure environment further ensures that there is no ability for code other than the DDR Processor to access sensitive crypto storage, such as keys. For example, this can include shielding sensitive storage from debug monitors and/or other monitoring/access activities or techniques. As would also be apparent to one of ordinary skill in the art, APU firmware, not just the DDR Processor, must be secured and not include bugs or vulnerabilities that can be exploited to allow for unauthorized access. For example, a common attack is buffer overflow, in which an attacker chooses inputs that cause an unchecked buffer to exceed its bounds, resulting in unintended behavior that the attacker can exploit.

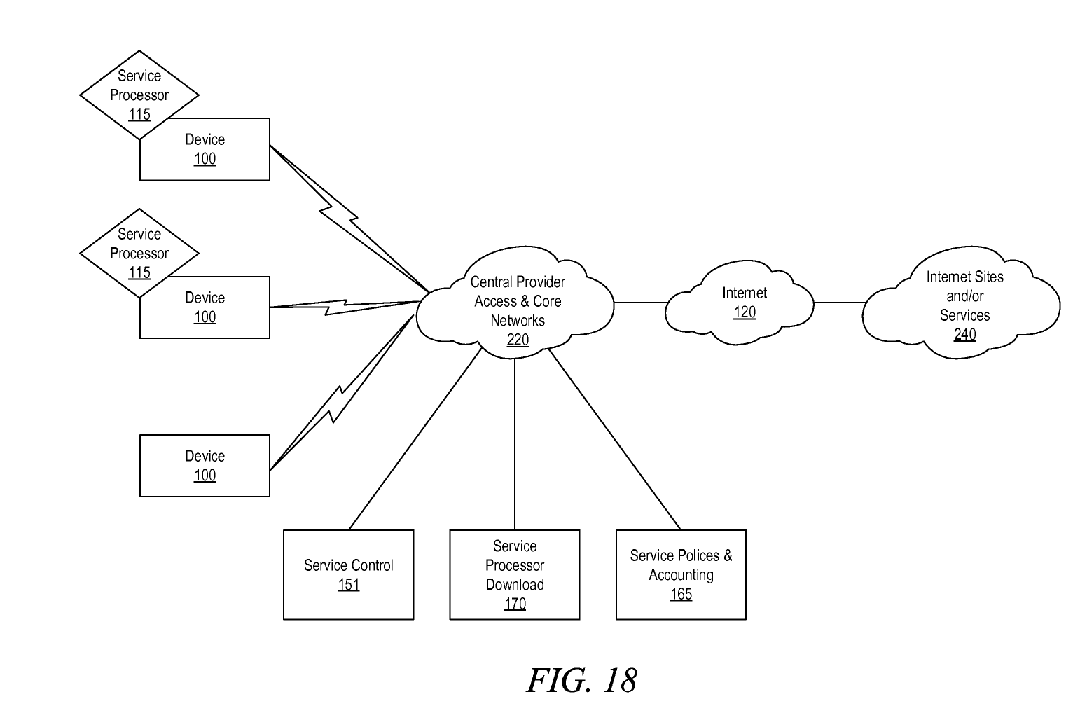

FIG. 18 illustrates a wireless network architecture for providing device assisted services (DAS) install techniques in accordance with some embodiments. As shown, FIG. 18 includes various wireless communications devices 100 (e.g., a mobile wireless device or an intermediate networking device) in wireless communication with central provider access and core networks 220. As shown, some of the devices 100 include service processors 115. For example, devices 100 can include various types of mobile phones, PDAs, computing devices, laptops, netbooks, tablets, cameras, music/media players, GPS devices, networked appliances, and any other networked device. In some embodiments, intermediate networking devices, as described herein, include a service processor or assist in the downloading of a service processor for one or more devices 100 to facilitate network access as described herein with respect to various embodiments. In some embodiments, a device 100 does not initially include a service processor (as shown in FIG. 18). In some embodiments, a service processor 115 is previously installed (e.g., during manufacture or distribution), or is downloaded and installed on a device 100 (as also shown in FIG. 18).

In some embodiments, FIG. 18 provides a wireless network architecture that also supports partitioned device groups, in which each device group can be provided independent and secure management. In some embodiments, partitioned device groups are provided. In some embodiments, each partitioned group of devices (e.g., mobile devices 100) can be uniquely managed with secure admin log-ins. In some embodiments, the partitioned device groups are securely managed using the service processor 115 installed on the devices 100 for that device group. In some embodiments, multi-device, multi-user accounting is provided. In some embodiments, capabilities are provided to support multi-party/multi-service reconciliation records to carriers and carrier partners. In some embodiments, service usage and profitability analytics are provided. For example, a partitioned beta test group of devices can be tested and optimized for various service usage policies and/or service plans, and then the optimized service usage policies and/or service plans can be published to an entire or larger device group. In some embodiments, a carrier can be provided a carrier branded device group, and/or a MVNO can be provided a MVNO branded device group.

In some embodiments, DAS install clients (e.g., bootstrappers for devices 100) are provided. In some embodiments, a first version service processor provides DAS install client function that facilitates a bootstrapping function for downloading (for example from/via a service controller) and installing a second version service processor. In some embodiments the second version may include user configuration and/or personalization settings and/or user selected service branding and/or user selected service provider branding components—wherein configuration/personalization/branding settings comprise one or more of logos, icons, widgets, menus, screens, wallpaper, ringtones, apps, service plans, etc.). In some embodiments the second version (or a new version) may include carrier/service provider/MVNO/OEM/VSP configuration and/or personalization settings and/or service branding and/or other branding components—wherein configuration/personalization/branding settings comprise one or more of preferred network lists, carrier/service provider/MVNO/OEM/VSP service policies/settings, device-specific (for example based on hardware, UI, or OS version) configurations/settings, roaming business rules, intermediate networking device settings, service plan policies, geography/location based configuration/settings, roaming/background service policies, logos, icons, widgets, menus, screens, wallpaper, ringtones, apps, service plans, etc.). In some embodiments, DAS install clients are provided for creating/downloading and installing a verifiable service processor for each device (e.g., a network capable device, such as a mobile wireless communications device or intermediate networking device). In some embodiments, a DAS install client downloads a uniquely secured service processor for device 100 (e.g., hashed/encrypted, such as based on device credentials, to prevent, for example, mass hacking or other security vulnerabilities, and/or a signed interface between the service processor and modem). In some embodiments, a non-advertised IP address allocated for each device group is rotated (e.g., to counter denial of service (DoS), distributed denial of service (DDS), and/or other types of attacks and/or vulnerabilities or exploits), and service processors are configured with multiple IP addresses for service control access (e.g., for secured network communication with service control 151 and/or service policies and accounting 165).

In some embodiments, DAS install techniques include one or more of the following operations. First, in some embodiments, whether a device is in a device group or list that includes an installed, up to date, and/or validated service processor is determined (e.g., verify that SIM, ESN, or other unique device identifier is registered, such as in a Home Location Register (HLR)/Network Information Repository (NIR) database or other authorized data store, as associated with service settings/policies for that device for service access and send its associated Charging Data Records (CDRs) to the service controller). Second, in some embodiments, if the device does not have an installed, up to date, and/or validated service processor, then the device is directed to, for example, an activation server to, for example, authenticate the device and/or verify a service processor for the device (e.g., ensure that a current and verified service processor version is installed and/or download a current and verified service processor version for the device).

In some embodiments installing a new or updating an existing at least a portion of the service processor is in response to a user device access or request to connect, or in response to a user input (for example to attempting to use a service activity or selecting a settings/setup communication activity request menu). In some embodiments installing a new or updating an existing at least a portion of the service processor is in response to a user device (or an associated user) request for a new service plan or a change of service plan (for example from a service plan type within the list of: post pay, pre pay, contract, no contract, pay as you go, unlimited, to a different service plan type from the list). In some embodiments the device role (wherein role comprises one or more of user, ownership, purpose, personal/consumer, enterprise/work) changes from a first role to a second role (for example a hand-me-down phone from a parent to a child, from a dormant/disabled/deactivated to an active state, or as part of a donation, recycling, refurbished, second hand purchase—e.g. over eBay, from the primary/main device to a secondary/backup device) and installing a new or updating at least a portion of the service processor assists the change of role (for example by enabling a modification of a service plan or enabling a device group service plan). In some embodiments an agent/client in the device (for example a service processor component) assists (for example by providing automated/automatic/simplified actions) in selecting a service provider, carrier, MVNO (for example by installing a component of the service processor or retrieving information—such as device or user information—to assist activation/modification of a service plan). In some embodiments the device role change is assisted by a service controller (for example a cloud service). In some embodiments a carrier selects one or more service processors for a device to offer/assist a change of role and sends the one or more service processors to the device (for example as part of a service offer, or in response to a device action/service activity).

In some embodiments the device is a new device or a blank device or a multipurpose device and installing a new or updating at least a portion of the service processor assists one or more of the initialization, authorization, activation (for example by enabling activation of a service activity or service plan or enabling a device group service plan—for example associated with a purchase, plan modification, phone transfer). In some embodiments the device is new or blank (and/or deactivated/dormant/disabled/etc.) device with one or more capabilities from the set of multi-band (for example 700 MHz, 1.9 GHz), multi-mode (for example 2G, 3G, 4G, LTE), multi-standard (4G, WiMax, Wi-Fi), multi-carrier/service provider (for example selecting from one or more MVNO or service provider brand names associated with network access provider or selecting from a plurality of service providers or network access providers) and installing a new or updating at least a portion of the service processor assists one or more of the initialization, authorization, activation of one or more components of the multi-band, multi-mode, multi-standard, multi-carrier/service provider (for example by enabling activation of a service activity or service plan or enabling a device group service plan—for example associated with a purchase, plan modification, phone transfer).

In some embodiments the device associated service provider/carrier/MVNO/MVNE/VSP changes from a first service provider/carrier/MVNO/MVNE/VSP to a second service provider/carrier/MVNO/MVNE/VSP (for example a device with a carrier changes from a first MVNO to a second MVNO associated with the same carrier/network access provider, or from a first MVNO to a service provider associated with managing the wireless access network, or any other permutation) and installing a new or updating at least a portion of the service processor assists the change of ownership (for example by enabling a modification of a service plan or enabling a device group service plan). In some embodiments installing a new or updating an existing or deleting at least a portion of the service processor is in response to a change from an activated service plan device to a dormant service plan device, or a temporary or partially activated service plan device state to an active service plan device state. In some embodiments installing a new or updating an existing or deleting at least a portion of the service processor is in response to a purchase/sale/delivery or power up (for example initial power up after purchase—for example to provide out of the box activation). In some embodiments installing a new or updating an existing at least a portion of the service processor enables a multi-carrier activation or selection.

In some embodiments a device agent or client (for example at least a portion of a service processor or an application) emulates at least a portion of one or more service plans—for example by performing at least a subset of managing, monitoring, accounting, notifying or controlling one or more aspects associated with a virtual service plan). For example a device (or user) may be associated/subscribed with a first (for example active/in operation) service plan and the emulated/virtual service plan may be monitoring/accounting for service activities and estimating a cost associated with the emulated/virtual service plan. For example a device (or user) may be associated/subscribed with a first (for example active/in operation) service plan and the emulated/virtual service plan may be monitoring/accounting for service activities and estimating a cost associated with the emulated/virtual service plan while enforcing (for example controlling/billing a first service plan policy). In some embodiments a user device may be emulating (or alternatively executing) one or more emulated/virtual service plans and presents a user of the device with an estimated measure (for example usage, cost) if the emulated/virtual service plan was in effect. For example a user may be subscribed to a post pay plan, and the device agent/client may emulate one or more service plans (for example a pre pay plan, or a application based plan—such as unlimited Google-associated-applications with a limit on all other data) and notify a user (for example via a UI after a user request or a time expiration or a usage/cost based threshold) about a cost associated with at least a subset of the alternative emulated/virtual service plans. In some embodiments an emulated/virtual service plan setting is selected by a user (for example to configure the emulated/virtual service plan).

In some embodiments an emulated/virtual service plan is created by a user. In some embodiments an emulated/virtual service plan created by a user may be communicated to a service provider/carrier/MVNO/VSP. In some embodiments the emulated/virtual service plan created by a user becomes a service provider/carrier/MVNO/VSP approved or offered service plan. In some embodiments service offers to a user of the device are based on usage measure associated with the emulated/virtual service plan. In some embodiments a plurality of emulated/virtual service plans are evaluated and one of them is selected as an offer to a user (for example based on cost or features or performance). In some embodiment the emulated/virtual service plan enforces service usage controls (for example in exchange or in addition to the regular/standard service plan in effect). For example the active service plan could have unlimited data usage and the emulated/virtual service plan could have a subset of unlimited application service access usage or network end-point access usage and a cap/limit on other service access usage and the emulated/virtual service plan could enforce the emulated/virtual service plan service policies to give a user a better appreciation for the emulated/virtual service plan if it became the (for example new/updated) active plan. Therefore a user could have a “test-drive” to experience the emulated/virtual service plan (for example one or more of management, accounting, billing, control, notifications, offers, user customization, user settings) prior to selecting and/or activating and/or switching from a current/first/active service plan to a second service plan. In some embodiments the emulated/virtual service plan is assisted by at least a portion of a service processor coupled to the device OS/system/platform (for example by having additional system permissions, or security elements) to assist in performing service access management emulation (for example with assistance of kernel or framework library functions associated with OS/system library functions). In some embodiments the device agent/client communicates with a network element (for example a service controller) to sent or receive information associated with managing the emulated/virtual service policy (or alternatively service plan). In some embodiments the information may assist in implementing a device group emulation/virtual service plan (for example a first device client/agent may exchange messages with a second device in a device group to manage an emulation/virtual service policy—such as aggregated/share of service usage or the first device managing a service policy aspect of the second device). In some embodiments at least a portion of the emulated/virtual service policy is implemented by a network element (for example with a DPI network element). In some embodiments at least a portion of the emulated/virtual service policy is implemented by a network element in cooperation with the device client/agent. In some embodiments the embodiments described herein associated with emulated/virtual service plans are managed/implemented at least in part by one or more network elements. In some embodiments the emulated/virtual service policy component (for example one or both of a device client/agent or one or more network elements) assists in re-configuring the device (or a network element/function). In some embodiments re-configuring the device comprises installing at least a portion of a new or updated or pre-stored/dormant service processor. In some embodiments the emulated/virtual service policy component recommends/offers of one or more alternative service plans, service providers, MVNO, VSP to a user of the device. In some embodiments implementing the new or updated service plan requires a new or updated SIM, or reconfiguring a OS/system network access hardware or software in a secure partition (for example a carrier/OEM/system/OS partition). In some embodiments the emulated/virtual service policy component recommends/offers one or more alternative service plans, service providers, MVNO, VSP to a user of the device and/or in response to a user acknowledgement and assists (for example automatically) the transition from the current device state to a new device state (for example with one or more of: an updated/new branding/look, an updated/new account—for example from a single device to a device group/family plan or vice versa, a new number, a new account, a new phone number). In some embodiments a transition from the current device state to a new device state is assisted by a network element (for example by one or more of: exchanging device and/or user credentials, evaluating account status, sharing device/user/service policy information between one or more providers—for example for a case where the device/user transfers from a first carrier/MVNO to a second carrier/MVNO). In some embodiments at least a portion of the information associated with the emulated/virtual service plan is stored at the device (for example NVM to preserve information between power states). In some embodiments at least a portion of the information associated with the emulated/virtual service plan is stored at the network (for example a cloud element—for example to aggregate information associated with a device group or to evaluate new service plans/offers based on crowdsourcing the information from multiple devices or to share the information and offer the device/user to a prospective service provider—such as a marketing/customer opportunity for the prospective service provider to target).

For example, a DAS install client can be downloaded and installed (e.g., using various bootstrapping techniques, in which, for example, during the installation of the service processor software it is sometimes necessary to update the installer or package manager itself, by using, for example, a small executable file, such as a bootstrapper, that updates the installer and then initiates the new/updated/second version service processor installation after the update, and, in some cases, the bootstrapper can install other prerequisites for the service processor software during the bootstrapping process as well; and using network access to a download server, and/or from a website, including, for example, service processor download function 170) that allows for secure connection from the device (e.g., mobile device 100) to a secure download server (e.g., service processor download 170). In some embodiment the bootstrapper verifies the integrity and/or legitimacy of the service processor bundle prior to install (for example to ensure that a compromised download server doesn't break the chain of trust). In this example, support for a configuration of the device can be determined, such as through a device query or device download of client verification software can be used to verify the device hardware/software configuration). In this example, a user/device validation step can also be performed. For example, an authorization process for a user sign-up can be performed (e.g., based on a user name, MAC address, Turing machine text verification, and/or credit card verification or using other authorization/validation techniques), in which this can be performed automatically or the user/device can be required to enter certain credentials for authorization/validation.

In some embodiments, the authorization process also includes various security techniques for securely associating a user's identity with the device (e.g., using public key/TLS techniques, SSH techniques for TLS, and/or identity management techniques or other security techniques). For example, a check can also be performed to determine if the device was previously and/or is currently an activated device (e.g., the device is already associated with an active service plan). For example, whether the device belongs to a registered device group can also be determined during a DAS install, and if not, then the default settings for that type of device can be applied. In some embodiments, the service processor is encrypted, hashed, and/or obfuscated based on the previous determination (e.g., device group association, default device settings, and/or any other settings/criteria).

In some embodiments, if the device is not associated with a service plan (e.g., based on the device look-up using device based unique identifier(s)/credential(s) or using other techniques, as described herein), then the device can be redirected to a service portal for an activation offer for a service plan (e.g., using an activation server). In some embodiments, the portal utilizes header information to indicate that the device is a managed device (e.g., for a given service provider, MVNO, or other service partner) in the portal request to proxy to an appropriate proxy server for that service provider for the activation process.

In some embodiments, the device is in probation mode after the new service processor install (e.g., restricted a restricted IP address can be used for the service controller or other network element for service control instead of the secured service controller IP addresses reserved for validated and non-probation mode service processors, which, for example, can reduce the risks of various security risks, such as DoS, DDS, and/or other mass or other types of attacks against publicly or other more easily accessible service controller or download servers). In some embodiments, while in probation mode, the service processor executes more robust service monitoring techniques (e.g., more frequent and/or more robust service integrity checks and/or more frequent heartbeats, for example, to monitor actual device/user behavior with the associated expected behavior, as described herein with respect to various embodiments). In some embodiments, after a probation period ends, the device is provided access based on the associated service plan, which is managed, at least in part, by the service processor (e.g., service processor 115) in communication with, for example, a service controller (e.g., service control 151 and service policies and accounting 165) or other authorized network elements for service control.

In some embodiments, the various techniques and embodiments described herein can be readily applied to intermediate networking devices (e.g., an intermediate modem or networking device combination). In some embodiments, intermediate networking devices include, for example, WWAN/WLAN bridges, routers and gateways, cell phones with WWAN/WLAN or WWAN/Bluetooth, WWAN/LAN or WWAN/WPAN capabilities, femtocells, back up cards for wired access routers, and/or other intermediate networking devices. In some embodiments, an intermediate networking device (e.g., an intermediate modem or networking device combination) downloads and sends a service processor to one or more devices communicating via the intermediate networking device. In some embodiments, an appropriate and validated service processor is securely downloaded to the intermediate networking device, and the intermediate networking device performs the service processor functions for various wireless communication devices (e.g., mobile wireless communication devices) in communication with the intermediate networking device. In some embodiments, in which one or more wireless communication devices are in wireless communication via an intermediate networking device, some of the service processor functions are performed on the intermediate networking device (e.g., an appropriate and validated service processor is installed or securely downloaded and installed on the intermediate networking device), and some of the service processor functions are performed on the one or more wireless communication devices (e.g., an appropriate and validated service processor is installed or securely downloaded and installed on the mobile device) (e.g., stack controls can be performed on the mobile device and various other controls can be performed on the intermediate networking device). In some embodiments, the one or more wireless communication devices cannot access the network via the intermediate networking device (e.g., the devices are quarantined) unless the one or more wireless communication devices each have an installed and functioning verified service processor (e.g., using CDRs from intermediate networking device and/or network).

In some embodiments, a USB WLAN stick or other similar networking device is provided (e.g., including a modem) with DAS install client software that loads onto the device 100 and installs a service processor 115 on the device 100. In some embodiments, software on the device 100 instructs the user to insert a properly configured memory device (e.g., a secured USB memory stick, dongle, or other secured device that can provide a DAS install client software, a service processor image, and/or device credentials for network access). In some embodiments, the USB WLAN installed software assumes control over, for example, the network stack of the device (e.g., for managing network access) and sets various service policies based on whether the service is communicated via the USB WLAN stick or via the Wi-Fi/other (e.g., including requiring no policies, such that access is open). In some embodiments, the DAS install client software on the USB WLAN stick provides a secure client that installs itself/certain software on the device that provides a DAS install client (e.g., bootstrapper) for the device, and the DAS install client downloads an appropriate service processor onto the device and/or the USB WLAN stick (e.g., the stack can also be located and managed on the USB WLAN stick).

In some embodiments, DAS install techniques include ensuring that a device's (e.g., the device modem's) credentials for the access network match the unique credentials for the service processor and the unique credentials for the device (e.g., MAC, SIM, IMSI, and/or other unique credentials for the device). In some embodiments, DAS install techniques include ensuring that multiple IP addresses are not associated with the same service processor for a particular device. In some embodiments, DAS install techniques include determining that this is the same device/modem that a service processor was previously downloaded for and whether that prior service processor is still active on the network. If so, then, in some embodiments, the user is required to type in, for example, a password to continue, for example, a reimaging of the device (or prevent the new device install or to disable the previously activated other service processor).

In some embodiments, DAS install techniques include starting with a device that does not include a service processor (e.g., a device, with, for example, a SIM or EVDO ESSN, but with no service processor, attempts to connect to the network, an appropriate service processor for the device is determined, and then a uniquely associated service processor is downloaded and installed on the device, for example, using a bootstrapper, as similarly described herein). In some embodiments, unique device credentials (e.g., MAC, SIM, IMSI, and/or other unique credentials for the device) are used to create a secure connection with, for example, the service controller (e.g., service control 151) or a secure download server (e.g., service processor download 170), to download a (e.g., new or replacement) service processor to be securely installed on the device. Accordingly, as similarly described herein, DAS install techniques can be applied to at least one or more of the following situations: a new service processor install; and/or a replacement service processor install (e.g., the originally/previously installed service processor was wiped/reimaged, hardware failure, or otherwise corrupted or deleted, and, thus, a replacement service processor is needed). In some embodiments, when a device connects to the network without, for example, a service processor, then a look up is performed (e.g., in a data store, such as a database) to determine whether the device is a member of a device group or a new device, and an appropriate service processor (e.g., version and settings) is provided for installation on the device. In some embodiments, when the device attempts an initial access to the network, at that time an updated version of a service processor for that device can be provided based on, for example, device type, device group, master agent, user interface (UI), settings, marketing pages, and/or other features and/or settings, which, for example, can allow for a new, changed, or evolving service plan/program by the time the device logs onto the network to provide, for example, for a dynamic and scalable solution.

In some embodiments, as similarly discussed above, two versions of the service processor are provided (e.g., a first version/image and a second version/image of the service processor software). In some embodiments, a first version service processor is a general purpose version used, for example, primarily for connecting to the network and loading a second version service processor software that, for example, can be one or more of the following: an updated version, a version tailored to a more specific purpose (e.g., based on a device type, device group, service type, service provider or service provider partner, or any other purpose/criteria), a version that includes additional features/functionality, an encrypted service processor version, a version that includes special service plan settings or capabilities (for example user or service provider/carrier/MVNO custom configuration) associated with a device group, a version that includes specific branding or features/functionality for a given service provider or service provider partner associated with a device group, a version that includes special marketing materials to motivate the user to try or buy services or transactions associated with a device group, and various other versions as will now be apparent to one of ordinary skill in the art in view of the various embodiments described herein.

In some embodiments, depending on whether the user has pre-signed up for a service plan, for example, a different version of the service processor software and/or settings is/are downloaded to the device during this initial service processor download process, including, for example, one or more of the following: a different set of options for service plan choices, marketing materials, ambient service settings and service options, service plan settings, and possibly various other features and/or settings.

In some embodiments, the first version of the service processor is installed during manufacturing or in the distribution channel prior to sale of the device. In some embodiments, the first version of the service processor is installed after the time of sale of the device using various DAS install techniques as described herein with respect to various embodiments.

In some embodiments, the first version of the service processor is not uniquely encrypted so that a general purpose version of the first service processor image can be distributed to multiple devices (e.g., downloadable via the Internet, such as through a website, or a software update not installed by an operable service processor or a software image that is loaded onto the device before the device credentials or device group associations are available or known). In some embodiments, a non-encrypted generic version of the service processor is used for broad distribution to many devices in which the device credentials are not known at the time of service processor software distribution (e.g., the generic version of the service processor can log onto the network to access a software update function in the service controller or service control 151, service processor downloader or service process download 170, and/or similar authorized network function, then the service controller can obtain the device credentials and/or user information and provide an updated version of the service processor using the various techniques or similar techniques to those described herein). In some embodiments, the second/updated version of the service processor is uniquely encrypted (e.g., based at least in part on the device credentials or device group associations).

In some embodiments, a first version of the service processor need not be uninstalled and replaced by a new install of a second version of the service processor, as, in some embodiments, the second version of the service processor includes updates to the first version of the service processor, settings changes to the first version of the service processor, and/or encryption or obfuscation of the first version of the service processor to provide a second version of the service processor that is uniquely associated with the device, the device user, the device group, and/or the service plan associated with the device. In some embodiments, the second/updated version of the service processor includes one or more restricted IP addresses providing for access to the secured service control/service controller IP addresses reserved for validated and non-probation mode service processors, which, for example, can reduce the risks of various security risks for the secured service control/service controller(s), such as DoS, DDS, and/or other mass or security attacks against publicly or other more easily accessible service control/service controller(s) and/or service processor download servers.

In some embodiments, the second version of the service processor is uniquely associated with some aspect(s) of the device credentials and/or user information with a temporary user account (e.g., also sometimes referred to herein as a dummy user account) or user account. In some embodiments, the second version of the service processor and/or the settings in the service processor are chosen based on a look up of some aspect of the device credentials and/or the user information to determine which device group version of the service processor and/or settings should be loaded. In some embodiments, when there is no appropriate device group association or the user preference takes priority over device group association, the first version of the service processor software is used to log onto the network (e.g., including potentially the service controller) to select a service offer, or device group association that then determines the second version and/or settings of the service processor software that will be loaded onto the device.

In some embodiments, the first version of the service processor is installed on aftermarket devices, and after installation this more general purpose version of the service processor provides for access to the service control/service controller (or similar network function). In some embodiments, the service control/service controller determines what type of device and/or what operating system (OS) software and/or what modem and modem software is on the device, and then loads an appropriate version of the service processor for that device or facilitates an updating of the first version of the service processor to provide a second version of the service processor for that device.

In some embodiments, the service processor is distributed on a peripheral device suitable for use with more than one type of device and/or more than one type of OS. Accordingly, in some embodiments, more than one version of the service processor can be shipped with the device for installation on the device once the device type and/or OS type is/are known, with each version of the software either being a first version of the service processor software as discussed above, or a second version or final version of the service processor software as similarly discussed above with respect to various embodiments.

In some embodiments, the first version/second version service processor software techniques, for example, allow for installations of a new OS version that is not compatible in some way with the present version of the service processor. For example, the installation of such a new and incompatible OS version can render the currently installed service processor version incapable of connecting to the network and updating the service processor. In such an example, a first version service processor software image that is compatible with the new OS can be used to access the network (e.g., connect to the service control/service controller or some other network element) to download and install a new, possibly uniquely encrypted and compatible second service processor image, as similarly discussed above with respect to various embodiments. In some embodiments, alternatively or in addition, the upgraded and/or new OS can include updated resources that are conditionally applied by the bootstrapper on next boot.

In some embodiments, the first version/second version service processor software techniques, for example, can handle situations in which a device has an inadvertently wiped or damaged service processor image such that the device is no longer capable of logging onto the network with its secure credentials and/or uniquely encrypted service processor software image. In such an example, the first version software processor can then be used as similarly described above with respect to various embodiments to download and install a new/replacement second version service processor on the device.

In some embodiments, there are multiple types of device log-in to the service control/service controller depending on whether a first or second version service processor is being used. For example, if a second version service processor is being used, which, in some embodiments, includes unique secure credentials, a uniquely encrypted or secure heartbeat channel, and/or a uniquely encrypted service processor software image, then the capabilities of the device and/or service processor to access the network and/or service controller elements can be as similarly described herein with respect to various embodiments. However, if the device is using a first version service processor, which, for example, does not have unique secure credentials, a uniquely encrypted heartbeat control channel, and/or a uniquely encrypted software image, then the heartbeat control channel traffic can be handled in a differential manner as compared to the traffic handling implemented for a second version service processor image. For example, the service controller heartbeat processing elements can detect that the service processor is a first version service processor and can then route the heartbeat traffic through a different set of security processes that do not rely on all the security aspects present in a second version service processor. As another example, the first version service processor can be a widely distributed software image that does not have unique encryption on the heartbeat channel and can be handled differentially, such as handled with a different server designed to handle insecure traffic and designed to not be disposed or easily exposed to mass or other security attacks (e.g., DoS, DDS attacks, and other types of security related and/or mass/large scale attacks against a network element, such as a download server or web/application server).

In some embodiments, a device supports two or more operating systems (e.g., different versions of operating systems and/or different operating systems) and for each operating system includes a compatible service processor. For example, when a dual boot configured device boots in a first operating system version, then a first service processor that is compatible with that first operating system version is selected for network access, and when the dual boot configured device boots in a second operating system version, then the second service processor that is compatible with that second operating system version is selected for network access.

In some embodiments, initial network access for a device is directed to a service controller (e.g., service control 151), service processor downloader (e.g., service processor download 170), and/or similar network element for managing service control. In some embodiments, initial network access is restricted to this initial network access to the service controller, service processor downloader, and/or similar network element for managing service control. In some embodiments, such initial network access is restricted until the device has been verified for network access, as similarly discussed herein with respect to various embodiments. In some embodiments, such initial network access is restricted until the device has been verified for network access and an appropriate service processor has been verified on the device and/or downloaded and installed on the device, as similarly discussed herein with respect to various embodiments. In some embodiments, such initial network access is restricted using various techniques, such as using a first version of a service processor on the device that restricts such initial network access. In some embodiments, such initial network access is restricted to and maintained in probation mode, as similarly described herein (e.g., a restricted IP address can be used for the service controller or other network element for service control instead of the secured service controller IP addresses reserved for validated and non-probation mode service processors, which, for example, can reduce the risks of various security risks, such as DoS, DDS, and/or other mass attacks against publicly or other more easily accessible service controller or download servers). For example, such initial network access can include access to a common activation server, which the device can access for determination of a supported configuration for a new or second service processor image download. As another example, such initial network access can direct the device to an initial web page including access to a service plan offer and purchase options (e.g., providing for a device credential look up for device group, provide choices of programs to user, or other service plan offer and purchase options). As another example, the initial web page can include access to a service plan offer and purchase options and a service processor verification and download/update function.

In some embodiments, a network based charging data record (CDR) feed, as described herein with respect to various embodiments, is provided for monitoring service usage by managed devices. In some embodiments, the CDR feed includes device generated CDRs or micro-CDRs generated by the service processor (e.g., service processor 115 can generate CDRs for monitored service usage on the device, which can, for at least some CDRs, include unique transaction codes for uniquely identifying the monitored service usage based on service or other categorizations/criteria) on the device (e.g., a mobile device or an intermediate networking device for that mobile device). In some embodiments, the CDR feed is a real-time (e.g., near real-time) network based CDR feed provided for determining whether any devices have been compromised (e.g., a hack of a first version or second version service processor providing for unrestricted service usage for such devices, and/or any other mass or security attack or vulnerability or exploit). For example, such a CDR feed can be used to determine abnormal or unusual traffic patterns and/or service level usage activities, which, for example, can be used to identify and/or protect against a DoS/DDS attack or other types of security attacks.

In some embodiments, based on various device and/or network based monitoring techniques, as described herein with respect to various embodiments, a determination is made that the service processor (e.g., service processor 115) is not functioning properly (e.g., may have been damaged and/or compromised/tampered with and, for example, allowing network access beyond the device's associated service plan and/or not properly monitoring/billing for such service usage) and that a new/replacement service processor should be downloaded. In some embodiments, a new/replacement service processor can be downloaded and installed in such situations, using the various techniques described herein with respect to various embodiments. In some embodiments, based on various criteria (e.g., service usage monitoring, billing, and/or any other criteria) or based on proactive and/or periodic administrative/security measures, a new/replacement service processor can be downloaded and installed, using the various techniques described herein with respect to various embodiments.

In some embodiments, based on, for example, triggers based on service plan changes (e.g., user changes to their service plan—such as from a pre pay to a post pay service plan, from a post pay to prepay service plan, from a contract to no contract service plan, from a no contract to contract service plan, from pay as you go to unlimited service plan, from unlimited to pay as you go service plan, etc.), service provider changes (e.g., service provider changes to their services/service policies or the associated service plan or changing from a first service provider to a second service provider), device changes (e.g., operating system version or other software platform changes or various hardware changes), a new service processor can be downloaded and installed or the installed service processor can be updated, using the various techniques described herein with respect to various embodiments.

In some embodiments, the device OS requires a pre-registered and signed version of the service processor software in order for the OS to allow the service processor to be installed or updated. In such embodiments, a sequence of pre-registered, pre-signed service processor software versions that have differing security parameters (e.g. encryption, signature, obfuscation, differences in code sequences, information for query—response sequences, and/or other security parameters) are provided. In some embodiments, the pre-registered service processors are used to regularly update the service processor software for a portion of devices connected to the network, or for all devices connected to the network. In some embodiments, a specific version of the service processor is assigned to a given device, and other versions with other security parameters will not be allowed to obtain service from the network. For example, more than one version of the software can be registered and distributed at any one time so that a hacker cannot create code that works for all devices. A sequence of service processor versions can be held in reserve and deployed when a successful software hack version is detected in the field for one or more previous service processor versions, and the new versions that have been held in reserve can be used to update devices in the field. As the reserved versions have not yet been distributed prior to the detection of a successful hack, it is not possible for a hacker to have a hacked version of the new software, and by refreshing new versions on a frequent basis it can become impossible for a hacker to successfully hack the new versions before additional new versions are deployed. Such embodiments can buy time by keeping successful software hacks out of the devices in the field until the successful software hack can be analyzed and a systematic security solution implemented to prevent the hack from remaining effective.

In some embodiments, the DDR Processor system includes a dedicated Secure Execution Environment (SEE) within the Application Processor Unit (APU) or modem chipset. In some embodiments, the SEE provides for a secure, trusted generation of DDRs as described herein. The basic functionality of the SEE in accordance with some embodiments is described below.

In some embodiments, the SEE is a secure memory execution partition that cannot be accessed by any external program, bus, or device port. In some embodiments, the secure memory execution partition includes code space and data space. In some embodiments, a secure boot loader executes within the SEE. In some embodiments, the only other code images allowed to execute in the SEE are secure images, meaning digitally-signed images whose signature is verified by the secure boot loader. In some embodiments, at time of device manufacture, the secure boot loader is programmed into nonvolatile memory in the on-chip SEE. For example, the secure boot loader can fetch a secure image from nonvolatile memory and install it in the SEE in a trusted and secure manner. In some embodiments, the secure boot loader is the only element capable of loading an image into the SEE.

In some embodiments, the DDR Processor 1214 is implemented as a secure image. Installation of the DDR Processor image into the SEE using the secure boot loader is described below. Other secure images can be similarly installed as will be apparent to one of ordinary skill in the art in view of the embodiments described herein. In some embodiments, images that can be similarly installed comprise one or more of installation of service processor Kernel, service processor Framework, service processor Application/Service/UI, service processor module/objects, service processor bootstrapper, service processor shim, service processor .ko, .jar, .apk, .zip, etc.

In some embodiments, the DDR Processor image is digitally signed by the device OEM. For example, the secure boot loader can verify the signature using a boot loader verification key and reject the image if the signature is invalid. In some embodiments, the boot loader verification key comprises a public key (for example 2048-bit RSA) embedded within the secure boot loader image. In some embodiments the DDR Processor image includes a second key (or other secure element) to enable downloading of additional or updated components without requiring a new OEM-signed image (for example for verification, authentication, validation, error or fault detection, fraud, etc.). In some embodiments, the third-party software components (for example the DDR processor or at least a portion of any service processor component) security check element (for example key, signature, certificate, hash, credential) is stored at a system partition component (for example one or more of system partition, recovery partition, key partition, boot partition, OEM partition). In some embodiments, the third-party software component security check element is shared with a system security check element (for example key, signature, certificate, hash, credential) or an OEM security check element (for example key, signature, certificate, hash, credential). In some embodiments the third-party security check element is at a separate or different location/partition/file than an OS/OEM security check element or not shared with a system or OS/OEM security check element (for example a first key for OS/OEM software components and a second key for the carrier/service provider/MVNO software component—for example a service processor component). In some embodiments, a third-party package (or alternatively service, application, solution or platform), for example a service processor or DAS client, comprises two or more software components at least a first portion of the two or more software components is stored at a first partition and at least a second portion of the two or more software components is stored at a second partition.

In some embodiments, the signed DDR Processor image is stored in on-chip nonvolatile memory. In some embodiments, the signed DDR Processor image is stored in off-chip nonvolatile memory (e.g., if the on-chip storage capacity of the chipsets is too constrained to store this image).

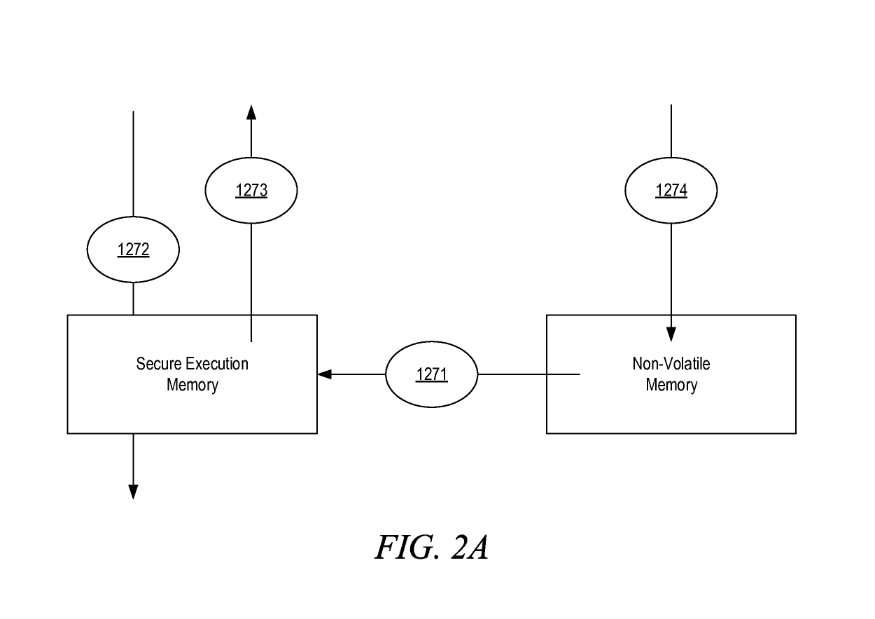

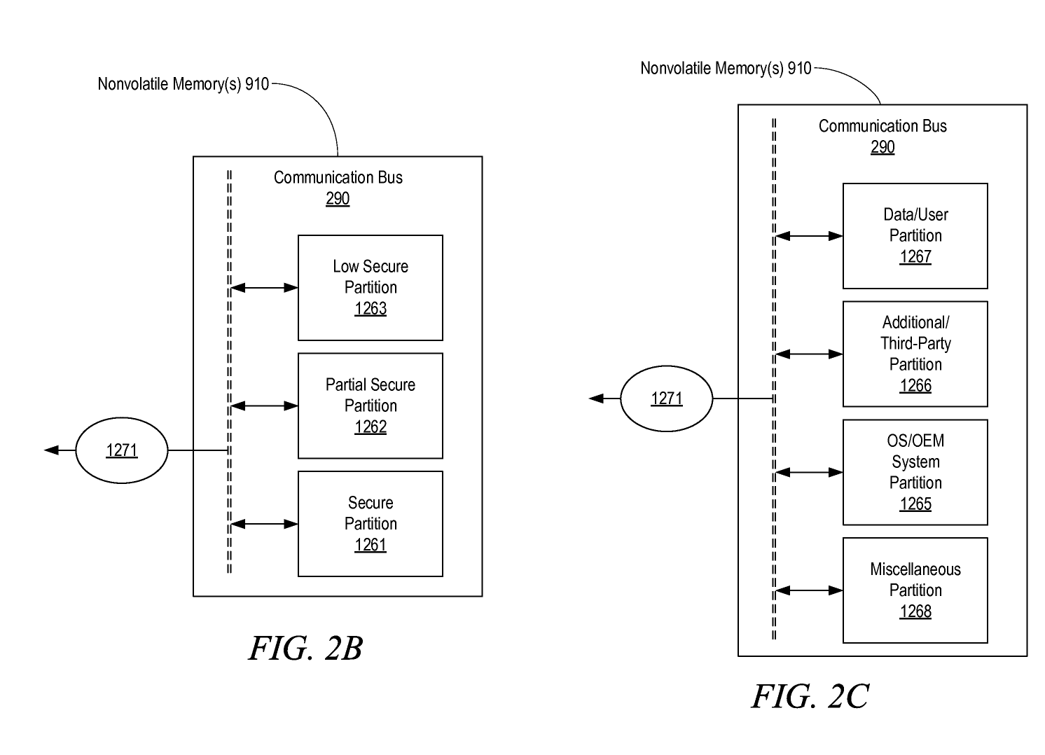

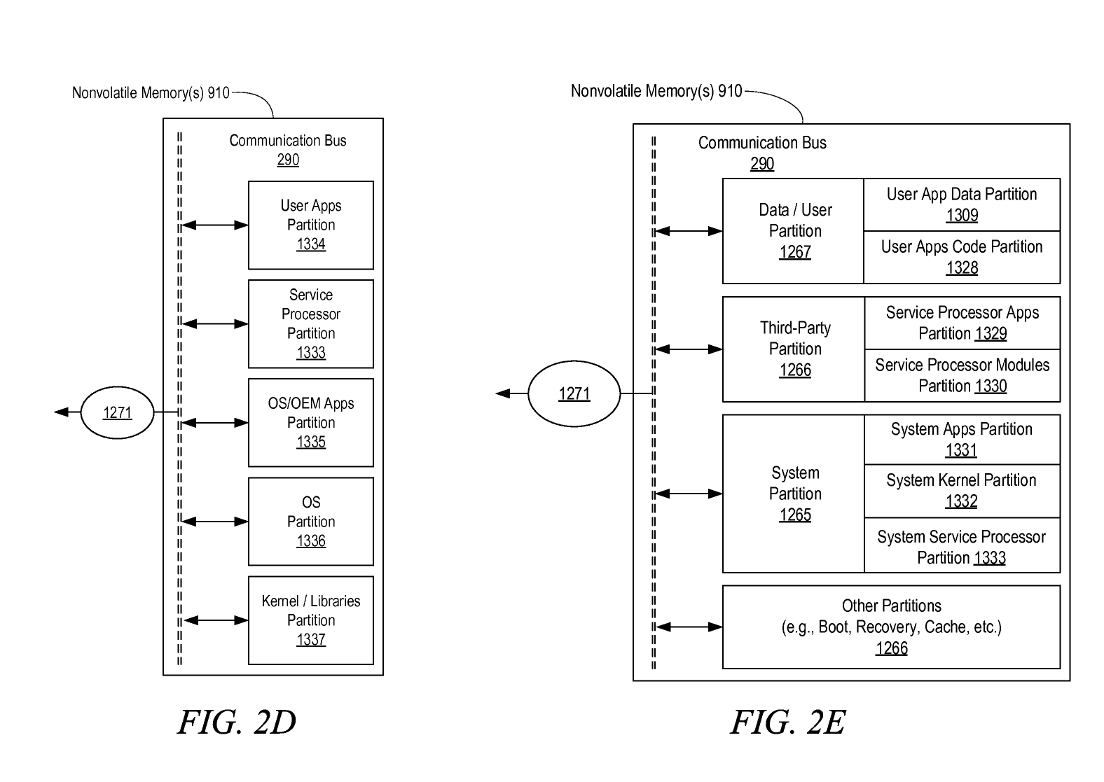

FIG. 2A illustrates a process for booting, executing, and updating the DDR firmware in accordance with some embodiments. As shown in FIG. 2A, at 1271, when the device boots, the Secure Boot Loader fetches the DDR Processor image from nonvolatile memory, installs it in the SEE, and executes it. In some embodiments, during installation, and prior to execution, the secure boot loader verifies the digital signature of the DDR Processor image using the boot loader verification key. If the signature is invalid, execution does not occur and an error message is sent to the Service Controller via the Service Processor, and the secure boot loader attempts to fall back to a previously stored image, as described herein with respect to various embodiments.

FIGS. 2B, 2C, 2D, 2E illustrate a number of exemplary nonvolatile memory configurations in accordance with some embodiments. As would be appreciated by a person having ordinary skill in the art additional non-volatile memory partition configurations with less or more partitions or by aggregating/mixing partitions across the FIGS. 2B, 2C, 2D, 2E are possible.

FIG. 2B illustrates a nonvolatile memory configuration based on a security level in accordance with some embodiments. In some embodiments, non-volatile memory 910 comprises one or more non-volatile memories. For example, one or more of: on chip non-volatile memory, off chip non-volatile memory, or an on-device flash, an external SD card, internal/external hard drive, etc. In some embodiments, non-volatile memory 910 is portioned (or alternatively split or divided) and comprises 3 levels of security. In some embodiments, 2 levels of security or more than 3 levels of security are available. In some embodiments, non-volatile memory includes Secure partition 1261, partial secure partition 1262 and low secure partition 1263. In some embodiments, there may be one of more partitions for each level of security. In some embodiments, the level of security is based on read/write/execute permissions (or alternatively properties or privileges) of the program/code/data within the partition. For example, a secure partition may be read only for all processes/threads except root or system users (and moreover root/system users/processes/threads may have read/write/execute permissions). For example, a partial secure partition may have read/write/execute by a root or system user and a third-party user, but read only permission for user apps. For example, a low secure partition may have read/write permission by all users/processes/threads (for example a temp directory). In some embodiments, a partial secure or low secure partition is called an unsecure or non-secure partition.

FIG. 2C illustrates another non-volatile memory configuration into partitions in accordance with some embodiments. In some embodiments, non-volatile memory includes OS/OEM System partition 255, additional/third-party partition 256, data/user partition 257 and miscellaneous partition 1268. In some embodiments, OS/OEM system partition is based on (or alternatively owned/developed/distributed) an OS provider with enhancements from the device OEM (for example device specific libraries to access low level hardware of the device). The OS/OEM system partition is typically a secure partition. In some embodiments, the OS/OEM partition may also include modules from a service provider, carrier, MVNO, service partner, etc. In some embodiments, the additional/third-party partition is developed by a third-party (for example not including the OS provider and not the OEM of the device). In some embodiments, the additional/third-party partition comprises additional OS functionality or OS enhancements. In some embodiments, the additional/third-party partition comprises kernel modules/objects, libraries, framework components, service/activity functions or UI components (for example .ko, .jar or .apk files). In some embodiments, the Additional/third-party partition is a secure or partial secure partition (for example lower security than the OS/OEM system partition and/or more security than the data/user partition). In some embodiments, the additional/third-party partition has similar or equivalent security as the system, OS or OEM partitions. In some embodiments, subpartitions of the additional/third-party partition has similar or equivalent security as the system, OS or OEM partitions. In some embodiments, the additional/third-party partition is mounted as read-only and/or is allowed to declare secure properties (for example, permission that are equivalent or a subset of system).

In some embodiments, the additional/third-party partition is read-only relative to a user of the device, to prevent the user of the device from erasing or tampering with the functionality. In some embodiments, the additional/third-party partition may also include modules from a service provider, carrier, MVNO, service partner, etc. (for example one or more of UI elements—such as icons, logos, branding, wallpaper screens, menus—applications, service monitoring, accounting, classification, control, billing, notifications, service offers, etc., for example associated with smart services). In some embodiments, the additional/third-party partition may also include modules from a service processor. In some embodiments, the data/user partition comprises user installed applications (for example code, executables) or app/user generated data). In some embodiments, the data/user partition is partial secure or low secure partition (for example a user of the device could remove items). In some embodiments, a miscellaneous partition may refer to one or more of a boot partition, a recovery partition, a keychain partition, a cache partition, etc. In some embodiments, at least one of the one or more miscellaneous partition are secure partitions.

FIG. 2D illustrates another non-volatile memory configuration into partitions in accordance with some embodiments. In some embodiments, the partitions of FIG. 2D are based on functionality hierarchy (for example spanning low lever kernel/libraries to high level user applications). In some embodiments, non-volatile memory includes Kernel/Libraries 1337, OS partition 1336, OS/OEM app partition 1335, service processor partition 1333 and user apps partition 1334. In some embodiments, Kernel/Libraries partition includes Linux Kernel with enhancements from the device OEM (for example device specific libraries to access low level hardware of the device). In some embodiments, the Kernel/Library partition is a secure partition. In some embodiments, the OS partition comprises functionality from one of Android OS, iOS, Windows Phone OS. In some embodiments, the OS partition is a secure partition. In some embodiments, OS/OEM apps partition comprises apps that are key extensions to the OS or considered key to the device (for example a browser app, settings menu app, maps/location app). In some embodiments, the OS/OEM apps partition is a secure partition. In some embodiments, the service processor partition comprises one or more of: OS extensions/enhancements, kernel/library extensions/enhancements, shims, bootstrappers, or specialized services/apps. In some embodiments, the service processor partition is a secure partition or partial secure partition. In some embodiments, the service processor partition is developed by a third party (for example not including the OS provider and not the OEM of the device). In some embodiments, the service processor partition comprises kernel modules/objects, libraries, framework components, service/activity functions or UI components (for example .ko, .jar or .apk files). In some embodiments, the service processor partition is read-only relative to a user of the device, to prevent the user of the device from erasing or tampering with the functionality. In some embodiments, the service processor partition may also include modules from a service provider, carrier, MVNO, service partner, etc. (for example one or more of UI elements, applications, service monitoring, accounting, classification, control, billing, notifications, service offers, etc., for example associated with smart services). In some embodiments, the user apps partition 265 comprises user installed applications (for example code, executables) or app/user generated data). In some embodiments, the user apps partition 1334 is partial secure or low secure partition (for example a user of the device could remove items).

FIG. 2E illustrates another non-volatile memory configuration into partitions in accordance with some embodiments. FIG. 2E is based on FIG. 2C. In some embodiments, a partition comprises subpartitions (for example system apps partition 1331, system kernel partition 1332 and system service provider 1333 may be subpartitions of system partition 1265). In some embodiments, a partition may be associated with one or more other partitions but at least one of the one or more other partitions having an allocated partition (for example an fixed address space in a flash) (for example one or more of system apps partition 1331, system kernel partition 1332 and system service provider 1333 may be separate partition associated with system partition 1265). FIG. 2E comprises system partition 1265 with subpartitions (or alternatively associated partitions) systems apps partition 1331, system kernel partition 1332, system service processor partition 1333; third-party partition 1266 with subpartitions (or alternatively associated partitions) service processor apps partition 1329 and service processor modules partition 1330. In some embodiments, the non-volatile memory comprises data/user partition 1267 with subpartitions (or alternatively associated partitions) user apps code partition 1328 and user app data partition 1309. In some embodiments, the non-volatile memory comprises other partition 1266 (for example boot partition, recovery partition, cache partition, etc.). In some embodiments, third-party partition is a subpartition of system partition 1265 (or alternatively a subpartition of a subpartition of system partition 1265—for example a subpartition of system service processor partition 1333). In some embodiments, the third-party partition 1266 is a subpartition of the system partition 1265 and the OS/platform/system grants the components of the third-party partition 1265 at least a portion of the permissions/properties/privileges (for example file-system read/write, execution rights [for example run as a system app, run as a persistent app, run with system privileges, run with system permissions, run with a system user ID or group user ID, run with high priority, run without being killed by another process], access to system components or other executables/programs/threads data) granted to system partition 1265. In some embodiments, the third-party partition comprises a system component (or extension) to be stored at a third-party partition 1266 such as a data partition 1267 (for example a carved out area of a user partition) or alternatively service processor apps partition 1329. In some embodiments, the third-party partition is associated with system partition 1265 (for example based on a symlink or symbolic link or granted through code—such as in the system image or bootloader). In some embodiments, the association of the third-party partition 1266 with the system partition 1265 grants the components of the third-party partition 1265 at least a portion of the permissions/properties/privileges (for example file-system read/write, execution rights, access to system components or other executables/programs/threads data) granted to system partition 1265. In some embodiments, the system partition 1265 (and in some embodiments, its associated partitions or subpartitions—for example one+ systems apps partition 1331, system kernel partition 1332, system service processor 1333 and/or optionally the third-party partition and its associated partitions/subpartitions service processor apps partition 1329, service processor modules partition 1330) are secure partitions (or comprise secure partition functions/elements/modules/files/executables). In some embodiments, the third-party partition 1266 (and in some embodiments, its associated partitions or subpartitions service processor apps 1329 and/or service processor modules partition 1330) are secure partitions or partially secure partitions. In some embodiments, data/user partition 1267 (and in some embodiments, its associated partitions or subpartitions) are partially secure or less secure partitions (for example allowing a use of the device to remove an app in this partition). In some embodiments, user apps data partition 1309 has lower security than the user app code partition 1328

In some embodiments, the data path from the non-secure (or alternatively differently-secure—for example by having lower data-path security but higher execution process privileges/properties/permission or system access privileges/properties/permission, less secure, partially secure permissions/properties or similar/equivalent security—for example similar secure privileges/properties/permission with a different key/signature/certificate/credential/etc.) OS stack elements to the modem(s) being monitored and controlled by the DDR Processor must pass into the SEE and be made available to the DDR Processor, such as shown at 1272 in FIG. 2A. Once the OS stack data destined for the modem is transferred into SEE memory, the secure DDR Processor program analyzes and acts on the data destined for the modem as described herein with respect to various embodiments. In some embodiments, the DDR Processor includes a secure data interface from the SEE to the modem data path such that there are not any data paths that can circumvent the SEE (e.g., to avoid detecting and/or monitoring by the DDR Processor). Examples of secure execution partition and data interface solutions include a trusted API, an ARM Trust Zone, an Intel Smart & Secure, or a custom solution or proprietary solution specific, such as from a chipset supplier for specific chipsets.

In some embodiments, a communication channel (e.g., a DDR mail box) provides communication between the DDR Processor program executing in the SEE to a Service Processor application program executing in the non-secure (or alternatively differently secure, less secure, partially secure or similar/equivalent secure) OS environment (e.g., application space or user space), such as shown at 230 in FIG. 2A. Example techniques for providing the DDR mailbox include shared memory using DMA channels, logical channels (e.g., endpoints) within the modem bus driver (e.g., USB interface) between the APU and MPU, and piggyback channels on top of an already exiting logical channel between the APU and MPU.

In some embodiments, the DDR Processor firmware image is updated, such as shown at 240 in FIG. 2A. In some embodiments, the DDR Processor firmware image is updated using OEM processes supported by the chipset supplier for over the air (OTA) and over the network (OTN) update(s) of the chipset nonvolatile memory firmware image provided to device OEMs. In some embodiments, the DDR Processor is stored along with other chipset secure firmware drivers loaded by the secure boot loader either during the initial power up cycle, upon exiting from power save state and/or any other times that the download can be performed in secure manner. In some embodiments, the DDR Processor requires enough nonvolatile memory space to accommodate at least two images, one image that is currently running and a new downloaded image (e.g., each image can be of a specified maximum size, such as 0.5 MB or another size limit). In some embodiments, the secure boot loader includes a firmware image switch to use the new image once the download is complete. For example, the image switch function can include a fallback system to switch back to the current image if the new image has an invalid signature, or if the new image is older than the current image as indicated by revision numbers included within each image. The current image can be retained at least until the new image has been accepted by the secure boot loader.

The embodiments for firmware image update have been described in the context of the DDR processor (or alternatively service processor DDR), but the embodiments described may be applied to one or more of the service processor components (for example one or more of service processor application, service processor kernel, etc.), as would be appreciated by a person having ordinary skill in the art.

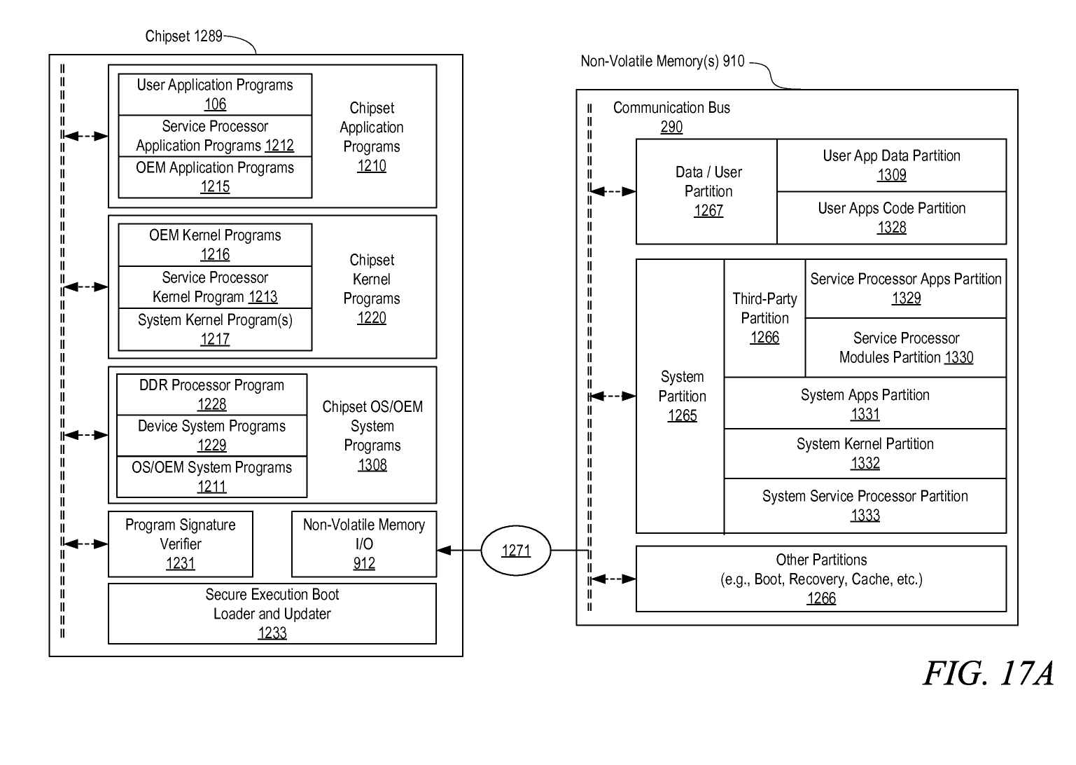

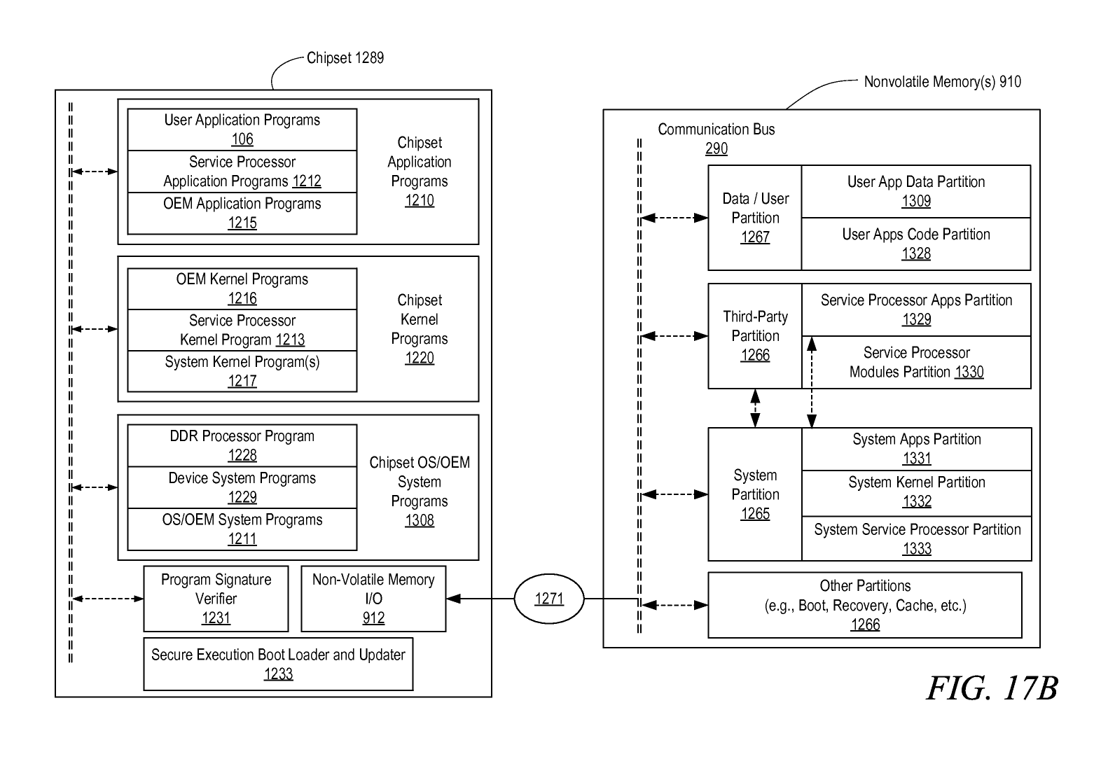

FIG. 17A illustrates a non-volatile memory 910 configuration into partitions and a chipset 1289 (comprising one or more processors) program (or executable) configuration in accordance with some embodiments. FIG. 17A comprises several non-volatile memory 910 elements from FIG. 2E. FIG. 17A comprises system partition 1265 with subpartitions (or alternatively associated partitions) systems apps partition 1331, system kernel partition 1332, system service processor partition 1333 and third-party partition 1266, itself comprising subpartitions (or alternatively associated partitions) service processor apps partition 1329 and service processor modules partition 1330. In some embodiments, the non-volatile memory 910 comprises data/user partition 1267 with subpartitions (or alternatively associated partitions) user apps code partition 1328 and user apps data partition 1309. In some embodiments, the non-volatile memory comprises other partitions 1266 (for example boot partition, recovery partition, cache partition, etc.). In FIG. 17A, the third-party partition 1266 is a subpartition of system partition 1265 (or alternatively a subpartition of a subpartition associated with system partition 1265—for example a subpartition of system service processor partition 1333). In some embodiments, the third-party partition 1266 is a subpartition of the system partition 1265 and the OS/platform/system grants the components of the third-party partition 1265 at least a portion of the secure elements—such as permissions/properties/privileges (for example file-system read/write, execution rights [for example run as a system app or service, run as a persistent app or service, run with system privileges, run with system permissions, run with a system user ID or system group user ID, run with high priority, run without being killed by another process], access to system components or other executables/programs/threads data) granted to system partition 1265.

In some embodiments, non-volatile memory 910 is coupled to chipset 1289. In some embodiments, chipset 1289 includes a program signature verifier 1231, a non-volatile memory I/O 912 and secure execution boot loader and updater 1231. In some embodiments, one or more of the program signature verifier 1231, the non-volatile memory I/O 912 and the secure execution boot loader and updater 1231 assist in one or more of install, update, delete (or alternatively erase or remove) one or more software components of non-volatile memory 910.

In some embodiments, the non-volatile memory I/O 912 loads or stores software components from or to the non-volatile memory 910. In some embodiments, the software components comprise, .zip, .apk, .jar, files, images, packages, kernel objects (.ko), etc. in either compressed or decompressed, source or executable format, and pre-installed or installed, etc. In some embodiments, a pre-installed image (for example in compressed .zip format) is stored in a first partition (for example, for a dormant secure state, or for subsequent installation or recovery back to factory state) and after installation is stored in a second partition. For example, a third-party service processor module/app could be stored in a system partition prior to installation (or alternatively in dormant state) and installed into the third-party partition as part of enabling (or alternatively installing or updating) the service processor. In some embodiments, the third-party service processor module is loaded by the non-volatile memory I/O 912 with one or more of a verification, signing, certificate or key security check is performed prior to installation (for example by the program signature verifier 1231 in collaboration with the secure execution boot loader and updater 1231). In some embodiments, a non-third-party module/function/component/agent (for example at least a portion of the OS, kernel, system or platform that is not part of the service processor) is loaded (or alternatively launched/executed) by the non-volatile memory I/O 912 with one or more of a verification, signing, certificate or key security check is performed prior to installation (for example by the program signature verifier 1231 in collaboration with the secure execution boot loader and updater 1231), launch or execution and a security check/element error/mismatch/alarm is reported to a service processor component. In some embodiments, a non-third-party module/function/component/agent (for example at least a portion of the OS, kernel, system or platform that is not part of the service processor) load/launch/executing comprises (for example security check/element) one or more of a integrity check, verification, signing, certificate, hash or key security check is performed and a security check/element (for example OS/system security/integrity check) flag/error/mismatch/alarm is reported to a service processor component (or alternatively or in addition to a service controller. In some embodiments, the flag/error/mismatch/alarm is reported to a service controller and the service controller prevents fraud by interacting with the service processor (for example sending information to a service processor component or by stopping/restricting DDR report feedback).

In some embodiments, the third-party software components security check element (for example key, signature, certificate, hash, credential) is stored at a system partition component (for example one or more of system partition, recovery partition, key partition, boot partition, OEM partition). In some embodiments, the third-party software component security check element is shared with a system security check element (for example key, signature, certificate, hash, credential) or an OEM security check element (for example key, signature, certificate, hash, credential). In some embodiments the third-party security check element is at a separate or different location/partition/file than an OS/OEM security check element or not shared with a system or OS/OEM security check element (for example a first key for OS/OEM software components and a second key for the carrier/service provider/MVNO software component—for example a service processor component). In some embodiments, a third-party package (or alternatively service, application, solution or platform), for example a service processor or DAS client, comprises two or more software components at least a first portion of the two or more software components is stored at a first partition and at least a second portion of the two or more software components is stored at a second partition. In some embodiments, the third-party package comprises a third-party system component (or system extension, enhancement or addition) to be stored at a first partition, for example, system partition 1265 (for example system service processor partition 1333) and a third-party application component to be stored at a second partition, for example, data partition 1267 (or alternatively service processor apps partition 1329). In some embodiments, the third-party package comprises a first partition, for example, system component (or extension) to be stored at a third-party partition 1266 and second partition, for example, an application component to be stored at a data partition 1267 (or alternatively service processor apps partition 1329). In some embodiments, the third-party package comprises a system component (or extension) to be stored at a third-party partition 1266 such as a data partition 1267 (for example a carved out area of a user partition) or alternatively service processor apps partition 1329. In some embodiments, a software component or image (for example in compressed .zip format) comprising at least a portion or a component of the service processor can be downloaded over-the-air (for example, via HTTP) and installed into the third-party partition as part of enabling (or alternatively installing or updating) the service processor.

In some embodiments, a third-party package (for example a service processor or DAS client) comprises two or more software components at least a first portion of the two or more software components is stored at a first partition and at least a second portion of the two or more software components is stored at a second partition enables installing, removing or updating the at least first portion of the two or more software components independently (or alternatively separately or differentially—for example at a different time or based on a different version) of the at least second portion of the two or more software components. In some embodiments, the first portion of the third-party package (for example, comprising kernel/library objects/modules) may (or alternatively must or shall) be included, installed or updated with the OS/OEM maintenance release, OS update or new OS. In some embodiments, the first portion may not (or alternatively must not or shall not) be installed or updated with the third-party package provider (for example, may not be installed or updated by the third-party package installer, bootstrapper, keys/certificates, etc.). In some embodiments, the first portion of the third-package (for example, that may/must not be updated by the third party) comprises kernel/library objects/modules. In some embodiments, the second portion may (or alternatively must or shall) be installed or updated independently of the OS/OEM maintenance release, OS update or new OS. In some embodiments, the first portion is integrated with OS/OEM or carrier/vendor/service provider/MVNO software components (for example, kernel, objects, modules, functions, libraries, etc.). In some embodiments, the first portion is part of (or is integrated with) the boot or initialization components (for example a bootstrapper). In some embodiments, the first portion is part of (or is integrated with) the recovery components (for example a bootstrapper or a shared key or shared key file). In some embodiments, the first portion is part of (or is integrated with) the at least a portion of the OS/OEM components and is installed/updated/recovered/deleted as part of an OS/OEM OTA download/installation/update/recovery process. In some embodiments, the third-party package updates or installs at least a portion of the software components using the default OE/OEM recovery method. In some embodiments, at least a portion of the third-party security elements (for example, keys, certificates, etc.) are pre-loaded into the recovery partition (for example, by the OS/OEM/carrier). In some embodiments, at least a portion of the third-party package (or service) is part of a system/OS/OEM package (or alternatively image or ROM). In some embodiments, at least a first portion of the third-party package (or service) is part of (or alternatively integrated with) a system/OS/OEM release/image/update and at least a second portion of the third-party package (or svc) is delivered, updated, release as a separate entity and when not installed makes the third-party service (or application) dormant. In some embodiments, at least a portion of the third-party package components are security checked (for example, signed) by a third-party security element (for example, key). In some embodiments, a device may be restored to a factory state or default state, for example, by removing at least a portion of the third-party package components. In some embodiments, disabling at least a portion of the third-party package components returns the device to a default state. In some embodiments, the third-party package (or service) may not update any software components that are not part of the third-party package. In some embodiments, the third-party package (or service) may only update a subset (or alternatively any or all) of software components that are part of the third-party package. In some embodiments, the third-party package may be updated during fulfillment or in the supply chain. In some embodiments, at least a portion of the third-party package software component may not be deleted by a user of the user device 100. In some embodiments at least a portion of the service processor partition is preserved across user-accessible factory resets (or alternatively or in addition a user-initiated clear or erase). In some embodiments at least a portion of the service processor partition is preserved across user-accessible factory resets to ensure delivery of DDRs and/or prevent software down-revving (for example to an exploitable service processor version).

For example, the second portion may be included, installed or updated with a third-party package update or release. For example, the second portion may be removed, from a third-party package. For example, the second portion may be removed, from a third-party package while keeping the first portion installed (for example to simplify future installations or updates). For example, the second portion may be removed, from a third-party package. For example, the second portion may be installed, removed, or updated from a third-party package independently of the first portion. In some embodiments, the third-party partition is removed when/if removing/disabling at least a portion (for example the second portion or both the first and second portion) of the third-party package or service.

For example, the second portion may be enabled or disabled from a third-party package independently of the first portion. In some embodiments, removing the second portion from the third-party package makes the third-party service dormant. In some embodiments, the device 100 is delivered with the third-party service in the dormant state. In some embodiments, the third-party service dormant state is the factory default (for example, during fulfillment or delivery to an end-user). In some embodiments, the third-party service dormant state is the factory default (for example, during fulfillment or delivery to an end-user) and may be activated/enabled OTA (for example, in response to a request from a user of the device or directed by a network element). In some embodiments, the third-party service (or alternatively solution, application, package) provides one or more API to assist one or more network elements (for example, cloud based, service controller 122, service design center (SDC)) to manage the third-party service. In some embodiments, removing the second portion from the third-party package makes the third-party service disabled. In some embodiments, removing the second portion from the third-party package while maintaining the third-party package first portion has negligible side effects on the one or more other system resources performance, components of the device 100. In some embodiments, removing the second portion from the third-party package while maintaining the third-party package first portion has no harmful effects on the one or more other system resources performance, components of the device 100. In some embodiments, removing the second portion from the third-party package while maintaining the third-party package first portion has no harmful (for example, the behavior is similar or equivalent to a empty call or a no-op) effects on the one or more other future system/OS/OEM software upgrades/releases of the device 100. In some embodiments, the third-party package (or alternatively service, solution, application or platform) may toggle from a enable (or alternatively active or on) state and a disable (or alternatively dormant or off) state. In some embodiments, the toggle selection is based on a flag (or alternatively a file or credential—for example, stored in the device or delivered OTA or set by a user of the device, or set via the UI of the device). In some embodiments, if the toggle flag is set to enable, during device boot (or alternatively initialization) the third-party package will be enabled/activated (for example, by installing the second portion of the third-party package or linking/launching/executing third-party package software components). In some embodiments, if the toggle flag is set to disable, during device boot (or alternatively initialization) the third-party package will be disabled (for example, by de-installing/removing the second portion of the third-party package). In some embodiments, the third-party package may be enabled or disabled without requiring a device boot (or alternatively during a boot sequence, a boot-up, a reboot or initialization). In some embodiments, changing the third-party package toggle from enabled to disabled (or from disabled to enabled) requires (or alternatively or in addition forces or requests for permission from a user of the device or notifies a user of the device) a device boot (or alternatively during a boot sequence, a boot-up, a reboot or initialization). In some embodiments, the third-party package comprises one or more of: a bootstrapper, an installer, a user ID, a user ID application, a key file, a permissions file. In some embodiments, the third-party package comprising one or more of: a bootstrapper, an installer, a user ID, a user ID application, a key file, a permissions file assist in one or more of: downloading, installing, updating, launching, executing at least a portion of the third-party package. In some embodiments, the third-party package modifies the device boot-up, for example, by inserting additional functionality to a boot sequence (for example, init.rc file). In some embodiments, the third-party package boot-up comprises evaluating the value of the toggle flag. In some embodiments, if the toggle flag is set to enabled, the third-party package components are installed (or alternatively or in addition loaded). In some embodiments, if the toggle flag is set to disabled (or alternatively is deleted), the third-party package components are de-installed (or alternatively removed or not loaded or not executed). In some embodiments, the bootstrapper can update the system from an image included with an OEM system/OS upgrade. In some embodiments, alternatively or in addition, the upgraded (or new) OS can include updated resources that are conditionally applied by the bootstrapper on next boot.

In some embodiments, at least a portion of the third-party package components require system/OS/OEM equivalent (or subset) secure execution. In some embodiments, a at least a portion of the third-party package components obtain system/OS/OEM equivalent (or subset) secure execution by associating the at least a portion of the third-party package components with a special user ID or special group ID (for example, a hard-coded user ID or a hard-coded user ID reserved/provided by system/OS/OEM or sharing a system/OS/OEM user ID). In some embodiments, the third-party package comprises a stub or dummy app. In some embodiments, the stub or dummy app assists in assigning or reserving a user ID and/or group ID associated with at least a portion of the third-party package components (for example, to enable system equivalent secure execution). In some embodiments, the stub or dummy app is part of the dormant (or disabled) components of the third-party package. In some embodiments, the stub or dummy app is a component of the third-party package that is integrated with the system/OE/OEM image/ROM.

For example, the second portion may be installed, removed, or updated from a third-party package independently of the first portion based on a directive from a network element (for example, a service controller 122) or via the device UI. For example, the second portion may be enabled or disabled from a third-party package independently of the first portion based on a directive from a network element (for example, a service controller 122). For example, the second portion may be enabled or disabled from a third-party package independently of the first portion. For example, the second portion may be installed, removed, or updated from a third-party package independently of the first portion based on a user preference. For example, the second portion may be enabled or disabled from a third-party package independently of the first portion based on a user preference. In some embodiments, the third-party package (or alternatively solution, service, application) communicated with a network element (or alternatively or in addition cloud, service design center (SDC) or service controller 122). In some embodiments, the third-party package is configured from a network element (for example, service plan associated management or synchronization or push notification messages)

In some embodiments, the third-party package comprises a third-party system component (or system extension, enhancement or addition) to be stored at a first partition, for example, system partition 1265 (for example system service processor partition 1333) and an third-party application component to be stored at a second partition, for example, data partition 1267 (or alternatively service processor apps partition 1329). In some embodiments, the third-party package comprises a first partition, for example, system component (or extension) to be stored at a third-party partition 1266 and second partition, for example, an application component to be stored at a data partition 1267 (or alternatively service processor apps partition 1329).

In some embodiments, the third-party package (or alternatively service, platform, application) with two or more software components is security checked (or alternatively secure or secured—for example, one or more of downloaded, installed, partitioned, updated, launched/executed in one or more of the non-volatile memory 910 and/or chipset 1289) by two or more security check elements (or secure elements). For example, at least a first portion of the two or more software components is security checked by a first security element (for example a first key) and at least a second portion of the two or more software components is security checked by a second security element (for example a second key). In some embodiments, the first security element is a OS/OEM security element (for example a shared key).

In some embodiments, the first security element is a carrier/service provider/MVNO security element (for example a shared key). In some embodiments, at least a first portion of the two or more software components is security checked by a first security element (for example a first key) and at least a second portion of the two or more software components is security checked by a second security element enables installing or updating the at least first portion of the two or more software components independently (for example at a different time or based on a different version) of the at least second portion of the two or more software components. For example, the first portion may be included, installed or updated with the OS/OEM maintenance release, OS update or new OS. For example, the second portion may be included, installed or updated with a third-party package update or release.

For example, a third-party system component to be stored at system partition 1265 and secured by a first security check element (for example a first key) and a third-party application component to be stored at a data partition 1267 and secured by a second security check element (for example a second key). In some embodiments, first and/or second security check element is used during one or more of: installation, update, delete, recovery, or during boot or initialization.

In some embodiments, a software component in non-volatile memory 910 receives a software component update. In some embodiments, program signature verifier 1231, non-volatile memory I/O 912 and secure execution boot loader and updater 1231 perform a security check (for example, by one or more of verification, signing, certificate or key) of a software component update prior to updating (for example during initialization, recovery or boot sequence).

In some embodiments, program signature verifier 1231, non-volatile memory I/O 912 and secure execution boot loader and updater 1231 perform a security check (for example, by one or more of verification, signing, certificate or key) on a program prior to loading (or alternatively launching, executing or running). In some embodiments, program signature verifier 1231, non-volatile memory I/O 912 and secure execution boot loader and updater 1231 perform a security check (for example, by one or more of verification, signing, certificate or key) on a program prior to loading (or alternatively launching, executing or running) during initialization or boot sequence (for example with assistance from a bootstrapper) of chipset 1289.

In some embodiments, chipset 1289 comprises (or alternatively runs or executes) several programs (or alternatively processes, threads, executables) executing or running (for example in foreground or background) on the chipset. In some embodiments, the chipset 1289 comprises chipset app program 1210, chipset kernel program 1220, chipset OS/OEM system program 1308.

In some embodiments, chipset app programs 1210 comprises user app program 106, service processor app program 1212, OEM app program 1215 (or alternatively carrier/service provider/MVNO apps). In some embodiments, user app program 106 are loaded (or alternatively launched, executed or run) based on software components of user apps partition 1328 (and/or data from user apps data partition 1309). In some embodiments, service processor app program 1212 are loaded based on software components of service processor apps partition 1329. In some embodiments, OEM app program 1215 are loaded based on software components of system apps partition 1331.

In some embodiments, chipset kernel programs 1220 comprises OEM kernel program 1216, service processor kernel program 1213, system kernel program 1217. In some embodiments, OEM kernel program 1216 are loaded (or alternatively launched, executed or run) based on software components of system kernel partition 1332. In some embodiments, service processor kernel program 1213 are loaded based on software components of system service processor partition 1333 or service processor modules partition 1330. In some embodiments, system kernel program 1217 are loaded based on software components of system kernel partition 1332.

In some embodiments, chipset OS/OEM system programs 1308 comprises OS/OEM system program 1211, DDR processor program 1228 (or alternatively any other service processor system component program) and device system program 1229. In some embodiments, OS/OEM system program 1211 are loaded (or alternatively launched, executed or run) based on software components of system partition 1265. In some embodiments, DDR processor program 1228 are loaded based on software components of system service processor partition 1333 or service processor modules partition 1330. In some embodiments, device system program 1229 are loaded based on software components of system partition 1265.

In some embodiments, the third-party service (or alternatively package, platform, application) with two or more software components (for example, files, images, executables, libraries, modules, functions) is security checked (or alternatively secure or secured). In some embodiments, the third-party service with two or more software components are security checked prior to launch or during execution in a processor (for example, chipset 1289) by two or more security check elements (or secure elements). For example, at least a first portion of the two or more third-party service software components is security checked by a first security element (for example a first process user ID, first process group use ID, a first system permission list) and at least a second portion of the two or more software components is security checked by a second security element (for example a second process user ID, second process group use ID, a second system permission list). In some embodiments, the first security element is a OS/OEM security element. In some embodiments, DDR processor program 1228 executed with chipset OS/OEM system program 1308 secure properties (or a subset or properties). In some embodiments, service processor kernel program 1216 is executed with chipset Kernel program 1220 secure properties (or a subset of properties). In some embodiments, a service processor program component (for example, one or more of service processor app program 1212, service processor kernel program 1213, DDR processor program 1228) running/executing with an associated (for example a service processor kernel program 1213 associated with a system kernel program 1217) system/OS/OEM program component (for example, OEM app program 1215, OEM kernel 1216, OS/OEM system program 1211) inherits security properties (or a subset of properties) from the associated system/OS/kernel program component. For example, an OS/OEM kernel program component calling (for example assisted by one or more of a callback, a hook, an API, a link, a function call) a service processor kernel program component may provide OS/OEM kernel security properties. In some embodiments, the security properties as based on the service processor program components association (for example, a relative or absolute location in a partition, association type—such as link/symlink, subpartition hierarchy). In some embodiments, the first security element is a carrier/service provider/MVNO security element. In some embodiments, the third-party service with two or more software components are security checked prior to launch or during execution in a processor by two or more security check elements enables launching (or alternatively running or executing) the at least first portion of the third-party service independently of the at least second portion of the third-party service. For example, the at least first portion of the third-party service two or more software components may be launched at a first time that is different than the launch time of the at least second portion of the third-party two or more service components. For example, the at least first portion of the third-party service two or more software components may be launched with a first set of secure properties (for example execution privileges, access to system resources, etc.) that is different than the secure properties of the at least second portion of the third-party two or more service components.

FIG. 17B illustrates a non-volatile memory 910 configuration into partitions and a chipset 1289 program configuration in accordance with some embodiments. FIG. 17B is similar to FIG. 17A, except on the association between system partition 1265 and third-party partition 1266. The embodiments in this detailed description described in the context of FIG. 17A (for example downloading, partitioning, installing, secure, update, remove, executing, of one or more service processor components) may be applied to FIG. 17B, as would be appreciated by a person having ordinary skill in the art. In some embodiments, the third-party partition 1266 is associated with system partition 1265 (for example based on a mount, a link, a symlink or symbolic link or granted through code—such as in the system image or bootloader). In some embodiments, the association of the third-party partition 1266 with the system partition 1265 grants the components of the third-party partition 1266 (or corresponding programs/executables launched/running/executing on chipset 1289) at least a portion of the secure properties (such as permissions/properties/privileges/rights), for example file-system read/write, execution rights, access to system components or other executables/programs/threads data granted to system partition 1265. In some embodiments, the system partition 1265 (and in some embodiments, its associated partitions or subpartitions—for example one+ systems apps partition 1331, system kernel partition 1332, system service processor 1333 and/or optionally the third-party partition and its associated partitions/subpartitions service processor apps partition 1329, service processor modules partition 1330) are secure partitions (or comprise secure partition functions/elements/modules/files/executables). In some embodiments, the third-party partition 1266 (and in some embodiments, its associated partitions or subpartitions service processor apps 1329 and/or service processor modules partition 1330) are secure partitions or partially secure partitions. In some embodiments, data/user partition 1267 (and in some embodiments, its associated partitions or subpartitions) are partially secure or less secure partitions (for example allowing a use of the device to remove an app in this partition). In some embodiments, user apps data partition 1309 has lower security than the user app code partition 1328.

In some embodiments, the OS/OEM system program 1211 executing within chipset OS/OEM system program 1308 and its associated programs—for example one+ DDR processor program 1228, device system program 1229) are secure program/executables are granted equivalent (or alternatively similar or a subset) of system security properties. In some embodiments, the system kernel program 1217 (or alternatively libraries or framework object/modules) executing within chipset kernel program 1220 and its associated programs—for example one+ OEM kernel program 1216, service processor kernel program 1213) are secure (for example similar or differently than the secure chipset OS/OEM system program 1308) program/executables are granted equivalent (or alternatively similar or a subset) of system/OS kernel security properties. In some embodiments, the OEM app program 1215 (or alternatively carrier/vendor/service provider/MVNO app program) executing within chipset app program 1210 and its associated programs—for example service processor app program 1212) are secure (or alternatively partially secure or less secure) program/executables are granted equivalent (or alternatively similar or a subset) of OEM app 1215 security properties.

In some embodiments, at least a portion of the third-party package/service is stored/saved at a partition with system-equivalent secure properties (for example, third-party partition 1266 in FIG. 17A or FIG. 17B) and executed with system-equivalent running secure properties to perform one or more of monitor, account, control, enforce, notify mobile plan/policies (for example, provide a user with data classification/categories, block/throttle data, notify of overages). In some embodiments, in addition a OS/OEM/carrier may need to provide device maintenance releases (update/install). In some embodiments, the partition security of the third-party package/service allows independent install/update during a initialization or boot sequence independently of the device recovery mode and/or prevents the OEM/carrier/MVNO from overwriting (or alternatively distorting or damaging) a current version of the third-party package. In some embodiments, at least a portion of the third-party package components or partition is placed under (or associated with) an OEM or carrier partition. In some embodiments, at least a portion of the third-party package components (for example, software or executables) is addressed (or accessed or enabled or executed) by associating (for example, with a symbolic link or granted through code—such as in the system image or bootloader) a system component (for example, kernel, library, module) with a third-party package component.

In some embodiments, the various design techniques described herein that allow for intercepting a service activity (for example incoming or outgoing voice, text, SMS, data) intention to launch, and applying a background service policy set or a network protection service policy set can be designed into the OS itself (and/or a service processor component). For example, the intercept and policy implementation functions can be designed into (or linked/simlink) the activity manager, broadcast intent manger, media service manager, service manager, or other application or service activity management function in the OS (for example Android OS). One of ordinary skill in the art will recognize that similarly, the various design techniques described herein that allow for intercepting a service activity intention to launch, and applying a background service policy set or a network protection service policy set can be designed into application launch management functions (for example in OS, system or service processor components) in the iPhone OS, windows mobile OS, windows PC OS, Blackberry OS, Palm OS, and other OS designs.

In some embodiments, a proxy network service manager refers to an intermediary data (and/or voice/text/SMS) flow function in a device operating system that sits on a data path between a device application and a device networking stack interface to provide a level of network service abstraction from the network stack interface, a higher level service function above the network stack interface, enhanced or special traffic processing functions, media service transfer management, file download service, HTTP proxy service functions, QoS differentiation, or other similar or related higher level traffic processing. Example Proxy Service Managers include the following: media service manager (e.g. android media service library function), email service manger, DNS function, software download service manager, media download manager (e.g. audio player, streaming media player, movie downloader, media service OS function, etc.), data download service manager, Android “media” library function, Android.net library function, Jave.net library function, Apache library function, other similar software/library functions or services in other device operating systems, SMTP/IMAP/POP proxy, HTTP proxy, IM proxy, VPN service manager, SSL proxy, etc. Herein these alternative network access data flows that are initiated by an application are termed application proxy service flows. In such embodiments an app can sometimes simply requests a network access service activity (or communication activity or service) from an OS component such as a proxy service component rather then directly accessing the network. In such embodiments, in order to implement background service controls (or alternatively or in addition roaming service management/control/notification/accounting) or user notification of application service usage, it is necessary to monitor the application proxy service flows, classify them as being initiated by or belonging to a particular application or service activity, and implement the proper background (or roaming) service classifications, user notifications, application process launch intercept, background (or roaming) service accounting, and background (or roaming) service usage restrictions as described herein in accordance with the policies intended for the initiating application or service activity. This is accomplished by inserting service usage monitors that allow a mapping of (i) the initiating application identifier (e.g. app name, app fingerprint, application identification tag, application process number, application credential, or other secure or non-secure application or process identifier) to (ii) the request to the proxy service and subsequently to (iii) the network service flows between the proxy service and the network elements that service the information communications. Once this mapping is accomplished, the service usage flows of the proxy service can then be accounted back to the initiating application, device software process or other service activity, the proper policies can then be applied to each service usage flow for user notification, service activity launch control, service activity background accounting (including variable charge rating dependent on background service state and/or sponsored service charging), service activity background service controls or network usage restrictions (for example based on a device state—such as power state, power save state, screen state, user interaction state, streaming media) as described herein (including but not limited to for example: block network access, restrict network access, throttle network access, delay network access, aggregate and hold network access, select for time of day network access restrictions, select network type restrictions, select roaming network access restrictions, select service usage restrictions such as a usage limit, select service cost restrictions such as a cost limit or otherwise place on another form of background service status or network usage restriction as described herein).

In some embodiments, this ability to track service usage for an service activity through a proxy service as described herein is used to improve usage reporting of service activities to a service controller for the purpose of statistically identifying service activities that are candidates for background (or roaming) service policy controls or network protections service policy controls.

In some embodiments, the various design techniques described herein that allow for monitoring, accounting for and/or implementing service policy for component service activities that belong to an aggregate service activity can be designed into the OS itself (or as a service processor component associated—such as with partition/permission/link/symlink—with the OS/system/kernel/platform). For example, in certain current mobile OS implementations (e.g. Android, iPhone, Blackberry, etc.) there are some applications available in the market that allow a user to get an estimate for how much data a certain subset of applications are consuming on a wireless service provider network, but it is not possible for the user or application to get an indication of the service usage for certain OS functions, whereas the embodiments disclosed herein will allow for this (for example assisted by a service processor component). As another example, in certain current mobile OS implementations it is not possible to associate proxy service usage (e.g. media download and media streaming proxy library software functions) with the specific applications that use the proxy service, so while the user can be informed of generic common OS functions or proxy services (e.g. in the case of Android: “media service”, “media”, “gallery”, “google service framework” and other generic common OS software library functions or proxy services), there is no way for the user to determine what applications widgets or other service activities are actually generating this common service function usage, whereas the invention described herein permits the user full visibility on such usage monitoring examples. Furthermore, if the OS is retrofitted with the intercept and policy implementation functions can be designed into the activity manager, broadcast intent manger, media service manager, service manager, or other application or service activity management function in the OS/system (for example Android OS). One or ordinary skill in the art will recognize that similarly, the various design techniques described herein that allow for intercepting a service activity intention to launch, and applying a background and/or roaming service policy set or a network protection service policy set can be designed into application launch management functions in the iPhone OS, windows mobile OS, windows PC OS, Blackberry OS, Palm OS, and other OS designs.

In some embodiments, a traffic control setting is selected based on the network service usage control policy. In some embodiments, the traffic control setting is implemented on the device based on the network service usage control policy. In some embodiments, the implemented traffic control setting controls traffic/traffic flows of a network capacity controlled service. In some embodiments, the traffic control setting is selected based on one or more of the following: a time of day, a day of week, a special time/date (e.g., a holiday or a network maintenance time/date), a network busy state, a priority level associated with the network service usage activity, a QoS class associated with the network service usage activity (e.g., emergency or whitelist traffic), which network the network service activity is gaining access from, which networks are available, a network type, a serving network carrier/service provider, a location or geography, a home network, a roaming network, which network the network service activity is connected to, which base station or communication channel the network service activity is connected to, and a network dependent set of traffic control policies that can vary depending on which network the service activity is gaining access from (e.g., and/or various other criteria/measures as described herein). In some embodiments, the traffic control setting includes one or more of the following: allow/block, delay, throttle, QoS class implementation, queue, tag, generate a user notification (for example based on a service processor component result/action/decision/request/offer), random back off, clear to send received from a network element, hold for scheduled transmission time slot, selecting the network from the available networks, and blocking or reducing access until a connection is made to an alternative network. In some embodiments, the traffic control setting is selected based on a network capacity controlled services priority state of the network service usage activity and a network busy state. In some embodiments, the traffic control setting (for example data access, background access or roaming access, wherein access comprises one or more of authorization, connection establishment, mobile IP session establishment, data transfers/traffic) is selected based on a device state (such as power state, screen state, screen dark/grey/locked state) or user interaction with the device. In some embodiments, the traffic control setting is selected based on a network capacity controlled services priority state of the network service usage activity and a network busy state and is global (e.g., the same) for all network capacity controlled services activities or varies based on a network service usage activity priority, user preferences or option selection, an application, a time based criteria, a service plan, a network the device or service activity is gaining access from, a redetermination of a network congestion state after adapting to a previously determined network busy state, and/or other criteria/measures as described herein.

In some embodiments, network capacity controlled services traffic (e.g., traffic flows) is differentially controlled for protecting network capacity (or enforcing device policy). For example, various software updates for an OS and one or more applications on the device can be differentially controlled using the various techniques described herein. As another example, security/antimalware software (e.g., antivirus, firewall, content protection, intrusion detection/prevention, and/or other security/antimalware software) can be differentially controlled using the various techniques described herein. As yet another example, network backups/imaging, content downloads (e.g., exceeding a threshold individually and/or in aggregate, such as for image, music, video, eBook content, email attachments, content/media subscriptions, RSS/news feeds, text/image/video chat, software updates, and/or other content downloads) can be differentially controlled using the various techniques described herein.

In some embodiments, an initiator (for example an application) triggers a control application (for example a media player) to utilize a proxy (media service). The activity stack and API data from the media player are provided to a classification and enforcement engine. The technique used to obtain traffic information for the purpose of tagging can be by, for example, a hook, callback, injection point, broadcast receiver, intent filter, or some other applicable mechanism (for example some other service processor component). In this way, traffic from a thread that is identified as that of the media server can be attributed to the initiator, and appropriate policy (e.g., traffic control, notification, and billing) can be enforced. Similarly, traffic from a thread that is identified as that of media player can be attributed to the initiator and appropriate policy can be enforced.

In some embodiments, after tagging a flow, it may be desirable to act on the flow in various ways related to the relevant service policy. For example, a mobile data limit can be set. Advantageously, it is possible to independently/differentially manage each app to restrict roaming and/or background and/or foreground data. It is also possible to disable background and/or roaming for a device across the board. Because of the way the flow is tagged, an app will not even be aware of restrictions to, e.g., background data.

Traffic tagging may or may not entail the use of hooks (or other service processor components/agents/functions). The amount of control over the proxy will depend upon whether, for example, the proxy was written by the same party that wrote other components of a device framework (or system/OS). In some embodiments a third party will make use of service processor components (for example hooks). It may also be desirable to hook at certain locations, such as in the socket, to tag back to a traffic stack “opened socket for thread” and give a socket-to-thread mapping. Combined with an API mapping, it is possible to map socket-to-app, which can then be pushed to a low level interface where traffic can be observed (e.g., a driver, in a kernel, etc.). As was previously discussed, in some embodiments the activity stack makes it possible to use hooks (if applicable) to map socket-to-control app-to-initiating app. In some embodiments, where every packet is counted at, e.g., a firewall, the low level interface can see the thread and can map each packet to the appropriate app even though the counted packets are, e.g., identified as those of the proxy. This facilitates traffic can being accurately dropped into the appropriate service policy buckets.

In some embodiments a data usage settings datastore includes service policy that can be accessed by a third party service engine (for example a service processor component). Service policy can be implemented and/or enforced using techniques described elsewhere herein. An example of policy that may be used by the service engine is “allow app” or “restrict app” (for example allow app in foreground, restrict app in background or block app in roaming).

In some embodiment a system manager launches the app and report app state to the 3^{rd} party service engine (or service processor or system or kernel). An example of app state is “callback on state change.” This can, for example, result in a callback if an app changes from running in the background to running in the foreground, or vice versa, or when the app is shut down. In some embodiments the system manager (or app state) depends on a device state (for example power, screen status) or network state or type. In some embodiments a list of apps in the foreground and/or background are communicated to a service processor component, OS, system or kernel function.

In some existing device operating systems, a proxy service function is used to manage the network service flows between the network and an application (e.g., application program, widget, service, process, embedded object, or any combination of these, etc.), and the proxy service is stored in the operating system (OS) as the application responsible for using services rather than the application actually using the network service. For example, in the Android OS, there exists a “media service” OS library software program function that manages the network stack interface for download of network data (typically, but not limited to, multimedia data). The device makes a request to the media service, which then performs various network stack interface functions to transfer the network data between the device application and the network. The media service can also process media files to determine how best to decode the multimedia and play the multimedia on the device user interface (UI). For example, the media service can determine the media filing coding standard (e.g., MP3, MP4, OGG, H.264, VP8, etc.), decode the media, select a player for the media (e.g., libstagefright (an Android streaming service library function), a third-party or OEM media player, etc.), and send the decoded media to the media player for UI playback. In the case of the media service, the data flows to the network can be classified by various device service usage monitoring agents (e.g., a kernel agent in the network stack) as belonging to the media service, not the originating application, and the OS provides no mechanism for tracking the usage back to the originating application.

In some embodiments, techniques or mechanisms associate the resulting network data flows back to the application name, identifier, process, etc. For example, in an Android system, the resulting network data flows can be associated with the UID. In some embodiments, a service classification and accounting agent (for example a service processor component—such as a hook) associates the resulting network data flows back to the application name, identifier, process, etc. by inspecting the resulting network data flows to determine a match between one or more aspects of the network resource identifier stored in association with the requesting application name, identifier, process, etc. In some embodiments, a service classification and accounting agent associates the resulting network data flows back to the application name, identifier, process, etc. by tracking the data flow from the interface between the media service manager and the application, through each stage of media service manager data flow processing to the resulting network data flow between the media service manager and the network stack. In some embodiments, virtual tagging is used, and the tracking is accomplished by identifying and recording, at each traffic processing step within the media services manager, an association between the traffic flows at one side of the traffic processing step and the traffic flows at the other side of the traffic processing step. In some embodiments with more than one traffic-processing step, the associations made for each step are followed to create an association for all steps. In some embodiments, literal tagging is used, and that tracking is accomplished by tagging the data flows at one side of the media service manager traffic processing and identifying the tag at the other side of the media service manager traffic processing.

In some embodiments, a proxy network service manager refers to an intermediary data flow function in a device operating system that sits on a data path between a device application and a device networking stack interface to provide a level of network service abstraction from the network stack interface, a higher-level service function above the network stack interface, enhanced or special traffic processing functions, media service transfer management, file download service, HTTP proxy service functions, quality-of-service (QoS) differentiation, or other similar or related higher-level traffic processing. Examples of proxy service managers include but are not limited to: a media service manager (e.g., the Android media service library function), an e-mail service manager, a domain name server (DNS) function, a software download service manager, a media download manager, a data download service manager, an Android “media” library function, the Android.net library function, the Java.net library function, an Apache library function, other similar software or library functions or services in other device operating systems, an SMTP, IMAP, or POP proxy, an HTTP proxy, an IM proxy, a VPN service manager, an SSL proxy, etc.

In some embodiments, the proxy service manager can perform application identification and classification, usage monitoring, and counting. This allows service usage to be classified and associated with an application prior to proxy processing. In some embodiments classification can be accomplished with a software agent (e.g. the service classification and accounting agent of a service processor) added to the proxy service manager software program (or library function—for example a hook). It may be noted that a software agent, in operation, can be implemented as an engine. In some embodiments a service classification and accounting proxy agent (for example a service processor component) can identify which application requested or is processing the data transfer with the network and can include this as part of the data flow classification for the data transfer. The service classification and accounting proxy agent can inspect the traffic to determine other parameters such as network destination (e.g., domain, URL, network address, IP address, traffic flow identifier, port address, etc.) or type of traffic (e.g., data or voice, text, SMS), network protocol (e.g., TCP-IP, UDP, native IP, HTTP, SSL, etc.)). The service classification and accounting proxy agent can also classify the traffic with other parameters such as active network, network state (network busy state, time of day, type of network (e.g., 3G, 4G, Wi-Fi, etc.)). The service classification and accounting proxy agent may also monitor service usage and account for traffic.

In some embodiments a service activity (alternatively service or communication activity) comprises a voice service (for example an inbound or outbound legacy voice, mobile voice or VOIP call) and a service processor component (for example assisted by a hook) analyzes incoming or outgoing phone calls and determines an action (for example allow or block) based on a service policy. In some embodiments the policy is based on source or destination number. In some embodiments in response to an incoming voice call, the telephony stack makes an authorization call to a service processor component, which evaluates a service policy/rule set/plan set (for example based on an authorization hook selects whether to allow call to ring the device or find out whether to allow call to be placed or received), returns a policy action (for example allow, don't allow, limit usage). In some embodiments one or more service processor components behave independently/differentially/differently (for example in a service policy, policy actions, notification) for voice, text, SMS and data. For example a service processor component in the kernel (or sends a policy and/or action to the kernel) may assist a data service policy but not be involved on voice or text service policy). For example emergency handling my transfer service policy and/or action to a service processor kernel and/or framework for data services, but not for one or more type of voice services. In some embodiments the device notifies (for example the user) of an allowed or blocked voice/phone call but not for a data service (for example a blocked background and/or roaming data service). In some embodiments emergency handling comprises one or more of 911, emergency services, whitelisted sources or destinations, CMAS, amber alert. In some embodiments emergency handling is assisted by special service processor components or service policies/actions (for example hardcoded rules that may not require a current plan or verified service controller communication/feedback).

In some embodiments a service activity (alternatively service or communication activity) comprises a text/SMS (for example an inbound or outbound text) and a service processor component (for example assisted by a hook) analyzes incoming or outgoing text PDU and determines an action (for example allow or block, or bill an entity) based on a service policy. In some embodiments the policy is based on source or destination number. In some embodiments an SMS PDU gets parsed/processed by a service processor component (for example assisted by a hook) for destination number, message type, whitelist, blacklist or emergency handling.

Overview of DDR Processor Implementation Embodiments

The DDR Processor can be provided using different configurations for secure embedded DDR firmware (e.g., in AWSP chipsets) including in an APU implementation, an MPU implementation, and a combined APU/MPU implementation as described herein in accordance with various embodiments. Those of ordinary skill in the art will also appreciate that similar and various other secure partition configurations for providing secure embedded DDR firmware can be provided in view of the various embodiments described herein.

In some embodiments, the DDR processor is provided using an integration into the APU chipset SEE and nonvolatile memory, such as an APU implementation shown in device architecture 1201 in which the DDR processor 1214 and a modem bus driver and physical bus 1242 are implemented in the zone of data path security 1240 as shown in FIG. 1. The DDR Processor is securely implemented on the 2G, 3G, or 4G modem data path directly below the modem driver data path processing function and above the modem bus driver data path processing function (e.g., typically USB driver, SDIO driver, or similar bus driver function). For example, using this approach, the entire data path below the DDR Processor through the modem bus driver and through the 2G, 3G or 4G network modem can be secured to prevent data paths that circumvent the DDR Processor data path processing.

In some embodiments, the DDR processor is provided using an integration into the 2G, 3G, or 4G MPU chipset SEE and nonvolatile memory, such as an MPU implementation shown in device architecture 1202 in which the DDR processor 1214 and a modem data path and signal processing 1254 are implemented in a zone of data path security 143 as shown in FIG. 1. The DDR Processor is securely implemented on the 2G, 3G, or 4G modem data path just below the modem bus driver and logical channel interface. For example, using this approach, the entire data path below the DDR Processor to the 2G, 3G or 4G network is secured to prevent data paths that circumvent the DDR Processor data path processing.

In some embodiments, the DDR processor is provided using an integration into the APU chipset SEE and nonvolatile memory, such as an APU and MPU implementation shown in device architecture 1203 in which the DDR processor 1214 is implemented in the zone of data path security 145, and a data path security verifier 1252 and the modem data path and signal processing 1254 are implemented in a zone of data path security 147 as shown in FIG. 1. The DDR Processor is securely implemented on the 2G, 3G, or 4G modem data path somewhere below the OS stack and above the modem bus driver. For example, using this approach, rather than securing the entire data path below the DDR Processor through the modem bus driver and through the 2G, 3G, or 4G network modem, the data path between the DDR Processor and the modem wireless network access connection is secured by integrity-checking the data that streams between the DDR Processor and a Data Path Security Verifier (DPSV) 1252 function. Any data path information that is not properly accounted for and integrity-checked is not conducted to or from the wireless network connection. For example, this approach eliminates the need to secure APU firmware, hardware, and data path elements other than the DDR Processor itself.

Embedded DDR Processor Implementation on an Application Processor

In some embodiments, embedding the DDR processor in an Application Processor Unit (APU) (e.g., smart phone APU or other wireless communication device APU) provides a single secure DDR Processor location in the wireless network data path (e.g., 2G/3G/4G wireless network data path or other device I/O connection or port) that provides for service usage monitoring and access control for multiple wireless modems. Also, the APU implementation approach can allow APU chipset suppliers who may not necessarily have WAN modem components or technology to implement solutions compliant with the various AWSP techniques described herein. Further, the APU implementation approach generally more easily allows for OTA and OTN firmware updates for APU implementations as described herein (e.g., which can be more complicated to provide in certain MPU implementations). Many disclosed embodiments describe DDR APU implementations where the DDR acts on communications flows through one or more wide area network networks, connections, or modems. As would be appreciated by one of ordinary skill in the art, the APU embodiments for a secure device data record processing system can also act on communications that flow over one or more additional I/O networks, connections, ports, or modems (e.g., a Wi-Fi network, connection, port, or modem; a USB network, connection, port, or modem; an Ethernet network, connection, port, or modem; a FireWire network, connection, port, or modem; a Bluetooth network, connection, port, or modem; a near field communication (NFC) network, connection, port, or modem; or another I/O connection, port, or modem).

Referring to device architecture 1201 as shown in FIG. 1, the DDR Processor is embedded into the APU chipset SEE and nonvolatile memory as similarly described above. Along with the DDR Processor SEE, the secure data path environment, shown as the Zone of Data Path Security 1240, includes the DDR Processor 1214 and the modem bus driver and physical bus 1242. For example, provided that the modem bus driver and the physical bus to the modem are secured against (e.g., or otherwise inaccessible to) fraudulent software or firmware attempting to circumvent the DDR Processor 1214, the modem itself (e.g., 3G modem or 4G modem 150) need not be secured. In particular, the DDR Processor 1214 is securely implemented on the 2G, 3G or 4G modem data path directly below the modem driver data path processing function and above the modem bus driver data path processing function (e.g., typically USB driver, SDIO driver or similar bus driver function). In some embodiments, the entire data path below the DDR Processor 1214 through the modem bus driver and through the 2G, 3G or 4G modem is secured to prevent data paths that circumvent the DDR Processor data path processing. In some embodiments, all information communicated from the device over device network connection or I/O port via the data path processing function (e.g., typically a USB driver, an SDIO driver, an Ethernet driver, a FireWire driver, a Wi-Fi driver, a Bluetooth driver, or a near field communication driver) is observed (and possibly processed to apply policy), classified, or reported on as it passes through the DDR Processor block. Accordingly, in some embodiments, the modem bus driver is either secured in the DDR SEE or in its own SEE, or the modem bus driver code and data path must be inaccessible to software or firmware on the APU that could circumvent the DDR Processor 1214.

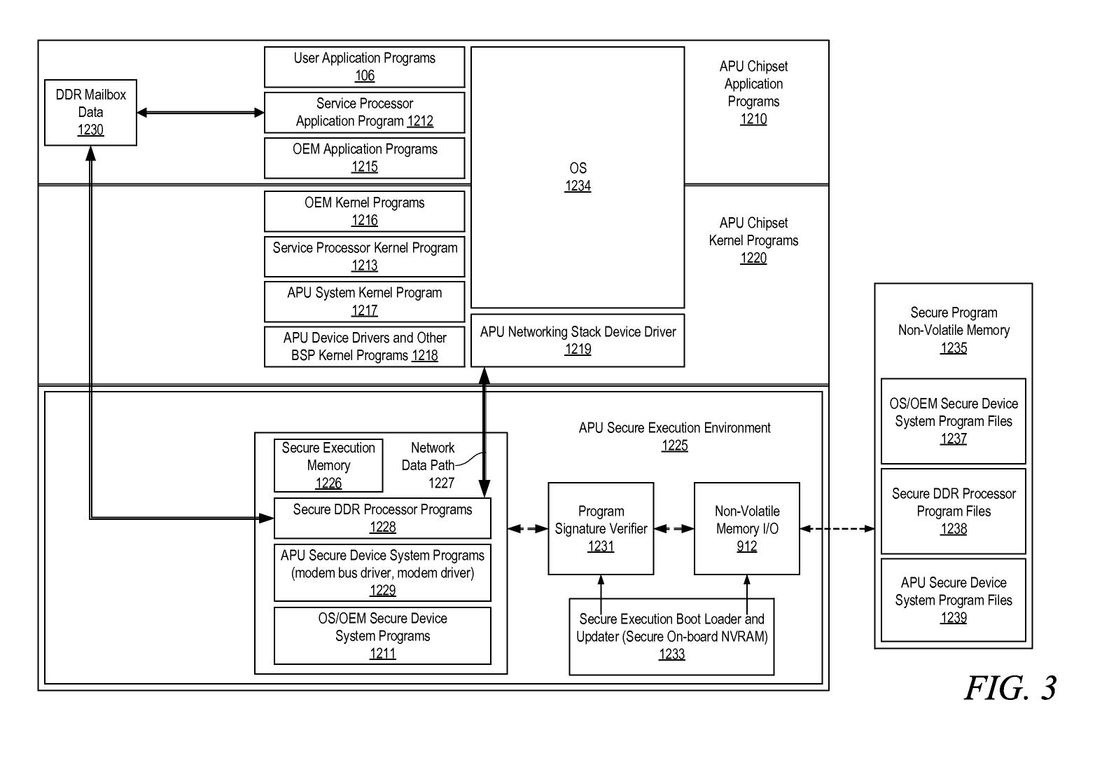

FIG. 3 illustrates an architecture for a secure embedded DDR Processor in an APU implementation in accordance with some embodiments. In particular, FIG. 3 shows the major functional elements within an APU based solution in accordance with some embodiments, in which the DDR processor 1214 resides in the APU's SEE together with other APU secure programs, and the DDR Processor's communication channel to the Service Processor application program 1212 is via a shared mailbox (e.g., a shared memory). FIG. 3 also shows an interface to the non-volatile memory (e.g., for software downloads) with the presence of secure boot code to ensure that all secure codes are first digital signature verified before a download is considered complete. In some embodiments, the data path is a separate interface in which data frames are sent to the secure environment for the DDR processor to gain access and perform DDR usage measure in addition to controlling limited or unlimited network access. Referring to FIG. 3, an APU can be logically partitioned into APU chipset application programs 1210, APU chipset kernel programs 1220, and a secure execution environment (SEE) shown as APU secure execution environment 1225. The APU secure execution environment 1225 communicates (e.g., using secure communication techniques, such as those described herein) with a network element/function (e.g., service controller 122 and/or other element(s)/function(s)). In some embodiments, secure program nonvolatile (non-volatile) memory 1235 includes OS/OEM secure device system program files 1237, secure DDR processor program files 1238, and APU secure device system program files 1239 that can be fetched by the secure boot loader residing in the APU secure execution environment (SEE) 1225 to be downloaded in to the SEE memory before code execution can take place as described herein.

The APU chipset application programs 302 include user application programs 106, service processor application program 1212 (e.g., for performing various service processor functions that need not be implemented in the kernel, as described herein), and OEM application programs 1215. The APU chipset kernel programs 304 include OEM kernel program 1216, service processor kernel program 1213 (e.g., for performing various service processor functions that are preferably implemented in the kernel, as described herein), APU system kernel program 1217, and APU device drivers and other BSP kernel programs 1218. As also shown, OS 1234 includes user/application space and kernel space implemented portions as would be apparent to one of ordinary skill in the art. Network access (e.g., 3G or 4G wireless network access) is communicated through APU network stack device driver 1219, which resides in kernel space 304 as shown.

The embodiments for SEE are described in the context of the DDR processor (or alternatively service processor DDR) in FIG. 3, 4, 5, 6, 7, 8, and associated descriptions, but the embodiments described may be applied (in addition or alternatively) to one or more of the service processor components (for example one or more of service processor application, service processor kernel, etc.), as would be appreciated by a person having ordinary skill in the art. In some embodiments, a first service processor component (for example DDR service processor) operates in a first SEE and a second service processor component operates on a second SEE (for example of different, similar, partial or low security). In some embodiments, the DDR processor is not present or not included with DAS or service processor functionality.

The APU SEE 1225 includes a secure execution memory 1226 for executing/storing secure DDR processor programs 1228, APU secure device system programs (e.g., modem bus driver, modem driver) 1229, and OS/OEM secure device system programs 1211. The APU SEE 1225 also includes a program signature verifier 1231 for verifying the secure DDR processor programs 326 and/or other secure programs in the secure execution memory 1226 as described herein. The APU SEE 1225 also includes non-volatile memory I/O 912 as shown. The APU SEE 1225 also includes a secure execution boot loader and updater (e.g., secure on-board NVRAM) 1233 for implementing a secure execution boot processes and secure update processes as described herein.

The embodiments for secure execution boot loader and updater (e.g., secure on-board NVRAM) 1233, program signature verifier 1231, nonvolatile memory I/O 912 for implementing a secure execution boot processes and secure update processes are described in the context of the DDR processor (or alternatively service processor DDR) in FIGS. 3, 4, 5, 6, 7, 8, and associated descriptions, but the embodiments described may be applied (in addition or alternatively) to one or more of the service processor components (for example one or more of service processor application, service processor kernel, etc.), as would be appreciated by a person having ordinary skill in the art.

In some embodiments, the network data path 1227 for any user or kernel mode applications or services are communicated from the APU networking stack device driver 1219 and monitored using secure DDR processor programs 326.

As further described herein, secure DDR processor programs 326 communicate to the service processor application program 1212 using a DDR mailbox function and communication channel as shown via DDR mailbox data 1230. In some embodiments, the DDR mailbox function provides a secure communication channel using various techniques as described herein. In some embodiments, the DDR mailbox function is used to communicate secure DDRs generated using secure DDR processor programs 326 for monitored network service usage to the service processor application program 1212. In some embodiments, the service processor application program 1212 communicates the secure DDRs to a network element/function, such as the service controller 122. In some embodiments, the service processor application program 1212 communicates the secure DDRs with a service processor report (e.g., which includes device based micro-CDRs/uCDRs based on monitored service usage based on service processor application program 1212 and/or service processor kernel programs 1213, such as application based monitoring/layer-7 or application layer based monitoring, as described herein) to a network element/function, such as the service controller 122. In some embodiments, the service processor application program 1212 communicates the secure DDRs with a service processor report for overlapping and/or common time periods/intervals (e.g., which facilitates reconciliation of device assisted service usage monitoring based on the two DAS assisted service usage measures by the service controller or other network elements/functions).

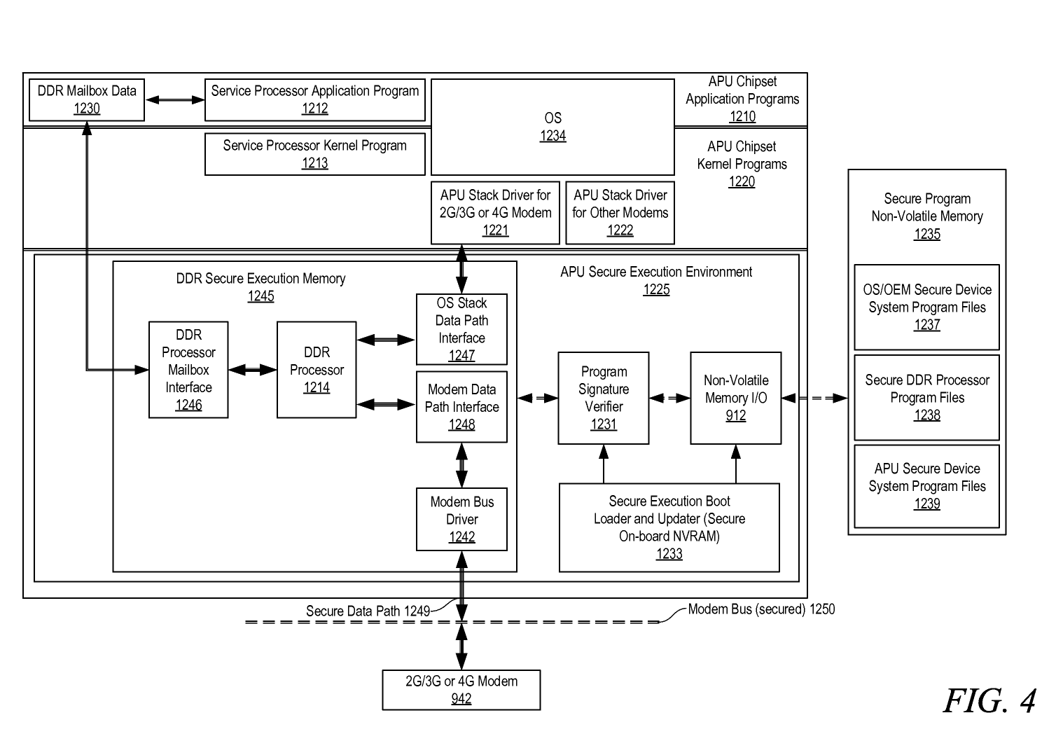

FIG. 4 illustrates another architecture for a secure embedded DDR Processor in an APU implementation along with a modem bus driver in accordance with some embodiments. In particular, FIG. 4 shows more detail on how DDR Processor 1214 can be implemented in an APU secure operating environment along with a modem bus driver 1242 (e.g., 2G, 3G, or 4G modem bus driver). DDR Processor 1214 monitors IP packets going to and from the modem bus driver 1242 (e.g. USB driver/controller), which provide for wireless network access via a secure data path 1249 to a modem bus 1250 for wireless access using a 2G/3G/4G modem 942 as shown. In some embodiments, DDR Processor 1214 monitors IP packets going to and from device I/O driver (e.g., typically a USB driver, a 2G/3G/4G modem driver, an SDIO driver, an Ethernet driver, a FireWire driver, a Wi-Fi driver, a Bluetooth driver, or a near field communication driver), which provides for device I/O access via a data path with secure DDR data path processing or monitoring.

As similarly described above, the secure execution boot loader and updater 1233 loads DDR Processor 1214 and modem bus driver images from nonvolatile (non-volatile) memory 912 into the execution memory within SEE, shown as DDR secure execution memory 1245, to execute (e.g., after code signature verification using secure program signature verifier 1231). DDR Processor 1214 and modem bus driver image and other secure images are all part of secure boot load to be signature verified before such are executed.

As shown, the DDR Processor sits in line with the 2G, 3G or 4G modem data path and all traffic between the OS stack and the 2G, 3G or 4G network is monitored by DDR Processor 1214. DDR Processor OS stack data path interface 1247 is provided that bridges between DDR secure execution environment (SEE) 1245 and the unsecure (wherein the term “unsecure” or “non-secure” in some embodiments may mean one or more of: differently-secure—for example by having lower data-path security but higher execution process privileges/properties/permission or system access privileges/properties/permission, less secure privileges/properties/permission, partially secure privileges/properties/permission or similar/equivalent secure privileges/properties/permission—for example similar secure privileges/properties/permission with a different key/signature/certificate/credential/etc.) OS stack in the kernel. Also, DDR Processor modem data path interface 1248 is provided that similarly connects DDR Processor 1214 to the modem data path fed by modem bus driver 1242. In some embodiments, DDR Processor 1214, which is provided in line on the data path and not simply a clone/monitor/drop function, also implements an access controller function to maintain the integrity of network access, for example, in the event that the DDR reports are tampered with or blocked from reaching the service controller 122 or DDR Processor 1214 is tampered with, or Service Processor 115 is tampered with, as described herein.

As also shown, DDR processor mailbox interface 1246 is provided that implements a mailbox function for passing DDR mailbox data 1230 between secure DDR SEE 1245 and unsecure Service Processor application 1212. As would be apparent to one of ordinary skill in the art in view of the various embodiments described herein, the DDR mailbox function can be implemented in a variety of ways.

In some embodiments, the DDR Processor and USB driver execute in a secure environment on the application processor chipset, such as DDR secure execution memory 1245. In some embodiments, the secure environment ensures no unauthorized ability to replace or modify the DDR Processor code or modem bus driver/controller code (e.g., a USB driver/controller or another device I/O driver/controller, such as a 2G/3G/4G modem driver/controller, an SDIO driver/controller, an Ethernet driver/controller, a FireWire driver/controller, a Wi-Fi driver/controller, a Bluetooth driver/controller, or a near field communication driver/controller). In some embodiments, the secure environment also ensures that the data path from the DDR Processor to the physical modem bus driver (e.g., USB port, Ethernet port, FireWire port, Wi-Fi port, Bluetooth port, NFC port, or another I/O bus port) is isolated from firmware outside the secure environment. That is, no firmware outside the secure environment has the ability to affect the accurate gathering of statistics by the DDR Processor. In some embodiments, the secure environment further ensures that there is no ability for code other than the DDR Processor to access sensitive crypto storage, such as keys. For example, this can include shielding sensitive storage from debug monitors and/or other monitoring/access activities or techniques. As would also be apparent to one of ordinary skill in the art, APU firmware, not just the DDR Processor, must be secured and not include bugs or vulnerabilities that can be exploited to allow for unauthorized access. For example, a common attack is buffer overflow, in which an attacker chooses inputs that cause an unchecked buffer to exceed its bounds, resulting in unintended behavior that the attacker can exploit.

There are various examples of APU chipset SEE Implementation techniques that can be used to meet these requirements as described above. For example, a conventional CPU with upgradeable firmware (e.g., including the DDR Processor) can be provided. The firmware can be stored in nonvolatile (non-volatile) memory, or can be stored in flash memory in which the flash memory can be reprogrammed/updated with new or upgraded firmware. The firmware can be installed at time of manufacture and by design provides a compliant secure environment. Rigorous quality-assurance testing is required to ensure that bugs are unlikely to provide a means for compromising the secure environment. A new firmware image can be accepted for installation only if it has a valid digital signature. Version control checking can be included to prevent rollback to older versions. The firmware that validates the signature and version resides in firmware that can also be upgradeable. As another example, a security partitioned CPU can be provided, such as an ARM Trustzone or Intel Smart & Secure (e.g., or another suitable substitute including potentially supplier custom security environment CPU partitioning techniques). The DDR Processor, modem bus driver (e.g., a USB driver/controller or another device I/O driver/controller such as a 2G/3G/4G modem driver/controller, an SDIO driver/controller, an Ethernet driver/controller, a FireWire driver/controller, a Wi-Fi driver/controller, a Bluetooth driver/controller, or a near field communication driver/controller), and any intervening code can execute in the secure partition, such as Trustzone's (e.g., or Smart & Secure's) secure mode. A secure boot procedure enforces the requirement that the DDR Processor, modem bus driver (e.g., a USB driver/controller or another device I/O driver/controller such as a 2G/3G/4G modem driver/controller, an SDIO driver/controller, an Ethernet driver/controller, a FireWire driver/controller, a Wi-Fi driver/controller, a Bluetooth driver/controller, or a near field communication driver/controller), and intervening code can be included in a digitally signed, version-controlled code image. In such approaches, hardware firewalls can shield sensitive crypto storage from normal mode firmware. Also, the hardware firewalls ensure that normal mode firmware cannot tamper with the data path between the DDR Processor and the physical modem bus driver (e.g., USB port), thus, preventing interference with the gathering of service usage measure data and/or statistics as described herein.

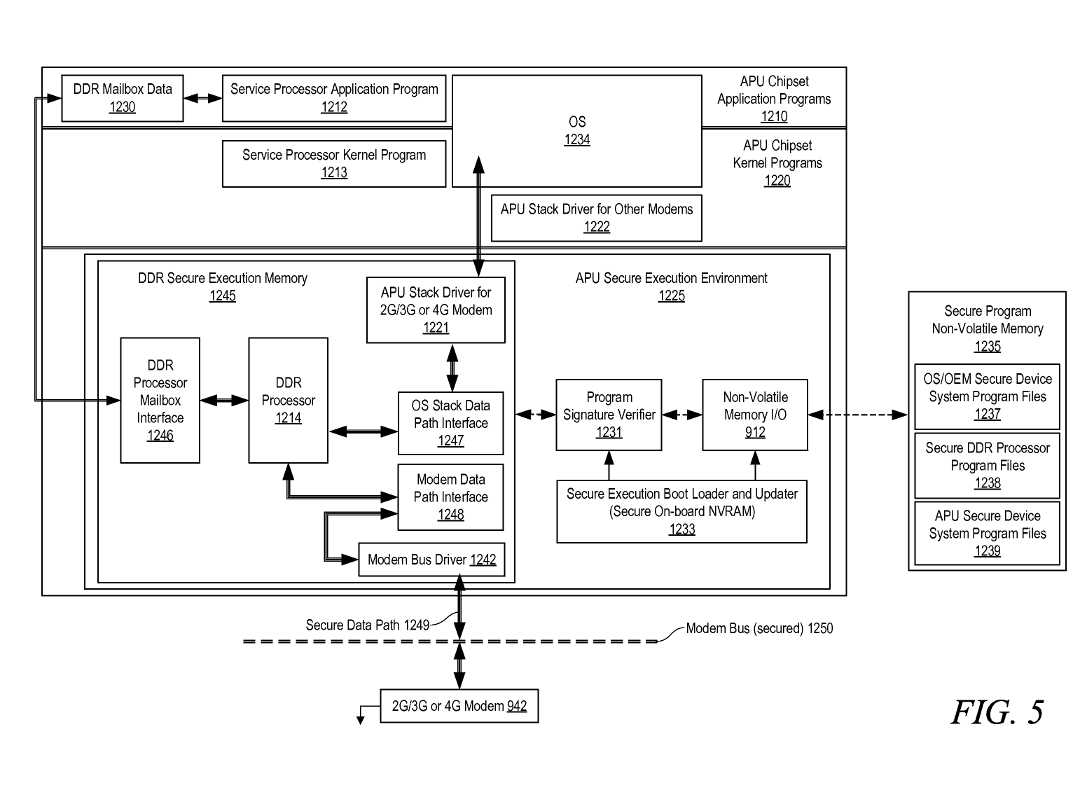

FIG. 5 illustrates another architecture for a secure embedded DDR Processor in an APU implementation along with a modem bus driver in accordance with some embodiments. In particular, FIG. 5 is similar to FIG. 4, except that as shown in FIG. 5, APU Stack Driver for 2G/3G or 4G Modem 1221 is located in the DDR secure execution memory 1245 instead of the APU kernel space 1220.

Embedded DDR Processor Implementation on a Modem Processor

In some embodiments, in an MPU implementation, the DDR Processor resides in the modem processor with other secure modem data path processing code and hardware functions. For example, in an MPU-based secure DDR Processor implementation, once the data path below the modem bus driver interface is secured, it is relatively difficult to hack the device to create a data path that reaches the network by circumventing the DDR Processor. Also, for some MPU chipset families, it can be more straightforward to implement a secure execution environment, secure boot loader, and secure nonvolatile memory as compared to implementing the same functions in some APU families that do not have standard hardware security partition features, such as ARM Trust Zone and Intel Smart & Secure. Further, an MPU implementation can have less interaction with the OS kernel builds than in the case of an APU implementation. In some embodiments with an MPU implementation, DDR Processor 1214 resides in a wireless wide area network modem such as a 2G, 3G or 4G modem, or in a local area or personal area modem such as a USB modem, an Ethernet modem, a FireWire modem, a Wi-Fi modem, a Bluetooth modem, an NFC modem, or another I/O modem. Many of the described embodiments are for MPU implementations with wireless wide area network modem, but, as would be appreciated by one of ordinary skill in the art, other variations involving other I/O device modems are possible without departing from the scope of the disclosure.

However, it should also be observed that in a MPU DDR Processor implementation, the modem processor environment may not have a CPU with the same performance and secure execution memory space as an APU solution. This apparent disadvantage can be mitigated by designing and optimizing the DDR Processor firmware so that the code memory size is small and the CPU performance requirement is appropriate for a typically relatively low powered modem processor chipset CPUs. Also, as mentioned above, the OTA and OTN update process may be more complex than that achieved by certain APU chipset suppliers and their OEMs.

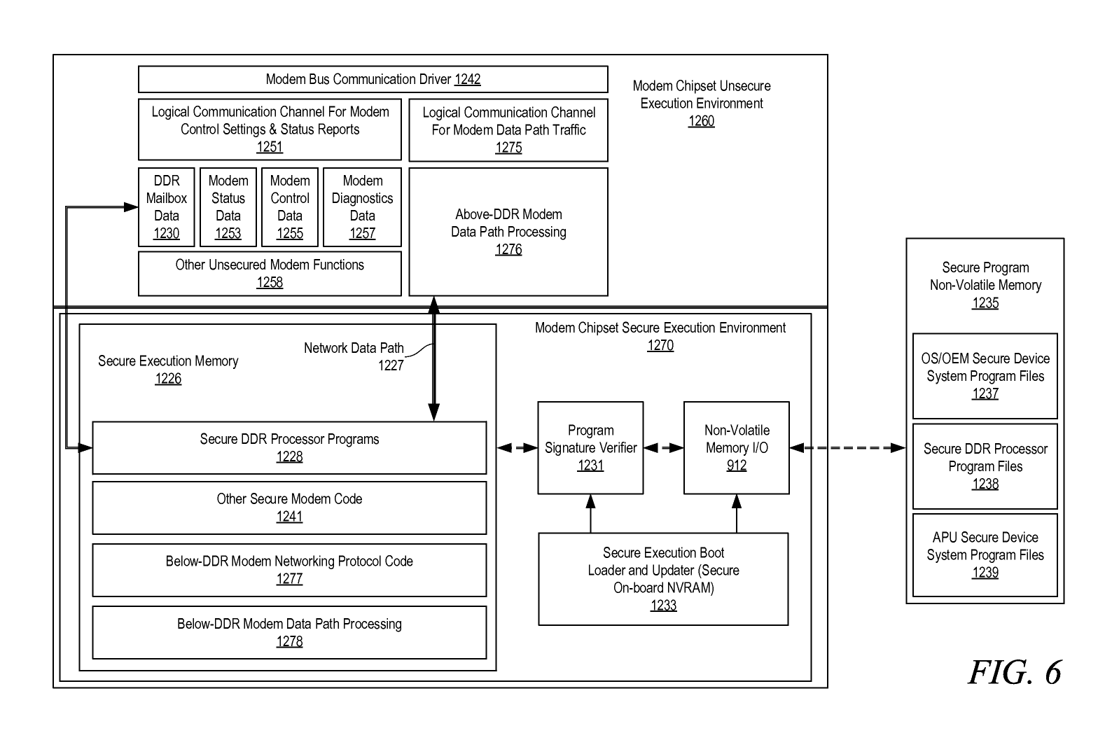

FIG. 6 illustrates an architecture for a secure embedded DDR Processor in an MPU implementation in accordance with some embodiments. In particular, FIG. 6 shows an MPU implementation that includes an embedded DDR Processor and modem data path from the DDR Processor to the network in the zone of data path security. In this approach, the DDR Processor 1214 is embedded into secure execution environment (SEE) 1270 and secure execution memory 1226 of the modem chipset (e.g., 3G or 4G MPU chipset). As shown, to ensure that fraudulent software or firmware cannot circumvent the DDR Processor, the Zone of Data Path Security includes the DDR Processor 1214 along with the modem data path processing and the modem signal processing that occurs between the DDR Processor and the antenna. In some embodiments, the DDR Processor 1214 is securely implemented on the 3G or 4G modem data path just below the modem bus driver 1242 and logical channel interface and the entire data path below the DDR Processor 1214 to the 3G or 4G network is secured to prevent data paths that circumvent the DDR Processor data path processing.

Similar to the APU based approach discussed above, FIG. 6 shows the major functional blocks within a modem based solution in which the DDR Processor 1214 resides in the modem's SEE monitor service usage via network data path 1227, along with other secure modem code 1241, below-DDR modem networking protocol code 1277, and below-DDR modem data path processing 1278, and the DDR processor's communication channel to the Service Processor application program is via a shared mailbox (e.g., serviced by a USB endpoint). This interface can either use a separate logical communication channel or be piggybacked on top of an already existing logical communication channel between APU and MPU. In some embodiments, the recipient of the DDR mailbox data 1230 is the Service Processor Application code.

As also shown in FIG. 6, the interface to the non-volatile memory (e.g., for software/firmware downloads/updates) with the presence of secure boot code ensures that all secure codes are first digital signature verified before download is considered complete. The data path is a separate interface in which data frames are sent to the secure environment for the DDR processor to gain access and perform DDR usage measure in addition to controlling limited or unlimited network access.

Modem chipset unsecure execution environment 1260 includes a modem bus communication driver 1242. In some embodiments, a logical communication channel for modem data path traffic 1275 and above-DDR modem data path processing 1276 is also provided. In some embodiments, a logical communication channel for modem control settings and status reports 1251, modem status data 1253, modem control data 1255, modem diagnostics data 1257, and other unsecured modem functions 1258.

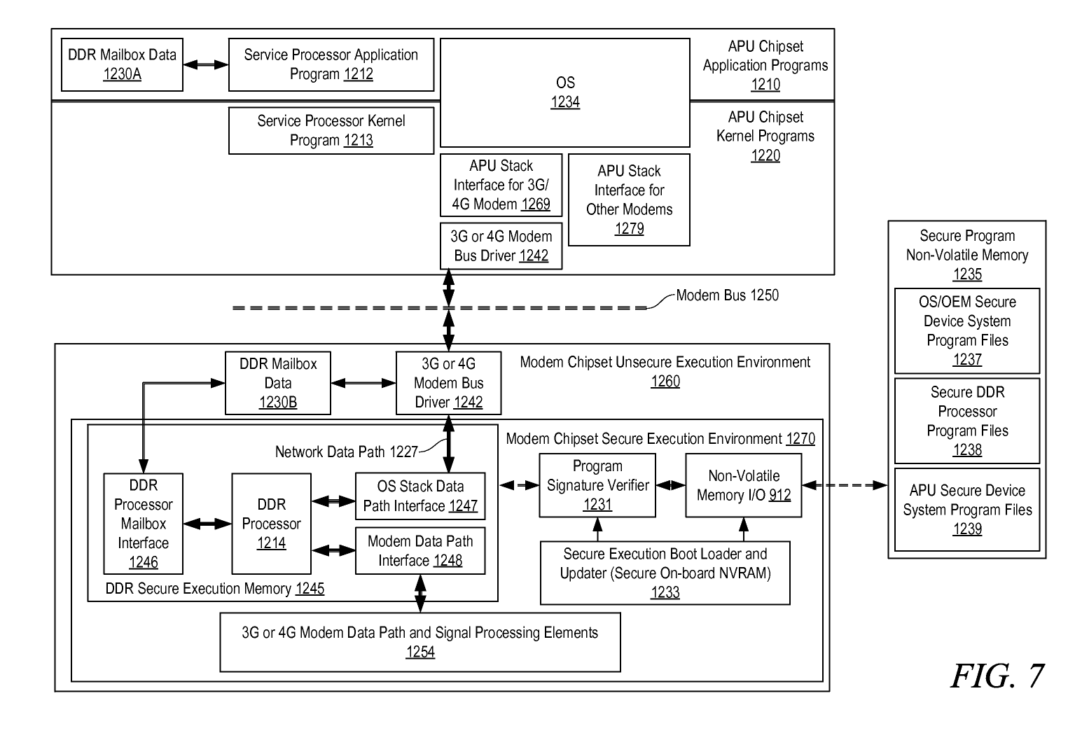

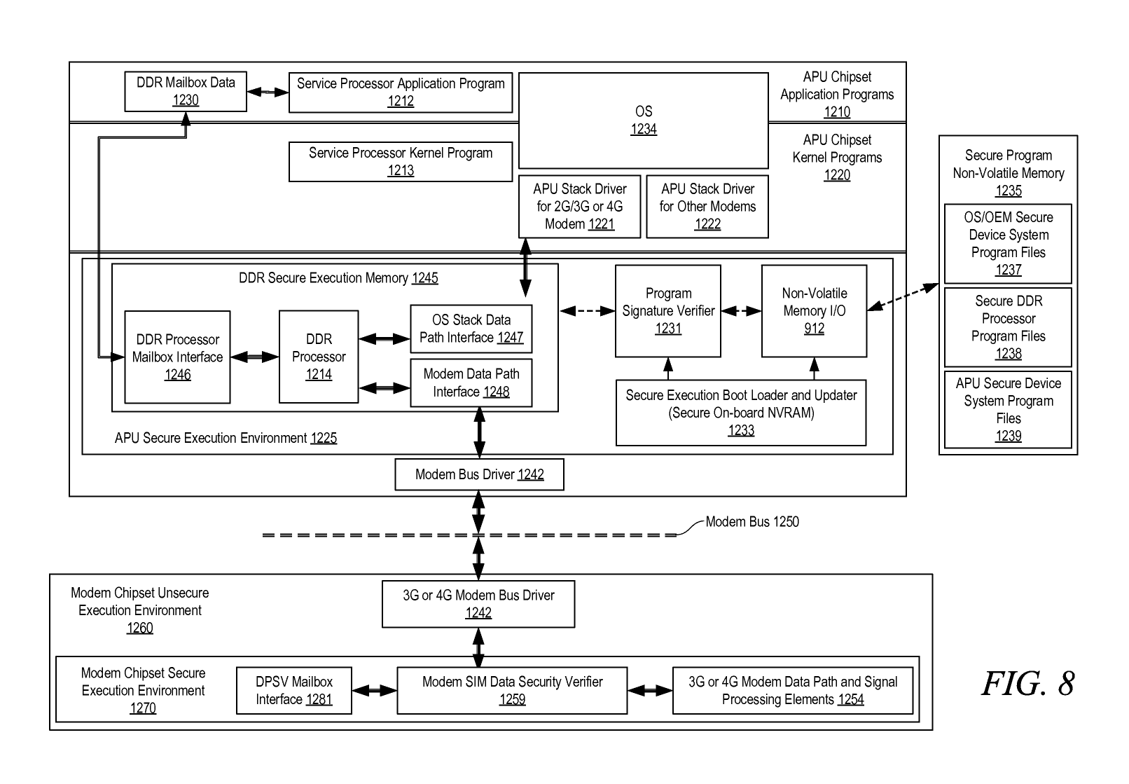

FIG. 7 illustrates another architecture for a secure embedded DDR Processor in an MPU implementation in accordance with some embodiments. In particular, FIG. 7 shows how the DDR Processor 1214 is implemented in an MPU secure operating environment where the data path through the 3G or 4G modem network processing and signal processing is secured up to the antenna from access from software or firmware other than the DDR Processor. In some embodiments, the secure boot loader process operates as similarly described above.

As shown, APU chipset application programs 1210, which includes DDR mailbox data 1230A communicated to the service processor application program 1212 as similarly described herein. APU chipset kernel programs 1220 includes service processor kernel program 1213 along with APU stack interface for 3G/4G modem 1269, APU stack interface for other modems 1279, and 3G or 4G modem bus driver 1242 for communication via modem bus 1250 to 3G or 4G modem bus driver 1242 of modem chipset unsecure execution environment 1260 as shown.

In some embodiments, the DDR Processor 1214 is in line with the data path allowing for secure network/service usage measure and/or access control as similarly described herein with respect to various embodiments. In some embodiments, a DDR Processor OS stack data interface (IF) 1247 is provided that bridges between the DDR secure execution environment (SEE) and the (potentially) unsecure modem bus driver interface 1242 in modem chipset unsecure execution environment 1260. As also shown, a DDR Processor modem data path interface 1248 is provided that similarly connects the DDR Processor 1214 to the modem data path processing and the modem signal processing 1254 that occurs between the DDR and the antenna. As described herein, the DDR is in line on the data path and is not simply a clone/monitor/drop function, as the DDR Processor also implement an access controller function in accordance with some embodiments to maintain the integrity of network access in the event that the DDR reports are tampered with or blocked from reaching the Service Controller, or the DDR Processor is tampered with, or the Service Processor is tampered with.

As also shown, a mailbox function is provided that passes data between the secure DDR SEE 1245 and the unsecure Service Processor application program 1212. In particular, a DDR Processor mailbox interface (IF) 1246 is in communication with a DDR mailbox 1230B, which is located in the modem chipset unsecure execution environment 1260. DDR mailbox data 1230A is shown as provided to the unsecure Service Processor application program 1212, which is provided through the modem communication path via the modem bus driver 1242 and the modem bus 1250 as shown. The DDR Processor mailbox interface (IF) 1246 is in communication with the DDR Processor 1214 and is located in the DDR SEE 1245. As would be apparent to one of ordinary skill in the art in view of the various embodiments described herein, the mailbox function can be implemented in a variety of ways. As similarly described above with respect to the various APU based embodiments, in accordance with some embodiments, the secure region is inclusive of all data path processing steps below the DDR Processor, and there is not any data path through the modem to the network that circumvents the DDR Processor.

In some embodiments, the DDR Processor executes in a secure environment in the MPU based embodiments, as similarly described above with respect to the APU based embodiments. In some embodiments, the secure environment ensures no unauthorized ability to replace or modify the DDR Processor code. In some embodiments, the secure environment also ensures that the data path from the DDR Processor to the antenna is isolated from firmware outside the secure environment. That is, no firmware outside the secure environment has the ability to affect the accurate gathering of statistics by the DDR Processor. In some embodiments, the secure environment further ensures that there is no ability for code other than the DDR Processor to access sensitive crypto storage, such as keys. For example, this can include shielding sensitive storage from debug monitors and/or other monitoring/access activities or techniques. As would also be apparent to one of ordinary skill in the art, MPU firmware, not just the DDR Processor, must be secured and not include bugs or vulnerabilities that can be exploited to allow for unauthorized access. For example, a common attack is buffer overflow, in which an attacker chooses inputs that cause an unchecked buffer to exceed its bounds, resulting in unintended behavior that the attacker can exploit.

Examples of secure execution environment (SEE) implementations in the MPU embodiments include the examples similarly discussed above for various secure execution environment (SEE) implementations in the APU embodiments.

Embedded DDR Processor Implementation on an Application Processor Combined with a Data Path Security Verifier on a Modem Processor

In some embodiments, the DDR Processor is embedded in a SEE APU chipset, and a Data Path Security Verifier (DPSV) is embedded in the MPU chipset, such as shown in device architecture 1203 of FIG. 1. For example, the DPSV can use cryptographic techniques to achieve a secure and trusted data path between the secure DDR Processor and the modem network antenna connection. This prevents a data connection between fraudulent software or firmware and the network without the need to secure the modem bus, the physical modem bus, and the modem data path elements above the DPSV element. By establishing a secure communication channel between the DDR Processor and the DPSV, a secure channel binding is created so that only network data path flows that are securely processed by the DDR Processor can reach the 3G or 4G modem connection to the wireless access network even if fraudulent software or firmware circumvents the DDR Processor by successfully gaining access to the modem bus interface. In the event that fraudulent software or firmware circumvents the DDR Processor and communicates intended unsecured data path information with the modem, the DPSV blocks the network data paths that are not processed and cryptographically secured by the DDR Processor.

FIG. 8 illustrates an architecture for a secure embedded DDR Processor in an APU and a Data Path Security Verifier (DPSV) in an MPU implementation in accordance with some embodiments. In particular, as shown in FIG. 8, the DDR Processor 1214 is embedded into the APU chipset SEE, and a second companion firmware image referred to herein as the Data Path Security Verifier (DPSV) 1259 is embedded into the MPU chipset SEE (e.g., a 3G or 4G MPU chipset SEE). As also shown, to ensure that fraudulent software or firmware cannot circumvent the DDR Processor, there are two zones of data path security, one encompassing only the DDR Processor and the second one that includes the DPSV along with the modem data path processing and the modem signal processing that occurs between the DDR and the antenna (e.g., this second zone of data path security is similar to that of a modem-only implementation of the DDR Processor).

As mentioned above, this approach does not require securing the APU 3G or 4G modem bus driver and physical bus. For example, some vendors and/or chipset suppliers (e.g., AWSP APU chipset suppliers) may consider it easier to create two firmware images and two zones of data path security rather than securing the data path between the DDR Processor SEE and the modem antenna connection. As compared to the APU implementation based approach, the firmware for the APU is somewhat simplified and the security design work involved with securing the modem bus driver and physical bus can be eliminated. As compared to MPU implementation based approach, the modem firmware is also simplified. For example, in some APU chipset architectures, it may be difficult to secure the data path from the DDR Processor through the modem bus driver, the modem physical bus, and the modem itself. Also, in some MPU chipsets, as similarly discussed above, there may be a need to simplify or reduce the size of the secure firmware program image required on the MPU. Simpler and smaller firmware can reduce the frequency of required updates or perhaps eliminate them altogether. The APU DDR Processor and MPU DPSV implementation approach described herein reduces the firmware required on the MPU down to the DPSV. This allows more complex data path processing by the DDR Processor to be implemented on the APU, in which (i) secure firmware execution memory is typically larger and CPU performance is typically higher, and (ii) the firmware update system is typically more capable and more flexible. However, there are also drawbacks with the APU DDR Processor and MPU DPSV implementation approach. The primary drawback is that firmware generally must be embedded in both the wireless network chipset (MPU) and the device Application Processor (APU) chipset.

As shown in FIG. 8, a first SEE 1225 is implemented on the APU chipset, which includes the DDR Processor 1214 for securely monitoring communications from APU stack driver for 2G/3G/4G modem 1221, using OS stack data path interface and/or modem data path interface 1248 as similarly described herein. A second SEE 1270 is implemented on the MPU chipset, which includes the Data Path Security Verification (DPSV) program 1259. The DPSV 1259 sits on the data path for the modem as shown. For example, the DPSV function can be quite simple: the DPSV 1259 only passes data path information that is processed and acknowledged by the DDR Processor 1214. The DPSV 1259 is bound to the DDR Processor 1214 so that it knows the secret session key of the DDR processor data path and can receive acknowledgements from the DDR Processor 1214. Various techniques for how the DDR Processor 1214 binds a secure data path channel to the DPSV 1259, and how the DPSV 1259 ensures that all 3G or 4G modem network service usage is being properly monitored and processed, is provided herein.

Referring to APU SEE 1225, a program signature verifier 1231, nonvolatile memory I/O 912, and secure execution boot loader and updater 1233 as similarly described herein with respect to various embodiments. The APU SEE 1225 also includes a DDR secure execution memory 1245. The DDR secure execution memory 1245 includes the DDR processor 1214 for monitoring the data path through OS stack data path interface 1247 and modem data path interface 1248 for data path communications via modem bus driver 1242 to modem bus 818 as shown. The DDR secure execution memory 1245 also includes a DDR processor mailbox interface for providing DDR mailbox data 1230 from DDR processor 1214 to service processor application program 1212 as shown and as similarly described herein. Similarly, the DPSV 1259 uses the DPSV mailbox interface 1281 as a communication channel to authenticate the DDR processor 1214 and establish a secret session key to be used for message integrity check between the two. Various techniques for implementing the security binding between DDR Processor 1214 and DPSV 1259 are described herein.

In some embodiments, the DDR Processor executes in a secure environment in the APU based embodiments, as similarly described above with respect to the APU based embodiments. In some embodiments, the secure environment ensures no unauthorized ability to replace or modify the DDR Processor code. In some embodiments, the secure environment further ensures that there is no ability for code other than the DDR Processor to access sensitive crypto storage, such as keys. For example, this can include shielding sensitive storage from debug monitors and/or other monitoring/access activities or techniques. As would also be apparent to one of ordinary skill in the art, APU firmware, not just the DDR Processor, must be secured and not include bugs or vulnerabilities that can be exploited to allow for unauthorized access. For example, a common attack is buffer overflow, in which an attacker chooses inputs that cause an unchecked buffer to exceed its bounds, resulting in unintended behavior that the attacker can exploit.

Similarly, in some embodiments, the DPSV executes in a secure environment. In some embodiments, the secure environment ensures no unauthorized ability to replace or modify the DPSV code. In some embodiments, the secure environment further ensures that there is no ability for code other than the DPSV to access sensitive crypto storage, such as keys. In some embodiments, the secure environment further ensures that there is no ability for any code to interfere with the proper crypto functions of the DPSV or communications between the DPSV and the DDR Processor. For example, this can include shielding sensitive storage from debug monitors and/or other monitoring/access activities or techniques. As would also be apparent to one of ordinary skill in the art, MPU firmware, not just the DPSV, must be secured and not include bugs or vulnerabilities that can be exploited to allow for unauthorized access. For example, a common attack is buffer overflow, in which an attacker chooses inputs that cause an unchecked buffer to exceed its bounds, resulting in unintended behavior that the attacker can exploit.

In some embodiments, the APU includes a Data Path Processor (DPP) that includes the DDR Processor function (or alternatively or in addition a second service processor function/module/component), which is secured in an APU SEE as described herein. In some embodiments, the APU DPP also includes other service monitoring, control, and notification functions. In some embodiments, the modem includes a Data Path Security Verifier (DPSV) that secures the path between the APU DPP and the modem network data path so that only the DPP can transmit over the modem even if other software, firmware, buses, or ports have access to the modem. In some embodiments, the modem DPSV is bound to the APU DPP by one or more of the techniques described herein and/or similar or other techniques as would be apparent to one of ordinary skill in the art in view of the various embodiments described herein. For example, the APU DPP can be provided in a secured data path to the modem network connection that cannot be circumvented by software, firmware, buses, or ports on the device. This can be a hardwired data path via hardware design or a data path secured with a secure firmware or software execution environment for all the data path elements below the APU DPP. The APU DPP and modem exchange public keys and/or digital certificates and then execute a key exchange process to authenticate each other which results in a secret shared session key to be used as the basis for message integrity checking.

Once the secret shared session key is established between APU DPP and DSPV, the APU DPP uses the session key to append an integrity check on each frame to be transmitted, and the modem uses the session key to validate the integrity check. The modem only allows frames that have a valid integrity check to be transmitted, and it blocks frames that do not include a valid integrity check, meaning that only frames that were processed by the APU DPP get transmitted. Similarly, the modem DPSV uses the session key to append an integrity check to each received frame, and the APU DPP uses the session to validate the integrity check before it is sent to the higher layer (e.g., application layer, etc.).

In some embodiments, modem downstream data path messages between DPSV and DPP are sequenced. In some embodiments, APU DPP upstream messages include downstream sequence information so that modem DPSV can confirm that APU DPP is receiving all downstream packets, and if not, then the modem DPSV can inform the APU DPP, inform the Service Controller, and/or take action such as restricting access and/or other appropriate actions.

In some embodiments, the APU DPP generates secure DDRs and communicates the secure DDRs to the Service Controller in a sequenced and secure manner as described herein with respect to various embodiments.

In some embodiments, the Service Processor application and/or Service Processor kernel program informs the APU DPP as to which sockets/flows belong to which applications (e.g., can be or should be associated with which applications for application based service usage monitoring, billing, and/or control) so that the APU DPP knows which application is generating or receiving traffic in order to assist in application classification tag for charging, traffic control, and/or user notification policies. In some embodiments, the Service Processor application informs the Service Processor kernel program as to which sockets/flows belong to which applications (e.g., can be or should be associated with which applications for application based service usage monitoring, billing, and/or control) so that the Service Processor kernel program knows which application is generating or receiving traffic in order to assist in application classification tag for charging, traffic control, and/or user notification policies (for example the binding between the application specified in a policy and the data present in the flows that can be matched on (uid)).

In some embodiments, the APU DPP performs a variety of functions. In some embodiments, the APU DPP can perform DDR Processor functions. The APU DPP can perform any or all of the service monitoring functions of the Charging Agent (CA) and/or Policy Decision Agent (PDA). The APU DPP can count all network traffic, and in some examples, classifying traffic by application and/or destination, NBS, time of day, active network, and/or various other criteria as described herein. The APU DPP can generate charging records. The APU DPP can communicate charging records to the Service Controller (e.g., or another network charging function) and/or device notification UI.

In some embodiments, the APU DPP performs access controller functions. For example, the APU DPP can instruct the service processor application and/or kernel program to either allow or block/kill or background an application or destination. The service processor application and/or kernel program can either allow/block or background an application by manipulating the application access to the network or by intercepting the application program boot/start sequence, or from suspending/resuming the application. The service processor application and/or kernel program can perform the intercept functions by reprogramming or intercepting application management functions in the OS (e.g., such as the Android activity manager and/or the service manager functions). The APU DPP either instructs service processor application/kernel program to control application and/or traffic, or controls traffic directly in the DPP. The APU DPP can perform policy enforcement functions as described herein with respect to various embodiments.

In some embodiments, the APU DPP can perform NBS monitor functions and/or reporting functions. For example, the APU DPP can detect NBS, modem performance parameters, network assets involved in link, and/or geo-location information.

In some embodiments, the APU DPP obtains network time from network with “secure” ping-loop system to verify that network time stamp is not intercepted and delayed. For example, the APU DPP can either have a local reliable clock or can perform a ping-loop each time a report is started and/or stopped.

Examples of secure execution environment (SEE) implementations in the APU DDR Processor and MPU DPSV embodiments include the examples similarly discussed above for various secure execution environment (SEE) implementations in the APU embodiments. Specific examples are also listed below. Example commercially available APUs include the following: Intel Atom (e.g., Z5xx, Z6xx, D4xx, D5xx series) based solutions with Intel Trusted Execution Technology including TPM support; and ARM based solutions with ARM Trusted Zone Architecture. Example APU specification requirements can also include: common hardware security blocks (e.g., AES, DES, RSA, Diffie-Hellman, SHA, and a random generator). Example commercially available MPUs include the following: EVDO chipset based solutions (e.g., ARM 11-based CPU architecture, including ARM Trusted Zone Architecture with many common hardware crypto blocks); HSPA chipset based solutions (e.g., Snapdragon/ARM based CPU architecture, including ARM Trusted Zone Architecture with many common hardware crypto blocks); and LTE chipset based solutions (e.g., Snapdragon/ARM based CPU architecture, including ARM Trusted Zone Architecture with many common hardware crypto blocks).

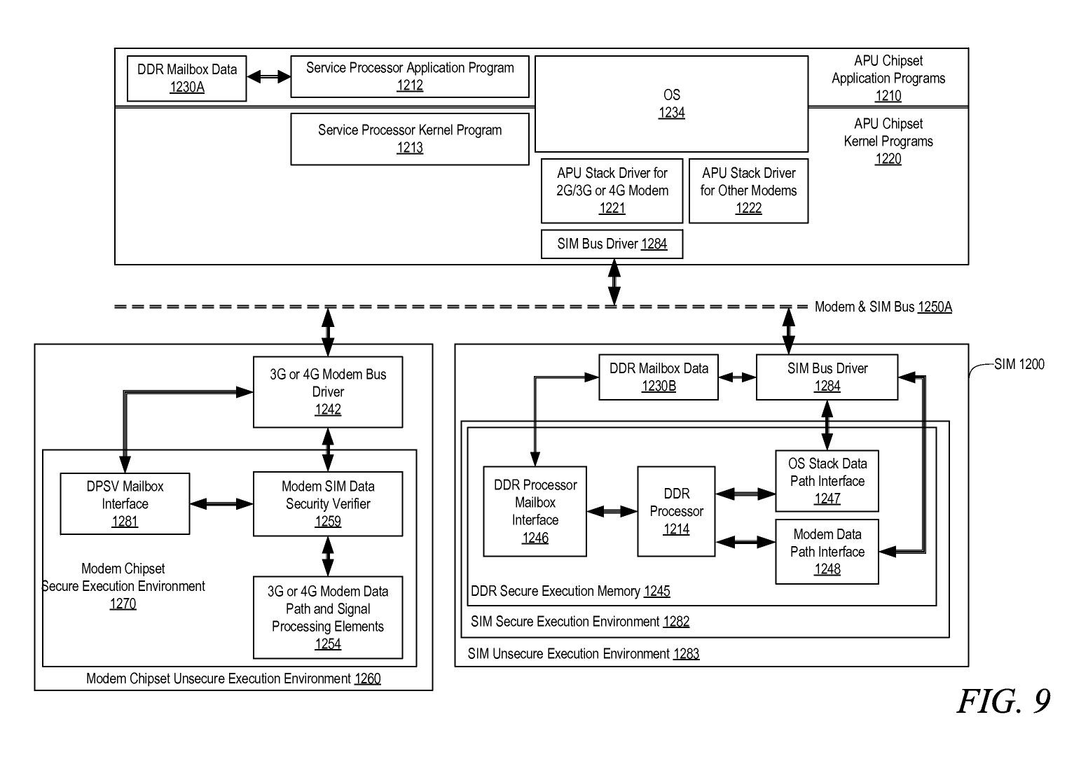

FIG. 9 illustrates an architecture for a secure embedded DDR Processor in a Subscriber Identity Module (SIM) and a Data Path Security Verifier (DPSV) in an MPU implementation in accordance with some embodiments. In particular, as shown in FIG. 9, the DDR Processor 1214 is embedded a SIM SEE 1282, and the Data Path Security Verifier (DPSV) 1259 is embedded into the MPU chipset SEE 1270 (e.g., a 3G or 4G MPU chipset SEE). Data communications from the APU, such as those similarly described herein including the mailbox function, communicate using the SIM bus driver 1284 using modem and SIM bus 1250A as shown.

As shown in FIG. 9, a first SEE 1282 is implemented in a SIM 1200, which includes the DDR Processor 1214 for securely monitoring communications from modem and SIM bus 1250A to SIM bus driver 1284, using OS stack data path interface 1247 and/or modem data path interface 1248 as similarly described herein. A mailbox function is similarly provided as described herein using DDR processor mailbox interface 1246, DDR mailbox data 1230B, and DDR mailbox data 1230A as shown.

As also shown in FIG. 9, data path communications via modem and SIM bus 1250A to 3G/4G modem bus driver 1242 to 3G/4G modem data path and signal processing elements 1254 are monitored using modem SIM data security verifier 1259 as described herein. The modem SIM data security verifier 1259 is implemented in a modem chipset SEE 1270 of the modem chipset/MPU 1260 as shown. Additionally, there is a DPSV mailbox 1281 that provides the communication channel to APU which the final destination to be DDR processor within the SIM for authentication and establishment of secret session key to be used as the basis for message integrity checking

In some embodiments, the SIM includes a Data Path Processor (DPP) that embeds the DDR function, which is secured in the SIM SEE. For example, the SIM DPP can also include other service monitoring, control, and notification functions. In some embodiments, the modem includes a Data Path Security Verifier (DPSV) that secures the path between the SIM DPP and the modem network data path so that only the DPP can transmit over the modem even if other software, firmware, buses, or ports have access to the modem.

In some embodiments, the modem DPSV is bound to the SIM DPP by one of the following techniques and/or similar or other techniques as would be apparent to one of ordinary skill in the art in view of the various embodiments described herein.

For example, the SIM DPP can be provided in a secured data path to the modem network connection that cannot be circumvented by software, firmware, buses, or ports on the device. The secured data path can be a hardwired data path via hardware design or a data path secured with a secure firmware or software execution environment for all the data path elements below the SIM DPP. In some embodiments, the communication between the DPSV 1259 and DDR Processor 1214 is secured using various secure communication techniques, such as those described herein. In some embodiments, the DPSV has a unique private/public key pair and a digital certificate (cert) that attests to the authenticity of its public key. The DDR Processor has a unique private/public key pair and a digital certificate (cert) that attests to the authenticity of its public key. The DPSV and the DDR Processor exchange public keys and certs, then execute a key exchange process that authenticates each other and results in a secret, shared session key. The DDR Processor receives upstream network data flows from the device OS networking stack and, using the session key, it appends an integrity check to each upstream data message that it sends to the DPSV. The DPSV blocks any upstream data path information that does not have a valid integrity check from the DDR Processor and informs the DDR Processor that it is receiving invalid upstream data so that the DDR Processor may inform the Service Controller of a possible fraud event. The DPSV receives downstream network data flows and, using the session key, it appends an integrity check to each downstream data message that it sends to the DDR Processor. Each downstream data message is, for example, sequenced so that data messages cannot be blocked or replayed without being detected by the DDR Processor. If the DDR Processor receives a downstream data message with an invalid integrity check, the DDR Processor rejects the message and informs the Service Controller of a possible fraud event. The DDR Processor acknowledges each non-rejected downstream data message in the next upstream data message it sends to the DPSV. If the DPSV stops receiving downstream data message acknowledgements, it blocks downstream network data flows and informs the DDR Processor so that the DDR Processor may inform the Service Controller of a possible fraud event. The DDR Processor securely sends DDR reports to the Service Controller by way of the Service Processor as described herein with respect to various embodiments.

In some embodiments, the modem downstream data path messages between the DPSV and DPP are sequenced. In some embodiments, the SIM DPP upstream messages include downstream sequence information so that modem DPSV can confirm that the SIM DPP is receiving all downstream packets and, if not, then modem DPSV can inform the SIM DPP, inform the Service Controller, and/or take action such as restricting access or another appropriation action(s).

In some embodiments, the SIM-MPU interface is a physical interface (e.g., a bus). In some embodiments, the SIM-MPU interface is a logical interface (e.g., via untrusted APU). In some embodiments, the SIM is logically an independent security hardware module (e.g., part of a secure execution environment) embedded into any device processing element (e.g., a SIM, video processor, audio processor, display processor, etc.).

In some embodiments, a SIM and MPU exchange comprises several components. In some embodiments, each of the MPU and the SIM has its own public/private encryption key pair with a certificate. In some embodiments, the MPU and SIM exchange keys using a key exchange protocol. In some embodiments, this key exchange takes place over a physical bus between the MPU and the SIM. In some embodiments, this key exchange takes place through a logical bus (e.g., via an untrusted APU). Such key exchanges protocols are well known in the art and are not described here. In some embodiments, after the MPU and SIM have mutually authenticated the keys using certificates, they establish a shared session key. In some embodiments, the MPU and SIM initialize a transmit count value to zero, a receive count value to zero, a maximum transmit count value to an integer N, and a maximum receive count value to an integer M. In some embodiments, the values of M and N are the same. In some embodiments, the values of M and N are implementation-dependent and can be determined based on the MPU's receive and transmit packet processing capabilities. For example, by choosing M to be 3 and N to be 2, the SIM block expects to get an ACK frame from the MPU after no more than three received packets and no later than after two transmitted packets; otherwise the SIM concludes that fraud has occurred and informs a network element.

In some embodiments, the MPU sends only a relevant portion of the transmit frame to the SIM for each outgoing packet in order to reduce SIM processing requirements. In some embodiments, the relevant portion of the transmit frames includes a header, transmit count, and an integrity check. In some embodiments, the header includes information such as one or more of source and destination addresses, source and destination ports, a protocol tag, and a packet length in bytes. In some embodiments, the transmit count counts transmitted frames and increments with each transmit frame. In some embodiments, the integrity check is determined by hashing one or more of the session key, header, and the transmit count.

In some embodiments, the MPU also sends only a relevant portion of the receive frame to the SIM for each incoming packet. In some embodiments, the relevant portion of the receive frames includes a header, receive count, and an integrity check. In some embodiments, the header is the same as the transmit frame header (e.g., one or more of source and destination addresses, source and destination ports, a protocol tag, and a packet length in bytes). In some embodiments, the receive count increments with each received frame. In some embodiments, the integrity check is determined by hashing one or more of the session key, header, and transmit count.

In some embodiments, the frame acknowledgment (e.g., ACK) is the sum of the maximum transmit count, the maximum receive count, and the integrity check. In some embodiments, the maximum transmit count is set to (transmit count+N), where transmit count is the transmit count from the most recent transmit frame. In some embodiments, the maximum receive count is set to (receive count+M), where receive count is the receive count from the most recent received frame. In some embodiments, the integrity check is determined by hashing one or more of the session key, maximum transmit count, and maximum receive count.

In some embodiments, the interface between the MPU and the SIM is a logical channel (e.g., via untrusted APU). In some embodiments, on the transmit side the APU sends the SIM the transmit frame header only (e.g., one or more of source and destination addresses, source and destination ports, a protocol tag, and a packet length in bytes). In some embodiments, the SIM sends back to the APU the transmit count, the maximum receive count (e.g., receive count+M), and an integrity check. In some embodiments, the SIM increments the value of the transmit count for every transmitted frame. In some embodiments, the SIM determines the integrity check by hashing one or more the session key, the header, the transmit frame count and the maximum receive count. In some embodiments, the APU appends the header and the frame body to the SIM-delivered transmit count, max receive count, and the integrity check and sends the result to the MPU. In some embodiments, the MPU transmits only the frames passing the integrity check one at time. In such embodiments, the MPU may not use a maximum transmit count.

In some embodiments, the interface between the MPU and the SIM is a logical channel (e.g., via untrusted APU). In some embodiments, on the receive side the MPU sends the APU the header (e.g., one or more of source and destination addresses, source and destination ports, a protocol tag, and a packet length in bytes), the receive count, an integrity check, and the frame body. In some embodiments, the receive count is incremented for every received packet. In some embodiments, the integrity check is determined by hashing one or more of the session key, the header, and the receive count. In some embodiments, the APU sends only the header (e.g., one or more of source and destination addresses, source and destination ports, a protocol tag, and a packet length in bytes), the receive count, and the integrity check to the SIM. In some embodiments, the MPU can process more than a single receive frame before obtaining the SIM confirmation feedback. In some embodiments, the SIM ACK frame (e.g., the indication of the maximum receive count) is piggybacked onto the frame as described herein.

In some embodiments, the MPU sends the entire data frame to the SIM, and the SIM appends an integrity check to be validated on the transmit side and on the receive side. In some embodiments, the DSPV engine adds the integrity check to the data frames and sends them to the SIM. In such embodiments, the SIM interfaces with the APU, and the SIM (DDR Processor) is in the middle of the data exchange.

In some embodiments, in each transmit frame, the MPU increments the transmit count and compares that value to the value of maximum transmit count as obtained from the most recent frame acknowledgment. In some embodiments, if the transmit count is greater than the maximum transmit count, the MPU determines that the SIM is not receiving valid transmit frame data. In some embodiments, the MPU informs a network element (e.g., a trusted entity such as a service controller) that a fraud has occurred after determining that the SIM is not receiving valid transmit frame data.

In some embodiments, if the MPU detects an invalid integrity check in a frame acknowledgment, or if the SIM detects an invalid integrity check on a transmit frame, the MPU or the SIM determines that malicious behavior is occurring. In some embodiments, when the MPU or the SIM determines that malicious behavior is occurring, the MPU or the SIM informs a network element (e.g., a trusted entity such as a service controller) that a fraud has occurred. In some embodiments, if the MPU or the SIM does not determine that malicious behavior is occurring, the SIM updates the DDR data collection using the header from the transmit frame and reports the results to the network element.

In some embodiments, in each receive frame, the MPU increments the receive count and compares that value to the value of the maximum transmit count as obtained from the most recent frame acknowledgment. In some embodiments, if the receive count is greater than the maximum receive count, the MPU determines that the SIM is not receiving valid receive frame data. In some embodiments, the MPU informs a network element (e.g., a trusted entity such as a service controller) that a fraud has occurred after determining that the SIM is not receiving valid receive frame data.

In some embodiments, if the MPU detects and invalid integrity check in a frame acknowledgment, or if the SIM detects an invalid integrity check on a receive frame, the MPU or the SIM determines that malicious behavior is occurring. In some embodiments, when the MPU or the SIM determines that malicious behavior is occurring, the MPU or the SIM informs a network element (e.g., a trusted entity such as a service controller) that a fraud has occurred. In some embodiments, if the MPU or the SIM does not determine that malicious behavior is occurring, the SIM updates the DDR data collection using the header from the receive frame and reports the results to the network element.

In some embodiments, the SIM DPP generates secure DDRs and communicates the secure DDRs to the Service Controller in a sequenced and secure manner as described herein with respect to various embodiments.

In some embodiments, the Service Processor application and/or Service Processor kernel program informs the SIM DPP which sockets/flows belong to which applications so that the SIM DPP knows which application is generating or receiving traffic in order to assist in application classification tag for charging, traffic control, and notification policy.

In some embodiments, the SIM DPP performs a variety of functions, as described herein. For example, the SIM DPP can perform the DDR Processor functions. The SIM DPP can perform any or all of the service monitoring functions of the Charging Agent (CA) and/or Policy Decision Agent (PDA). The SIM DPP counts all traffic with the network, and in some cases, also classifies the traffic by application and/or destination, NBS, time of day (TOD), active network, and/or various other criteria. The SIM DPP can generate charging records. The SIM DPP can communicate charging records to the Service Controller (e.g., or another network charging function) and/or device notification UI.

As another example, the SIM DPP can perform various access controller functions. The SIM DPP can instruct the Service Processor application and/or kernel program to either allow, block/kill, or background an application or destination. The Service Processor application and/or kernel program can allow, block/kill, or background an application by manipulating the application access to the network or by intercepting the application program boot/start sequence, or from suspending/resuming the application. The Service Processor application and/or kernel program can perform the intercept functions by reprogramming or intercepting application management functions in the OS (e.g., such as the Android activity manager and/or the service manager functions). As an example, the SIM DPP can either instruct the Service Processor application and/or kernel program to control the application and/or traffic, or controls traffic directly in the DPP. The SIM DPP can also perform policy enforcement functions as described herein.

As yet another example, the SIM DPP can perform NBS monitoring and/or reporting functions. The SIM DPP can detect NBS, modem performance parameters, network assets involved in link, and geo-location.

As yet a further example, SIM DPP can obtain a network time from network with “secure” ping-loop system to verify that network time stamp is not intercepted and delayed. For example, the SIM DPP can either have local reliable clock or can perform ping-loop each time a report is started and/or stopped.

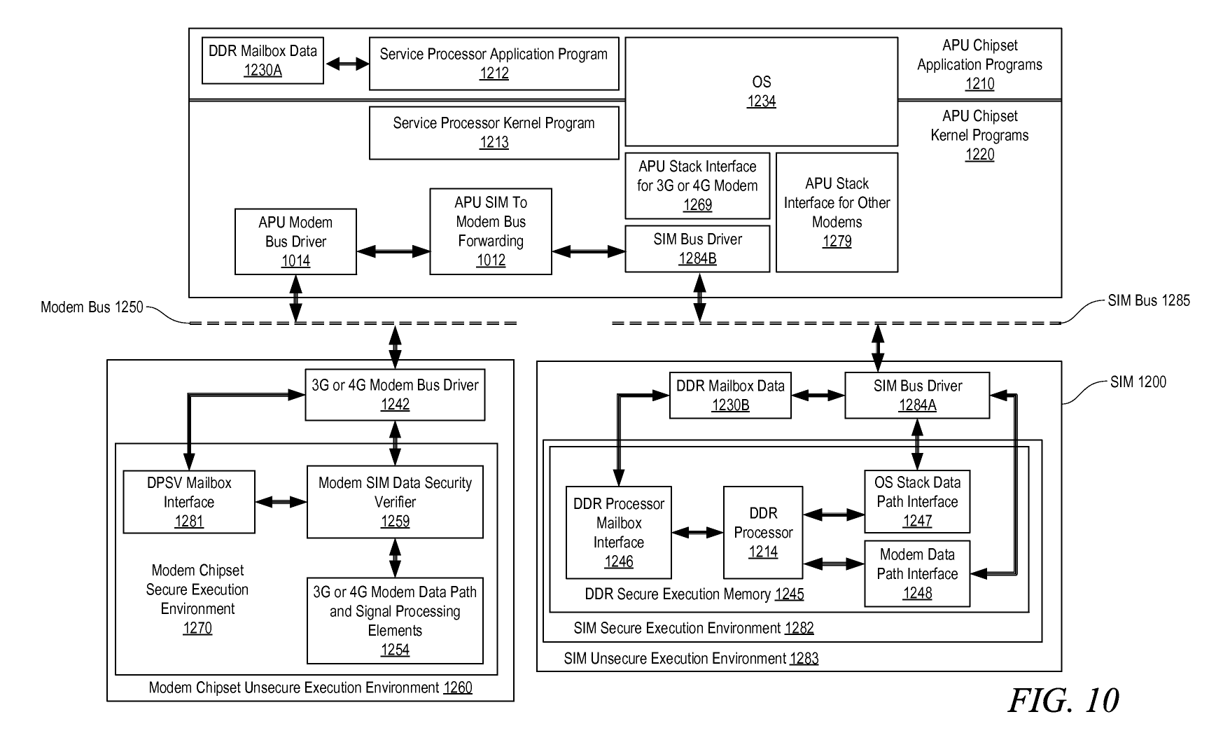

FIG. 10 illustrates another architecture for a secure embedded DDR Processor in a Subscriber Identity Module (SIM) and a Data Path Security Verifier (DPSV) in an MPU implementation in accordance with some embodiments. In some applications it may be desirable to locate the DDR Processor on a standalone chipset that attaches to the APU or MPU chipset, such as a SIM card. FIG. 10 illustrates such an implementation in accordance with some embodiments. For example, an embedded DDR Processor can be implemented on a smart phone APU chipset combined with a Data Path Security Verifier (DPSV) implemented on a 3G or 4G wireless modem chipset.

In some embodiments, a hardware or firmware secure data path between the DDR Processor and the modem DPSV is not required, such as shown in FIG. 10, in which the DDR Processor is implemented on the SIM card (e.g., or another standalone security chipset) by providing a data path logical channel forwarding function on the APU and providing a mailbox data communication function between the Service Controller and the DDR Processor to connect over a SIM data bus. In addition, the DDR Processor reports to the Service Controller can be secured with none of the system elements on the APU being secured in a hardware assisted secured execution environment (SEE).

Referring to FIG. 10, the secure DDR Processor 1214 is located in DDR Secure Execution Memory 1245 of SIM Secure Execution Environment 1282 on the SIM as shown, as similarly described above with respect to FIG. 9. The architecture of the APU is similar to that shown in and discussed above with respect to FIG. 9, except that an APU SIM to modem bus forwarding function 1286 and an APU bus driver function 1287 are added to the APU in the APU Chipset Kernel Programs 1220 as shown in FIG. 10. A secure DPSV 1259 is located in modem chipset SEE 1270 of the modem for monitoring communications from 3G/4G modem bus driver using 3G/4G modem data path and signal processing elements 1254 as similarly described above with respect to FIG. 9. However, in FIG. 10 in comparison with FIG. 9, the MPU and SIM are separate hardware or chipsets that communicate with the APU via independent communication buses. In particular, the MPU communicates with the APU via modem bus 1250 using 3G/4G modem bus driver 1242 to APU modem bus driver 1287 and APU SIM to modem bus forwarding function 1286 as shown. The SIM communicates with the APU via SIM bus 1285 using SIM bus driver 1284A to SIM bus driver 1284B as shown. Also, the DPSV uses DPSV mailbox 1281 as the communication channel to authenticate the DDR processor 1214 in the SIM where the connection is established within the APU. As shown the APU has two communication channels; a first communication channel with the DDR processor and a second communication channel with the DPSV.

In some embodiments, a first logical communication channel is created over the SIM bus 1285 between the Service Processor DDR mailbox 1230A on the APU and the DDR mailbox 1246 on the SIM, and this supports the communication between the Service Processor (e.g., Service Processor application program 1212 and/or Service Processor kernel program 1213) and the DDR Processor 1214 using DDR processor mailbox interface 1246 to DDR mailbox data 1230B to SIM bus driver 1284A as shown. A second logical data channel is created over the SIM bus 1285 between the OS networking stack and the DDR Processor 1214, and this is the logical channel intended for all OS networking stack communications with the 3G or 4G network using OS stack data path interface 1247 to SIM bus driver 1284A as also shown. A third logical communication channel is created between the SIM DDR Processor 1214 and the modem DPSV 1259. This third logical communication channel is formed by forwarding data between the SIM bus interface (e.g., modem data path interface 1248 to SIM bus driver 1284A) located on the SIM, the SIM bus driver 1284B located on the APU, the SIM to modem bus forwarding function 1286 located on the APU, the modem bus driver 1287 located on the APU, and the modem bus interface 1242 located on the modem as also shown.

In some embodiments, the communication between the DPSV 1259 and DDR Processor 1214 is secured using various secure communication techniques, such as those described herein. In some embodiments, the DPSV has a unique private/public key pair and a digital certificate (cert) that attests to the authenticity of its public key. The DDR Processor has a unique private/public key pair and a digital certificate (cert) that attests to the authenticity of its public key. The DPSV and the DDR Processor exchange public keys and certs, then execute a key exchange process that authenticates each other and results in a secret, shared session key. The DDR Processor receives upstream network data flows from the device OS networking stack and, using the session key, it appends an integrity check to each upstream data message that it sends to the DPSV. The DPSV blocks any upstream data path information that does not have a valid integrity check from the DDR Processor and informs the DDR Processor that it is receiving invalid upstream data so that the DDR Processor may inform the Service Controller of a possible fraud event. The DPSV receives downstream network data flows and, using the session key, it appends an integrity check to each downstream data message that it sends to the DDR Processor. Each downstream data message is, for example, sequenced so that data messages cannot be blocked or replayed without being detected by the DDR Processor. If the DDR Processor receives a downstream data message with an invalid integrity check, the DDR Processor rejects the message and informs the Service Controller of a possible fraud event. The DDR Processor acknowledges each non-rejected downstream data message in the next upstream data message it sends to the DPSV. If the DPSV stops receiving downstream data message acknowledgements, it blocks downstream network data flows and informs the DDR Processor so that the DDR Processor may inform the Service Controller of a possible fraud event. The DDR Processor securely sends DDR reports to the Service Controller by way of the Service Processor as described herein with respect to various embodiments.

In some embodiments, the DDRs transmitted from the DDR Processor to the Service Controller are integrity checked and sequenced in a manner that cannot be tampered with or replayed. An authentication process between the DDR Processor and the Service Controller combined with a set of unique DDR report sequence identifiers and authentication session keep-alive timers are used to maintain and confirm the secure connection between the DDR Processor and the Service Controller. If the secure session or the flow of DDR records between the DDR Processor and the Service Controller are interrupted, then the access control function in the DDR Processor restricts access of the 3G or 4G modem data path to the network destinations necessary to reestablish a securely authenticated session with between the DDR and the Service Controller.

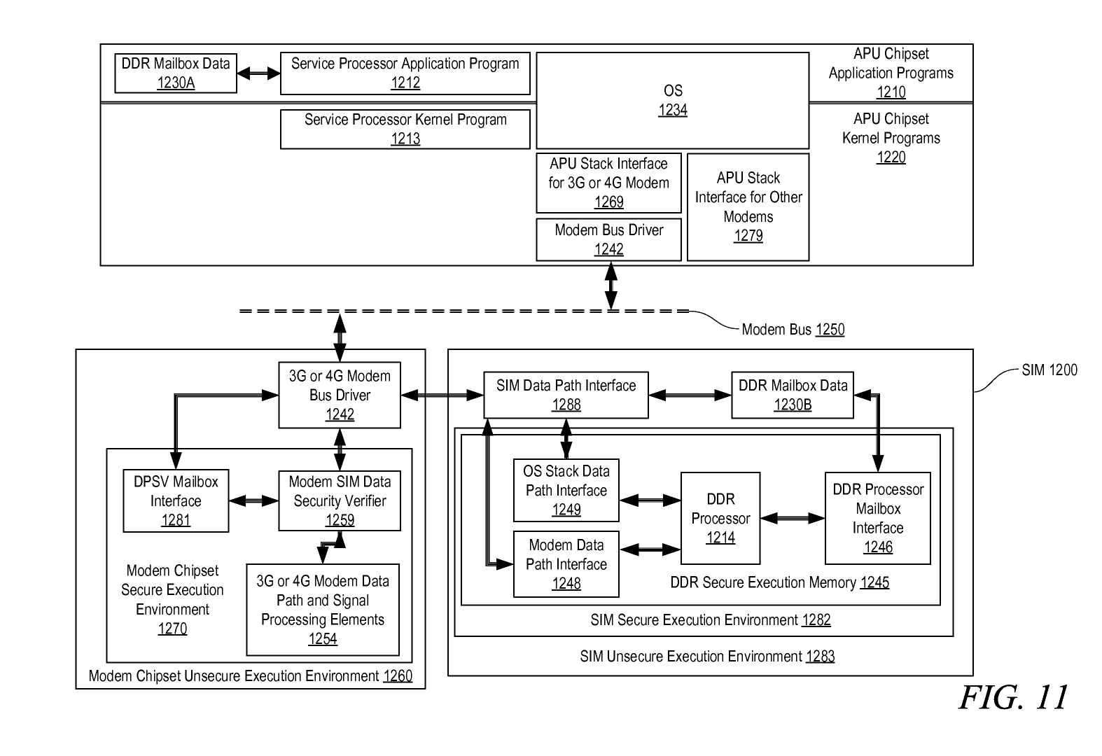

FIG. 11 illustrates another architecture for a secure embedded DDR Processor in a Subscriber Identity Module (SIM) and a Data Path Security Verifier (DPSV) in an MPU implementation in accordance with some embodiments. FIG. 11 is similar to FIG. 9 except that as shown a SIM data path interface 1288 is provided for direct communication from the SIM with 3G or 4G modem bus driver 1242 on the MPU. SIM communications, such as those similarly described herein to the APU including the mailbox function, communicate using the SIM data path interface 1288 to the 3G or 4G modem bus driver 1242 using modem bus 1250 to communicate with the APU via modem bus driver 1242 and the APU stack interface for 3G or 4G modem 1269 as shown.

In some embodiments, various other architectures including various other locations of the DDR Processor can be provided using these or similar techniques as will now be apparent to one of ordinary skill in the art in view of the embodiments described herein.

In some embodiments, various other architectures including various other locations of the DDR Processor and/or DPSV can be provided using these or similar techniques as will now be apparent to one of ordinary skill in the art in view of the embodiments described herein.

For example, the DDR Processor (e.g., and/or various secured elements of the Service Processor) can be located in various other locations (e.g., in various secure operating environments) that involve network access policy enforcement at higher levels in the network stack. In particular, certain functions performed by the Service Processor without hardware security can be located in hardware secured execution memory. Such functions can include 3G and 4G network data path processing and usage report functions, 3G and 4G network application access management and usage reporting functions, and 3G and 4G service user notification and customer activity status functions.

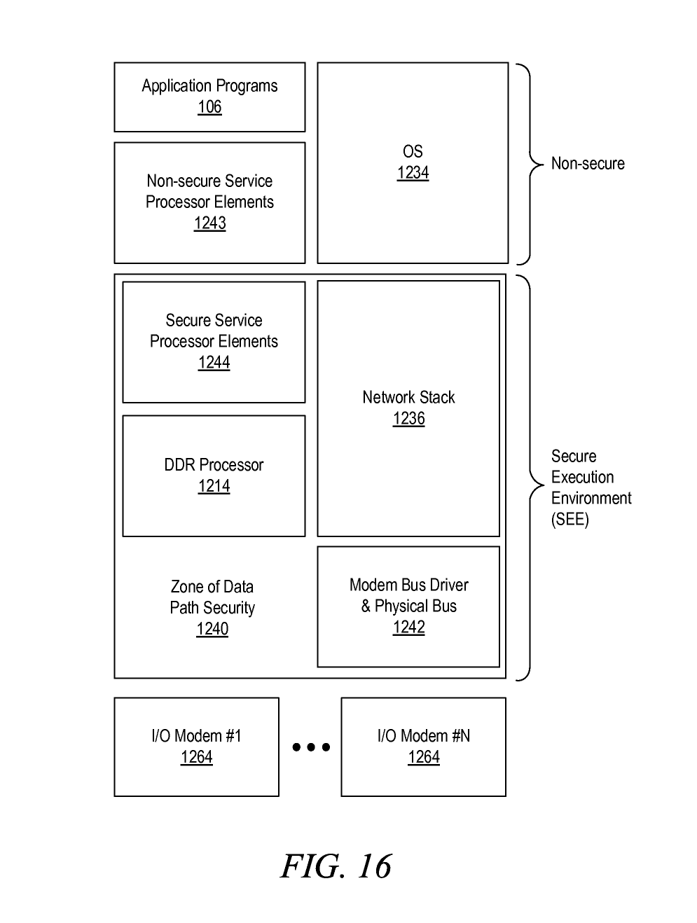

FIG. 16 illustrates an embodiment in which the secure execution environment (referred to in FIG. 16 as zone of data path security 1240 or SEE) includes secure service processor elements 1244. FIG. 16 illustrates a number of I/O modems 1264 for various device I/O ports numbered #1 through #N (e.g., possibly including but not limited to 2G, 3G, 4G, Wi-Fi, Ethernet, USB, FireWire, Bluetooth, and NFC). Modem bus driver and physical layer bus 1242 are located in the secure execution environment (zone of data path security 1240), and thus the secure execution environment protects secure service processor elements 1244 and the data path between secure service processor elements 1244 and the device I/O ports. In some embodiments, secure service processor elements 1244 include the portions of the service processor that are desired to be protected from malware or unauthorized user tampering or configuration changes, including but not limited to the secure service processor elements responsible for policy enforcement, I/O port communication activity monitoring and reporting, I/O port communication control or traffic control, application activity monitoring, application control, application access control or traffic control, network destination monitoring and reporting, network destination access control or traffic control, and device environment monitoring and integrity verification. Network stack 1236 is also shown in FIG. 16 in the secure execution environment, but in general not all of the network stack functions need to be implemented in the secure execution environment, provided that the data path below the monitoring point in secure service processor elements 1244 and I/O modems 1264 is secured (e.g., unauthorized data path access is not available or allowed). In the embodiment shown in FIG. 16, secure service processor elements 1244 interact with network stack 1236 to implement the various I/O port activity monitoring and control functions described herein. Non-secure service processor elements 1243 are also included but not limited to user interface elements.

In some embodiments, secure service processor elements 1244 (for example one or more of functions, modules, objects, libraries, shims, hooks, bootstrappers, etc.) are implemented within a secure execution environment (zone of data path security 1240) or alternatively stored at least in part in one or more of secure execution memory or secure RAM or secure non-volatile memory or secure memory partition). The various embodiments described in relation to FIGS. 3, 4, 5, 6, 7, 8, 9, 10 and 11 and the associated disclosures facilitate implementation of secure service processor elements 1244 by simply replacing (or in addition to) the DDR processor 1214 by the secure service processor elements and adapting the embodiment descriptions, as would be understood by one of ordinary skill in the art. This allows sophisticated device wide area network access control or charging functions, as described in the context of the various secure service processor element embodiments, to be implemented and/or controlled on a device and/or the network (for example operator, MVNO, VSP, etc.). In some embodiments, one or more service processor elements 1244 (for example one or more of service processor application, service processor kernel, service processor DDR, service processor secure elements, service processor element with partial security properties, service processor will a subset of security properties) is distributed by a network operator (or MVNO, third-party partner, etc.).

In some embodiments, the DDR processor 1214 (or alternatively service processor DDR) is included (or partially included) within secure service processor elements 1244. In some embodiments, the DDR processor functionality is not part of the service processor 115. In some embodiments, the DDR processor 1214 is not part of the DAS client. In some embodiments, the DDR processor is not available at the device 100, but one or more other service processor 115 features/functions are available to provide DAS.

In some embodiments, non-secure service processor elements 1243 (or alternatively differently-secured service processor elements), including for example, one or more of functions, modules, objects, applications, libraries, shims, hooks, bootstrappers, etc. are implemented within a second secure execution environment (or alternatively stored at least in part in one or more of secure execution memory or secure RAM or secure non-volatile memory or secure memory partition). The various embodiments described in relation to FIGS. 3, 4, 5, 6, 7, 8, 9, 10 and 11 and the associated disclosures facilitate implementation of differently secure service processor elements 1243 by simply replacing (or in addition to) the DDR processor 1214 by the secure service processor elements and adapting the embodiment descriptions, as would be understood by one of ordinary skill in the art. This allows sophisticated device wide area network access control or charging functions, as described in the context of the various secure service processor element embodiments, to be implemented and/or controlled on a device and/or the network (for example operator, MVNO, VSP, etc.). In some embodiments, one or more service processor elements 1243 (for example one or more of service processor application, service processor service, service processor activity, service processor kernel, service processor DDR, service processor secure elements, service processor element with partial security properties, service processor will a subset of security properties) is distributed by a network operator (or MVNO, third-party partner, etc.).

The various embodiments described in relation to FIGS. 9, 10 and 11 and the associated disclosures facilitate implementation of secure service processor elements 1244 on a device by simply replacing (or in addition to) the DDR processor 1214 by the secure service processor elements and adapting the embodiment descriptions, as would be understood by one of ordinary skill in the art. This allows sophisticated device wide area network access control or charging functions, as described in the context of the various secure service processor element embodiments, to be implemented and or controlled on a device and/or the network (for example operator, MVNO, VSP, etc.). In some embodiments, one or more service processor elements (for example one or more of service processor application, service processor kernel, service processor DDR, service processor secure elements, service processor element with partial security properties, service processor will a subset of security properties) is distributed by a network operator (or MVNO, third-party partner, etc.).

In some embodiments, using secure execution environment partitioning technology, large portions or the entire service processor functionality are implemented in hardware secured execution environments in the APU or MPU. In some embodiments, using secure CPU partitioning technology, large portions or the entire Service Processor functionality are implemented in hardware secured execution environments in the APU or MPU. As an example embodiment, service processor functions that can be executed within a secure execution environment include policy enforcement actions in accordance with a set of policy instructions stored in the secure execution environment such as: managing policy for one or more of 2G, 3G or 4G network (and/or other I/O ports such as Ethernet, Wi-Fi, USB, FireWire, Bluetooth, or NFC), wherein the policy management can include application access management, application traffic processing, application access monitoring and reporting, or application access service accounting and reporting. As another example embodiment, secure service processor element functions that can be executed within a secure execution environment include managing policy for one or more applications wherein the policy specifies whether to block, allow, or throttle the applications in accordance with a set of policy instructions stored in the secure execution environment. As another example embodiment, secure service processor element functions that can be executed within a secure execution environment include managing policy for one or more applications wherein the policy includes application activity monitoring and reporting or operating environment monitoring and reporting (e.g., monitoring the security status or presence of malware in the device operating environment). As another example embodiment, secure service processor element functions that can be executed within a secure execution environment include managing policy for one or more network destinations or resources that can include websites, domains, URLs, IP and/or TCP addresses, server names, other devices, or content sources, wherein the policy includes access management, traffic control, access monitoring or access service accounting. As another example embodiment, secure service processor element functions that can be executed within a secure execution environment include managing policy for one or more roaming access networks. As another example embodiment, secure service processor element functions that can be executed within a secure execution environment include monitoring and reporting communication activity on one or more device I/O connections including one or more of a 2G, 3G, 4G and/or other I/O port. In some embodiments, secure service processor element functions that can be executed within a secure execution environment include monitoring, classifying (e.g., identifying application and/or network destination and/or data content type associated with the I/O port activity) and reporting communication activity on one or more device I/O connections, including one or more of a 2G, 3G, 4G and/or other I/O port. In some embodiments, a service controller located in the network provides the set of policy instructions stored in the secure execution environment by communicating them to the secure service processor element via a secure communication link as described herein. In some embodiments, these policy enforcement actions involving reporting can include sending the reports to a service controller located in the network via a secure communication link into the secure execution environment as described herein for further processing of the reports. In some embodiments, sending the reports to a service controller located in the network via a secure communication link into the secure execution environment can include the authenticated secure sequencing and receipt protocols described herein.

As another example embodiment, secure service processor element functions that can be executed within a secure execution environment can include one or more of: (i) a secure application manager that identifies traffic associated with a specific application or group of applications to differentially manage one or more of 2G, 3G and 4G application access policies (e.g., allow, block, throttle, defer for later transmission, apply a given QoS level) or service usage accounting (and/or accounting for application access by one or more other I/O ports, such as Ethernet, Wi-Fi, USB, FireWire, Bluetooth, or NFC), (ii) a secure application manager that identifies when an application is attempting to run (or launch) and determines whether to permit the application to run (or launch) or to not allow the application to run (or launch) based on a set of application policies, (iii) a secure application manager that differentially manages 3G and 4G application access (and/or application access or service usage accounting for one or more other I/O ports) according to network access policy set by the service controller and network busy state determined on the device, and (iv) 3G and 4G network traffic that is classified and processed according to application identifier, layer 7 destination as well as layer 3/4 destination and network busy state. In some embodiments, securing such service processor functions can be augmented by: (i) configuring the secure execution environment with the various operating environment techniques disclosed herein so that the service processor achieves a similar degree of protection from hacking and malware described for lower levels of stack processing (e.g., the DDR processor SEE embodiments described herein), (ii) protecting or securing the data path between the DDR Processor (e.g., and/or elements of the service processor) and the modem antenna connection from circumvention or tampering by device malware, and (iii) providing sufficient secure or protected memory and sufficient secure execution environment CPU cycles to execute the more sophisticated data path processing functions.

In some embodiments, a secure communication between a network-based service controller and a device-based secure service processor element operating in a secure execution environment on a device connected to a wide area access network is used for secure (or trusted) delivery of secure service processor element I/O activity monitor records for one or more I/O ports (e.g., an I/O port including but not limited to 2G, 3G, 4G, Ethernet, Wi-Fi, USB, FireWire, Bluetooth, or NFC), wherein the secure communication includes a secure message receipt feedback loop. In some embodiments, if the secure message feedback loop is interrupted, a secure service processor element secure communication channel error condition is detected and acted on. In some embodiments, an ordered sequence of secure service processor element I/O activity reports is communicated to a service controller using a signed or encrypted communication channel, and if the ordered sequence is interrupted or tampered with, a device secure service processor element secure communication channel error condition is detected and acted on. In some embodiments, the service controller observes the integrity of the ordered sequence of secure service processor element I/O activity reports to determine if device data records have been tampered with or omitted. In some embodiments, if the secure service processor element determines that the I/O activity monitor records have not been tampered with or omitted, the service controller sends back a signed or encrypted I/O activity monitor record receipt message. In some embodiments, if the secure service processor element determines that an I/O activity monitor record has been tampered with or omitted, the service controller sends back an error message or does not send back a signed or encrypted I/O activity monitor record receipt message. In some embodiments, if the secure service processor element receives an error message from the service controller, or does not receive a signed or encrypted I/O activity monitor record receipt message within a certain period of time or within a certain number of transmitted I/O activity monitor records or within a certain amount of communication information processed, then (i) a device configuration error message is generated for delivery to a security administrator or server, and/or (ii) one or more of the wireless network connections or other I/O connections or ports of the wireless communication device are either blocked or restricted to a pre-determined set of safe destinations. In this manner, if a device secure service processor element, the device operating environment, device operating system, or device software is tampered with in a manner that produces wireless network or other I/O port access service usage characteristics that are not compliant with expected policy or allowed policy, a device configuration error message can be generated, or device wireless network access or other I/O connection accesses can be restricted or blocked. Such embodiments can be helpful in securing device-based network access (or I/O control) policies and can also be helpful in identifying device software that has been tampered with or any malware that is present on the device. In some embodiments, the restriction on wireless network accesses or other I/O accesses results in access to a limited number of network destinations or resources sufficient to allow further analysis or troubleshooting of the device configuration error condition.

In some embodiments, the secure service processor element executing within a secure execution environment and communicating with a service controller via a secure communication link that includes a secure message receipt feedback loop observes device application and/or I/O port activity and generates one or more of the following device activity reports: service usage reports, service usage reports including service usage classification, application service usage reports, network destination service usage reports, service usage reports including network type identifiers, service usage reports including location identifiers, application access monitoring reports, application access service accounting reports, application activity monitoring reports, device operating environment monitoring reports.

In some embodiments, the secure service processor element executing within a secure execution environment and communicating with a service controller via a secure communication link that includes a secure message receipt feedback loop observes device application and/or I/O port activity and generates a roaming network service usage report.

In some embodiments, the service controller observes the secure service processor element I/O activity records to determine if the device is in compliance with a service controller policy condition. In some embodiments, determining whether the device is in compliance with the service controller policy condition comprises verifying that the device secure service processor element is properly implementing a device policy. In some embodiments, the device policy being verified is a network access service policy enforcement set. In some embodiments, the device policy that is verified is a network access service policy enforcement set comprising a network access service plan policy enforcement set, including a set of policies for one or more of network access control or traffic control, network application control, network destination control, network charging or accounting, and network service usage notification. In some embodiments, the device policy that is verified is whether or not the device application activity is in accordance with a set of pre-determined policies (e.g., determining if the applications that are accessing the network or other I/O ports are all allowed applications, or determining if the applications accessing the network or other I/O ports are behaving according to expected policy behavior). In some embodiments, the device policy verification includes whether the device is accessing approved or unapproved networks. In some embodiments, the device policy verification includes whether the device is communicating specified content via one or more allowed wireless connections or other I/O ports, or is communicating specified content over one or more wireless networks or I/O ports that are not allowed. In some embodiments, the device policy verification includes whether the device is communicating specified content via an allowed secure link over one or more wireless connections or other I/O ports, or is communicating specified content over an insecure link. In some embodiments, the device policy verification includes whether the device is communicating from an allowed location or from a location that is not allowed. In some embodiments, the device policy verification includes whether or not the device operating environment monitoring reports indicate that the device operating environment is free of any malicious software or erroneous operating conditions.

In some embodiments, secure service processor elements 1244 are implemented within a secure execution environment (zone of data path security 1240) that is located on a SIM card. The various embodiments described in relation to FIGS. 9, 10 and 11 and the associated disclosures facilitate implementation of secure service processor elements 1244 on a SIM card by simply replacing DDR processor 1214 by the secure service processor elements and adapting the embodiment descriptions, as would be understood by one of ordinary skill in the art. This allows sophisticated device wide area network access control or charging functions, as described in the context of the various secure service processor element embodiments, to be implemented on a SIM card that can controlled and distributed by a network operator. Additional embodiments are now provided for various aspects of DDR Processor functional operations.

DDR Firmware Installation, Security Credential Configuration, and Update

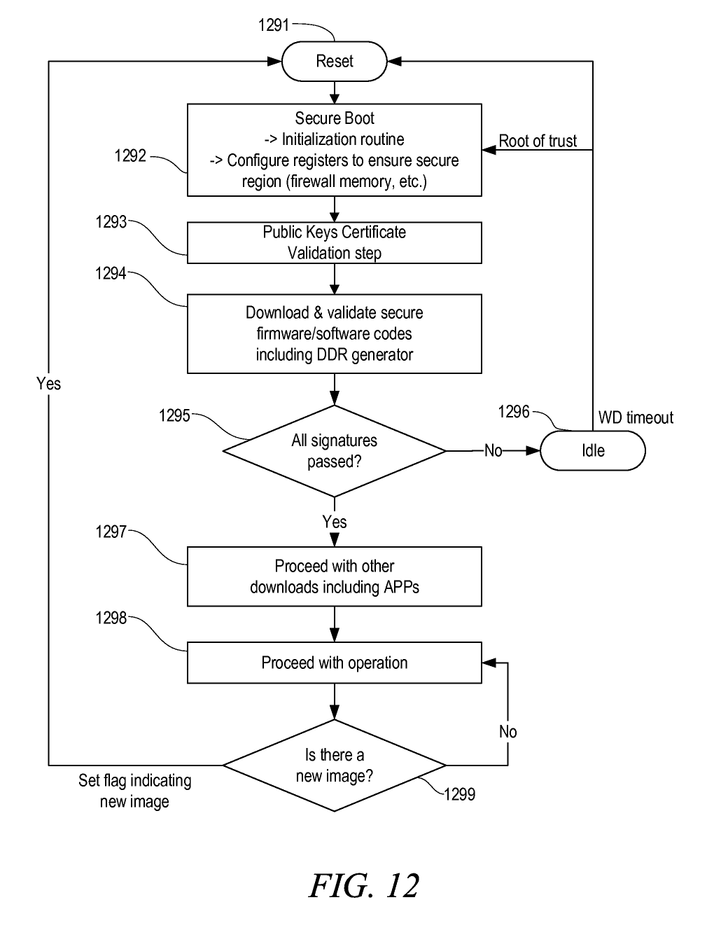

FIG. 12 illustrates a secure boot sequence flow diagram in accordance with some embodiments. In some embodiments, upon a reset and/or power up at 1291, the system (e.g., APU, SIM, and/or MPU, whichever the DDR is embedded on in the wireless communication device) starts by executing a secure boot (e.g., executing secure boot code) at 1292. As part of the secure boot, an initialization routine is performed to configure system parameters (e.g., configures registers to ensure secure region, such as HW/firmware firewall memory) to establish the secure/normal region boundary and interfaces. The secure boot code also has access to the root of trust, which is hidden to all other firmware/software. At 1293, a public keys certificate validation step is performed in which the secure boot downloads and verifies its own public key (e.g., using a hashing technique) and then downloads public keys of all secure codes at 1293. At 1294, the secure boot proceeds to download and verify/validate digital signatures of every secure software package (e.g., including the DDR Processor including a DDR generator) before allowing normal software routines to be downloaded. For example, this can be performed using a chain of trust built on the root of trust. At 1295, the secure boot determines if all signatures are properly validated. If any digital signature fails, then the secure boot stays looped in the idle state as shown at 1296 until it gets reset as shown at 1291 (e.g., watch dog timer expires) and/or the platform is flashed with a new image. If all of the digital signatures are properly validated, then the secure boot proceeds with other downloads (e.g., including applications) at 1297. Normal operation proceeds and the secure boot is completed at 1298. At 1299, whether there is a new image is determined. If not, then normal operation continues at 1298. When new secure software image is downloaded (e.g., the image is stored in new area of the flash memory with a “secure” flag set), and the system can return to reset state to have the secure boot reading the new image (e.g., based on the flag) and validate the digital signature of the image before it becomes the current image.

Mailbox Communication Channel Between the Service Processor and DDR Processor

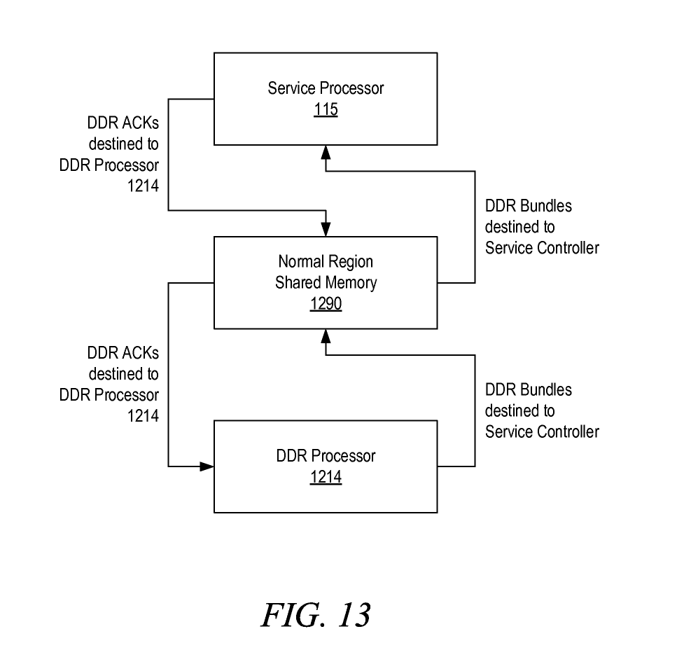

FIG. 13 illustrates a functional diagram for passing DDR Service Processor mailbox messages between secure and unsecure memory regions in accordance with some embodiments. In some embodiments, a logical communication channel between the DDR Processor 1214 and the Service Processor 115 is provided in order to send secure DDR messages (e.g., DDR message bundles) to the Service Controller (e.g., via the Service Processor's communication agent). In some embodiments, this logical communication channel is referred to in various embodiments described herein as the DDR Mailbox Data functional element/block. For example, for ease of implementation, it can be assumed that the DDR processor does not have an IP address of its own hence can only send its message to the Service Controller through the Service Processor using this logical channel. The logical channel can be based on shared memory (e.g., normal region) architecture, shown as normal region shared memory 1290. As described herein with respect to various embodiments, the DDR messages are encrypted and can only be decrypted by the Service Controller. This logical channel can also be used for Service Controller to send down new DDR software updates.

In some embodiments, in which the DDR Processor is located in the APU, then the shared memory can be accessed via both Service Processor and DDR Processor using the APU's direct memory access (DMA) engines.

In some embodiments, in which the DDR Processor is located in the MPU, then a modem interface is provided to support an additional logical channel (e.g., USB endpoint for 2G/3G/4G) to satisfy this requirement. In some embodiments, the logical channel is piggybacked on top of an existing configuration and status channel that provides the control channel between the APU and the MPU.

DDR Processor Record Generator

In some embodiments, a DDR report spans a measurement period. Measurement periods are generally contiguous, meaning the next period begins immediately after the current period ends, with no traffic falling between periods. At the start of a period, all prior DDRs are deleted. During the period, the table of DDRs grows, since each observed IP flow creates an entry in the table. The period ends when either DDR storage exceeds a predefined threshold, or when a DDR report is requested by the Service Processor. DDR data not yet sent to the Service Processor application remains in memory across power cycles and battery pulls.

In some embodiments, at the end of the measurement period, the DDR report is prepared by the DDR Processor and sent to the Service Processor. For example, various secure communication and/or crypto techniques can be used to ensure that the contents of the report are kept private, and to ensure that any tampering with the DDR report will be detected by the Service Controller.

In some embodiments, the report also includes time stamps that identify the start and end of the measurement period. Timestamps are calibrated and confirmed via a periodic handshake with the Service Controller to ensure that the DDR Processor time base has not been altered. Data compression is used to minimize the size of the report.

In some embodiments, each DDR report message includes a unique sequence identifier that allows the Service Controller to determine if any DDRs have been blocked from the sequence. The report is stored by the Service Processor for subsequent forwarding to the Service Controller. Data stored by the Service Processor remains in memory across power cycles and battery pulls.

In some embodiments, the DDR processor resides in the modem where the secure DDR usage report is then sent to the Service Processor (e.g., communication agent within the Service Processor) to be sent to the Service Controller.

DDR Processor Access Controller

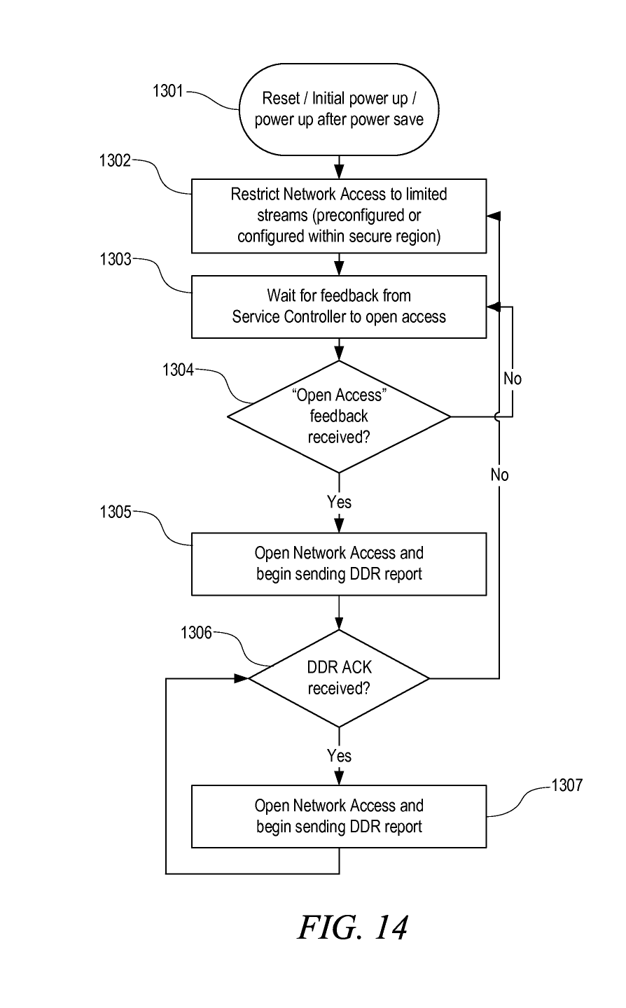

FIG. 14 illustrates a flow diagram for a DDR Processor Service Controller session authentication and verification in accordance with some embodiments. In some embodiments, the DDR Processor includes an access controller function (e.g., Access Controller). In some embodiments, upon reset and/or powering up a DDR Processor access control function, such as the Access Controller, restricts network access (e.g., to only a few pre-configured IP addresses and/or host names including certain carrier/wireless service provider services).

In some embodiments, the Access Controller ensures that the Service Processor correctly delivers DDRs to the Service Controller. If the DDR flow is blocked or tampered with, then the Access Controller blocks cellular (e.g., or managed Wi-Fi) wireless network access until the proper flow of DDRs is restored. In some embodiments, the network access restriction is only applied to networks that have network access services maintained and managed by the network operator. For example, this function can disabled for Wi-Fi access that is not managed by the network operator.

In some embodiments, once a modem is authenticated (e.g., via a PPP session) via AAA, either after initial power up and/or after restoring from power save, the Access Controller restricts limited network access (e.g., based on set of IP addresses/host names and/or other criteria) until it gets feedback from the Service Controller to allow open access. Also, while traffic is running and the DDR Processor sending DDR records/reports, it continually expects to receive secure DDR ACK frames to allow open access, otherwise it enters a restrict access state again.

Referring now to FIG. 14, at reset and/or initial power up or power up after a power save mode, the process begins, as shown at 1301. At 1302, the Access Controller restricts network access to limited streams (e.g., preconfigured or configured within the secure region. At 1303, the Access Controller waits for feedback from the Service Controller to open network access. At 1304, whether the feedback is received from the Service Controller is determined. If not, then the process returns to 1303 to continue to wait for feedback from the Service Controller. If the feedback is received (e.g., and the secured Service Controller feedback is properly verified and/or validated, as described herein), then the Access Controller opens network access and DDR reports begin to be sent at 1305. At 1306, whether a DDR ACK frame is received in response to such DDR report(s) is determined. If not, then the process returns to 1302 and network access is restricted. If the DDR ACK frame is received (e.g., and the secured DDR ACK frame is properly verified and/or validated, as described herein), then the Access Controller continues to maintain open network access and to send DDR reports at 1307.

DDR Processor Network Busy State (NBS) Monitor

In some embodiments, the Network Busy State (NBS) Monitor is a secure firmware program element in the DDR Processor that monitors, records, and/or securely reports information on network busy state (e.g., or network congestion state) to the Service Controller for storage, network congestion analysis, and/or service charging and control policy security purposes. For example, the NBS Monitor can perform one or more of the following functions within the SEE: log active network information (e.g., active network type, home/roaming, current carrier, base station, and/or base station sector); monitor network access attempts and successes; monitor network speed; monitors round trip delay; monitor packet error rate; monitor modem performance parameters (e.g., RF channel, RF signal strength and variability, SNR, raw modem bit rate, raw modem bit error rate, and/or channel bandwidth); implements algorithm to classify busy state of network; and report network busy state history within DDRs.

Binding and Securing the Secure Communication Channel Between the DDR Processor and the Service Controller

In some embodiments, binding and securing the secure communication channel between the DDR Processor and the Service Controller is provided as described below. The DDR Processor has a unique private/public key pair and a digital certificate (cert) that attests to the authenticity of its public key. The Service Controller has a unique private/public key pair. Its public key is well known and included in the DDR Processor code image. The DDR Processor sends its public key and cert to the Service Controller, and the two execute a key exchange process that authenticates each other and results in a secret, shared session key. The DDR Processor uses the session key to encrypt DDR reports it sends to the Service Controller and to append an integrity check to messages it sends to the Service Controller. The Service Controller uses the session key to append an integrity check to messages it sends to the DDR Processor.

As will now be apparent to one of ordinary skill in the art in view of the various embodiments described herein, various other secure communication and crypto techniques can be used to provide for binding and securing the secure communication between the DDR Processor and the Service Controller.

Binding and Securing the Secure Communication Channel Between the DDR Processor and the DPSV in an APU/MPU Implementation

In some embodiments, binding and securing the secure communication channel between the DDR Processor and the DPSV in an APU/MPU implementation is provided as described below. The DPSV has a unique private/public key pair and a digital certificate (cert) that attests to the authenticity of its public key. The DDR processor has a unique private/public key pair and a digital certificate (cert) that attests to the authenticity of its public key. The DPSV and the DDR Processor exchange public keys and certs, then execute a key exchange process that authenticates each other and results in a secret, shared session key. The DDR Processor receives upstream network data flows from the device OS networking stack and, using the session key, it appends an integrity check to each upstream data message that it sends to the DPSV. The DPSV blocks any upstream data path information that does not have a valid integrity check from the DDR Processor and informs the DDR Processor that it is receiving invalid upstream data so that the DDR Processor may inform the Service Controller of a possible fraud event. The DPSV receives downstream network data flows and, using the session key, it appends an integrity check to each downstream data message that it sends to the DDR Processor. Each downstream data message is sequenced so that data messages cannot be blocked or replayed without being detected by the DDR Processor. If the DDR Processor receives a downstream data message with an invalid integrity check, the DDR Processor rejects the message and informs the Service Controller of a possible fraud event. The DDR Processor acknowledges each non-rejected downstream data message in the next upstream data message it sends to the DPSV. If the DPSV stops receiving downstream data message acknowledgements, it blocks downstream network data flows and informs the DDR Processor so that the DDR Processor may inform the Service Controller of a possible fraud event. The DDR Processor securely sends DDR reports to the Service Controller by way of the Service Processor as described herein. The DDRs transmitted from the DDR Processor to the Service Controller are integrity checked and sequenced in a manner that cannot be tampered with or replayed. An authentication process between the DDR Processor and the Service Controller combined with a set of unique DDR report sequence identifiers and authentication session keep alive timers are used to maintain and confirm the secure connection between the DDR Processor and the Service Controller. If the secure session or the flow of DDR records between the DDR Processor and the Service Controller are interrupted, then the Access Controller function in the DDR Processor restricts access of the 2G, 3G, or 4G modem data path to the network destinations necessary to reestablish a securely authenticated session with between the DDR and the Service Controller.

As will now be apparent to one of ordinary skill in the art in view of the various embodiments described herein, various other secure communication and crypto techniques can be used to provide for binding and securing the secure communication channel between the DDR Processor and the DPSV in an APU/MPU implementation.

Security Requirements for OEM Programming of DDR Processor

In some embodiments, code signing for the DDR Processor is provided. In particular, the DDR Processor code image is digitally signed by the device OEM. The signature is verified by the Secure Boot Loader using a fixed public key embedded within the Secure Boot Loader code image. This imposes the security requirement that the OEM operate a secure code-signing facility that preserves the secrecy of the fixed signing key. The OEM ensures that only authorized personnel are able to access the code-signing facility and that they do so only for legitimate DDR Processor images. In some embodiments the DDR processor image is digitally signed (or in general security verified by a security element) as directed by an entity associated with the service processor (for example 3^{rd} party, service processor owner/designer/implementor, MVNO, or MVNE).

In some embodiments, a random seed for the DDR device private key is provided. In particular, at the time of device manufacture, a private/public key pair called the DDR Device Key is assigned. The DDR Device Key is unique to each device and is used to establish a secure communications link to the Service Controller. For example, the DDR Device Key can be a Diffie-Hellman key pair with a 1024-bit modulus, 1024-bit base, and a 128-bit private exponent. The private exponent of the DDR Device Key (DDR Device Private Key) is unique to each device and stored in, for example, 128 bits of on-chip nonvolatile memory (e.g., OTP memory) in the SEE. The modulus and base are common to all devices and are embedded within the DDR Processor image. The public portion of the DDR Device Key (e.g., DDR Device Public Key) is not permanently stored; instead, it is calculated by the DDR Processor using the modulus, base, and private exponent. The DDR Processor includes a factory initialization routine that is executed while the device is being initialized and tested at the factory. The factory initialization routine generates the DDR Device Private Key and programs it into the nonvolatile memory of the SEE. The DDR Device Private Key never leaves the device and is accessible only to the DDR Processor. The factory initialization routine computes the DDR Device Public Key and exports it to the factory tester. For example, the factory tester can provide a 128-bit random string to be used by the factory initialization routine as a seed to generate the DDR Device Private Key. This requires that the factory tester include or have access to a high-quality random bit source. Various suitable methods can be used, such as FIPS 140-2 (“deterministic random number generators”) seeded with the output of a hardware random source. In some embodiments, at the time of device manufacture, a digital certificate called the DDR Device Cert is assigned to the device. The DDR Device Cert is unique to each device and is used to establish a secure communications link to the Service Controller. The contents of the DDR Device Cert include the DDR Device Public Key. The DDR Device Cert is signed by the issuing certificate authority, and the signature is verified by the Service Controller when establishing a secure link. The DDR Device Cert is not sensitive information and, for example, can be stored in either on-chip or off-chip nonvolatile memory. The OEM issues a DDR Device Cert for the DDR Device Public Key exported by the factory initialization routine, which imposes the security requirement that the OEM operates, or has access to, a certificate authority (CA). If the OEM chooses to access an outsourced CA, then the OEM's primary obligation is to ensure that only authorized personnel are able to request certificates, and that they do so only for devices that have DDR Device Public Keys legitimately exported by the FI routine. If the OEM chooses to operate a CA, the OEM has the additional obligation of maintaining the security of the CA, specifically, preserving the secrecy of the CA's fixed key that signs certificates.

The embodiments for code signing, verification, keys and certificates herein are described in the context of the DDR processor (or alternatively service processor DDR), but the embodiments described may be applied (in addition or alternatively) to one or more of the service processor components (for example one or more of service processor application, service processor kernel, etc.), as would be appreciated by a person having ordinary skill in the art.

As will now be apparent to one of ordinary skill in the art in view of the various embodiments described herein, various other security techniques can be used or required for OEM programming for the DDR Processor (or alternatively one or more of the service processor application, service processor kernel and DDR service processor).

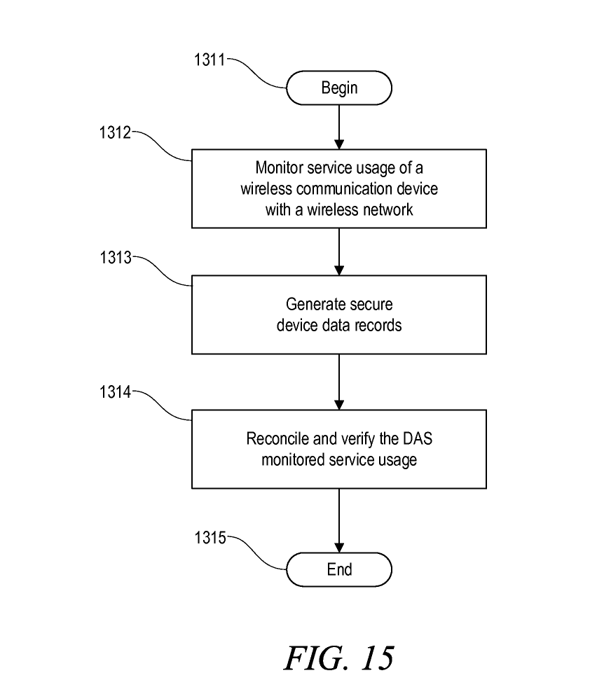

FIG. 15 illustrates a flow diagram for secure device data records for implementing device assisted services (DAS) in accordance with some embodiments. At 1311, the process begins. At 1312, service usage of a wireless communication device with a wireless network is monitored (e.g., using DAS client based monitoring techniques, such as including the various techniques described herein for implementing secure DDRs). At 1313, secure device data records of the monitored service usage of the wireless communication device with the wireless network are generated. In some embodiments, each device data record is one of an ordered sequence of device data records with each sequential device data record providing an accounting of service usage over a service usage interval spanned by the device data record, and each device data record is associated with a secured unique sequence order identifier. At 1314, the device data records (DDRs) are reconciled and verified using the various reconciliation and verification techniques described herein. For example, the DDRs can be verified using the unique sequence order identifier (e.g., and various other integrity checking based techniques, as described herein with respect to various embodiments). As another example, the DDRs can be reconciled with other service usage reports by comparison with service processor reports (e.g., layer-7 classification reports) and/or by comparison with network based service usage reports (e.g., network flow records, such as CDRs or IPDRs), as described herein with respect to various embodiments. At 1315, the process ends (e.g., and can repeat for continued service usage monitoring).

Exemplary Service Policy Verification Combinations

In some embodiments, a communications device comprises: one or more communication I/O ports, at least one of which is a wide area network connection port; storage for storing a device communication activity policy; a secure execution environment that is not accessible by user application software; a one or more secure data path processing agents configured to: execute in the secure environment, monitor device data communications activity on one or more device I/O ports, generate a device data record that summarizes an aspect of the device communications activity that provides information suitable for verifying that a device policy enforcement client is properly implementing the device communication activity policy, and communicate the device data record via a trusted communication link over the wide area network connection port to a network element; and a trusted data path between the one or more secure data path processing agents and the one or more I/O ports that cannot be accessed by device user application software. In some embodiments, the data path is trusted because tampering with or alterations to data on the data path are detectable. In some embodiments, intermediate elements on the data path cannot alter or tamper with the data without detection. In some embodiments, the data path is trusted because data sent over it is signed. In some embodiments, the trusted data path between the one or more secure data path processing agents and the one or more I/O ports is further configured to secure communications by encryption.

In some such embodiments, the trusted communication link includes a secure message receipt feedback loop.

In some embodiments, the one or more secure data path processing agents are further configured to restrict the access of one or more device I/O ports, and if the secure message receipt feedback loop indicates an error, then the one or more secure data path processing agents restricts access of one or more device I/O ports. In some embodiments, the restriction of access for one or more device I/O ports allows communication to a network element configured to provide the device with error handling service when a secure message receipt feedback loop error condition exists.

In some embodiments, the communications device receives the device communication activity policy from a network element. In some embodiments, the device communication activity policy comprises an application activity monitoring policy. In some embodiments, the device communication activity policy comprises a network destination, address or resource monitoring policy.

In some embodiments, the information suitable for verifying that the device policy enforcement client is properly implementing the device communication activity policy comprises communication activity records for one or more device I/O ports.

In some embodiments, the secure execution environment and the one or more secure data path processing agents are located in a secure execution partition controlled by an application processor. In some embodiments, the secure execution environment and the one or more secure data path processing agents are located in a secure execution partition controlled by an operating system or secure partitioning software. In some embodiments, the secure execution environment and the one or more secure data path processing agents are located in a secure execution partition controlled by a modem processor. In some embodiments, the secure execution environment and the one or more secure data path processing agents are located on a SIM card.

In some embodiments, the wide area network is a wireless network, and the information suitable for verifying that the device policy enforcement client is properly implementing the device communication activity policy comprises device wireless network service usage records.

In some embodiments, the wide area network is a wireless network, and the device communication activity policy comprises a network access control policy for the wireless network. In some such embodiments, the wireless network access control policy is a set of one or more control policies for one or more applications (for example providing text, SMS, voice, data services or communication activities) operating on the device. In some embodiments, the wireless network access control policy is set of one or more specific access control policies for one or more network destinations, addresses or resources accessible over the wireless network. In some embodiments, the wireless network is a roaming network, and the network access control policy defines policies that are specific to a device roaming network connection condition and different than a home network connection condition. In some embodiments, different roaming networks have different network access control policies.

In some embodiments, the wide area network is a wireless network and the device communication activity policy comprises a network access service usage accounting policy for the wireless network. In some such embodiments, the network access service usage accounting policy is a set of one or more service usage accounting policies for one or more applications operating on the device. In some embodiments, the network access service usage accounting policy is a set of one or more service usage accounting policies for one or more network destinations, addresses or resources accessible over the wireless network. In some embodiments, the wireless network is a roaming network, and the network access service usage accounting policy defines service usage accounting policies that are specific to a device roaming network connection (e.g., or a specific roaming network connection) condition and different than a home network connection condition. In some such embodiments, the device communication activity policy further comprises requesting an access network service cost acknowledgement or payment indication from a device user and restricting device roaming network access privileges if the user does not provide a service cost acknowledgement or payment indication.

In some embodiments, a network system comprises: memory configured to store a device communication activity policy; a trusted communication link over a wide area network to a one or more secure data path processing agents; a communication link over the wide area network to a device policy enforcement client; and a policy verification processor configured to (i) store the device data records, (ii) receive device data records from a communications device over the trusted communication link, the device data records containing information that summarizes an aspect of the device communications activity that provides information suitable for verifying that the device policy enforcement client is properly implementing the device communication activity policy, (iii) analyze the information contained in the device data record to determine if the device policy enforcement client is properly implementing the device communication activity policy, and (iv) take an error handling action if the analysis indicates that the device policy enforcement client is not properly implementing the device communication activity policy.

In some such embodiments, the trusted communication link includes a secure message receipt feedback loop. In some embodiments, the network system further comprises an error handling processor that detects when an error condition exists with the secure message receipt feedback loop, flags the error condition to an administrator or error tracking system, and communicates with the device to analyze the error or provide error messages to a device user.

In some embodiments, the network system communicates the device communication activity policy to the device. In some embodiments, the device communication activity policy comprises an application activity monitoring policy. In some embodiments, the device communication activity policy comprises a network destination, address or resource monitoring policy.

In some embodiments, the information suitable for verifying that the device policy enforcement client is properly implementing the device communication activity policy comprises communication activity records for one or more device I/O ports.

In some embodiments, the wide area network is a wireless network, and the information suitable for verifying that the device policy enforcement client is properly implementing the device communication activity policy comprises device wireless network service usage records.

In some embodiments, the wide area network is a wireless network, and the device communication activity policy comprises a network access control policy for the wireless network. In some such embodiments, the wireless network access control policy is a set of one or more control policies for one or more applications operating on the device. In some embodiments, the wireless network access control policy is a set of one or more specific access control policies for one or more network destinations, addresses or resources accessible over the wireless network. In some embodiments, the wireless network is a roaming network and the network access control policy defines policies that are specific to a device roaming network connection condition and different than a home network connection condition.

In some embodiments, the wide area network is a wireless network, and the device communication activity policy comprises a network access service usage accounting policy for the wireless network. In some such embodiments, the network access service usage accounting policy is a set of one or more service usage accounting policies for one or more applications operating on the device. In some embodiments, the network access service usage accounting policy is a set of one or more service usage accounting policies for one or more network destinations, addresses or resources accessible over the wireless network. In some embodiments, the wireless network is a roaming network and the network access service usage accounting policy defines service usage accounting policies that are specific to a device roaming network connection condition and different than a home network connection condition.

Exemplary Combinations Using a Receipt Feedback Loop

In some embodiments, a communications device comprises: one or more I/O ports, at least one of which is a wide area network connection port; a secure execution environment that cannot be accessed by user application software; a one or more secure data path processing agents configured to: (i) execute in the secure environment, (ii) monitor communication activity for one or more of the I/O ports, (iii) generate a device data record that summarizes an aspect of the device I/O port communication activity, (iv) communicate the device data record via a trusted communication link over the wide area network connection port to a network element, the trusted communication link comprising a secure message receipt feedback loop wherein the one or more secure data path processing agents receives a successful transmission receipt from the network element for data records that are successfully transmitted to and verified by the network element, (v) track transmitted device data records and successful transmission receipts received from the network element, and (vi) if one or more successful transmission receipts are not received for corresponding transmitted device data records within a specified event interval after sending the device data record to the network element over the trusted communication link, then restrict access of one or more device I/O ports; and a secure data path between the one or more secure data path processing agents and the one or more I/O ports that cannot be accessed by device user application software. In some such embodiments, the restriction of access for one or more device I/O ports still allows the communications device to communicate with a network element configured to provide the device with error handling service when a secure message receipt feedback loop error condition exists. In some such embodiments, the specified event interval comprises a period of time, a number of records transmitted, or a number of communications with the network element.

In some embodiments, the secure execution environment and one or more secure data path processing agents are located in a secure execution partition controlled by an application processor. In some embodiments, the secure execution environment and one or more secure data path processing agents are located in a secure execution partition controlled by a modem processor. In some embodiments, the secure execution environment and one or more secure data path processing agents are located on a SIM card.

In some embodiments, the aspect of the device I/O port communication activity that is summarized in the device data record comprises a summary of device application access activity. In some embodiments, the aspect of the device I/O port communication activity that is summarized in the device data record comprises a summary of device network access activity. In some embodiments, the aspect of the device I/O port communication activity that is summarized in the device data record comprises a summary of device content communication activity.

In some embodiments, a network system comprises: a trusted communication link over a wide area network to a one or more secure data path processing agents for the purpose of receiving device data records, the device data records comprising a summary of an aspect of the device I/O port communication activity, the trusted communication link comprising a secure message receipt feedback loop wherein the network based system transmits a successful transmission receipt to the one or more secure data path processing agents for data records that are successfully received by and verified by the network based system; and a storage system to store the device data records. In some embodiments, the network system further comprises an error handling processor that detects when an error condition exists with the secure message receipt feedback loop, and, after detecting an error, flags the error condition to an administrator or error tracking system. In some embodiments, the network system further comprises a system to communicate with the device during an error condition to analyze the error condition or provide error messages to a device user.

In some embodiments, the network system further comprises a device data record analyzer configured to: (i) store a device I/O port communication activity policy comprising allowable device I/O port communication behavior, (ii) compare device data records to the I/O port communication activity policy, and (iii) declare an I/O port activity error condition when the device data records indicate I/O port communication activity that is outside of the behavioral limits specified in the I/O port communication activity policy.

In some embodiments, the aspect of the device I/O port communication activity that is summarized in the device data record comprises a summary of device application access activity. In some embodiments, the aspect of the device I/O port communication activity that is summarized in the device data record comprises a summary of device network access activity. In some embodiments, the aspect of the device I/O port communication activity that is summarized in the device data record comprises a summary of device content communication activity.

Exemplary Combinations Using a SIM Card

In some embodiments, a communications device comprises: one or more communication I/O ports comprising at least a wide area network connection port; storage for storing a device communication activity policy; and a SIM card configured with: (i) a secure execution environment that is not accessible by user application software, (ii) one or more secure data path processing agents configured to execute in the secure execution environment and act on device data path communication to one or more of the I/O ports to enforce the device communication activity policy, and (iii) a trusted data path link for data path communication from the one or more secure data path processing agents to one or more I/O port modems, the one or more I/O port modems comprising a secure modem processor execution environment that is not accessible by user application software. In some embodiments, the one or more secure data path processing agents are further configured with a trusted communication link over the wide area network connection port to a network element.

In some such embodiments, the device communication activity policy is a device I/O port communication reporting policy, and the one or more secure data path processing agents are further configured to: (i) monitor and/or report communication activity conducted on the one or more I/O ports, (ii) create device data records that summarize the communication activity, and (iii) transmit the device data records to the network element over the trusted communication link. In some embodiments, the monitoring and/or reporting of communication activity comprises monitoring data usage. In some embodiments, the monitoring and/or reporting of data usage comprises a classification of the network destinations accessed in association with the data usage. In some embodiments, the monitoring and/or reporting of data usage comprises a classification of the device applications generating the data usage. In some embodiments, monitoring communication activity comprises monitoring roaming service usage. In some embodiments, monitoring communication activity comprises monitoring service usage for one or more QoS classes. In some embodiments, monitoring communication activity comprises monitoring voice usage.

In some embodiments, the service processor is further configured to gather application information from device agents.

In some embodiments, the device communication activity policy is device I/O port communication control policy and the service processor is further configured to: (i) monitor communication activity conducted on the one or more I/O ports, and (ii) enforce I/O port communication policy on the one or more I/O ports.

In some embodiments, the communication control policy specifies a control policy for one or more network destinations. In some embodiments, the communication control policy specifies a control policy for one or more device applications. In some embodiments, the communication control policy specifies a control policy for a roaming network. In some embodiments, the communication control policy specifies a control policy for a QoS service class.

In some embodiments, the trusted data path communication between the one or more secure data path processing agents and the one or more I/O port modems is secured by signing or encrypting with a shared key. In some embodiments, the one or more secure data path processing agents are further configured with a trusted communication link over the wide area network connection port to a network element, and the shared key is acquired from the network element.

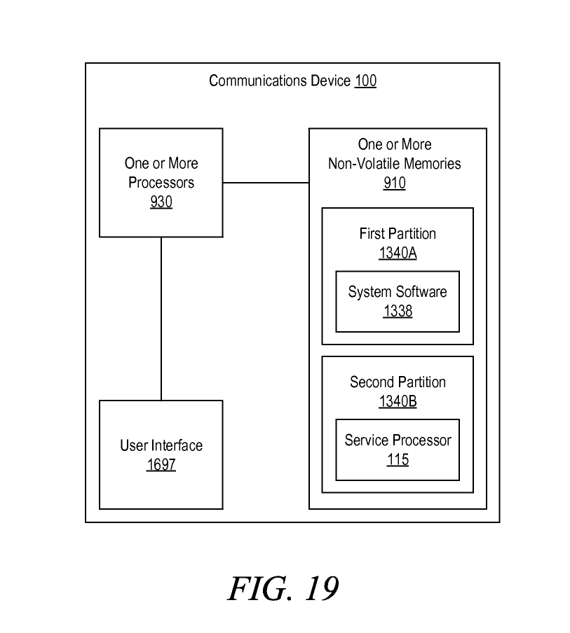

FIG. 19 illustrates a block diagram of a communications device 100 in accordance with some embodiments. One or more processors 930 are communicatively coupled to device user interface 1697 and also to one or more non-volatile memories 910. One or more non-volatile memories 910 comprise at least first partition 1340A and second partition 1340B. First partition 1340A contains at least a portion of system software 1338. Second partition 1340B contains at least a portion of service processor 115. One or more processors 930 are configured to execute one or more machine-executable instructions, which one or more processors 930 obtain from memory on communications device 100 (e.g., from one or more non-volatile memories 910 or from another memory (not shown) on communications device 100).

It is to be appreciated that FIG. 19 illustrates only some elements of communications device 100, and that communications device 100 may also include one or more modems, additional memory, and other components or elements. It is also to be appreciated that one or more non-volatile memories 910 may include more than two partitions (e.g., a third partition, a fourth partition, etc.), and that one or more of the partitions may store more information in addition to or other than system software 1338 and service processor 115. For example, the partitions, or another part of one or more non-volatile memories 910, may store one or more security elements.

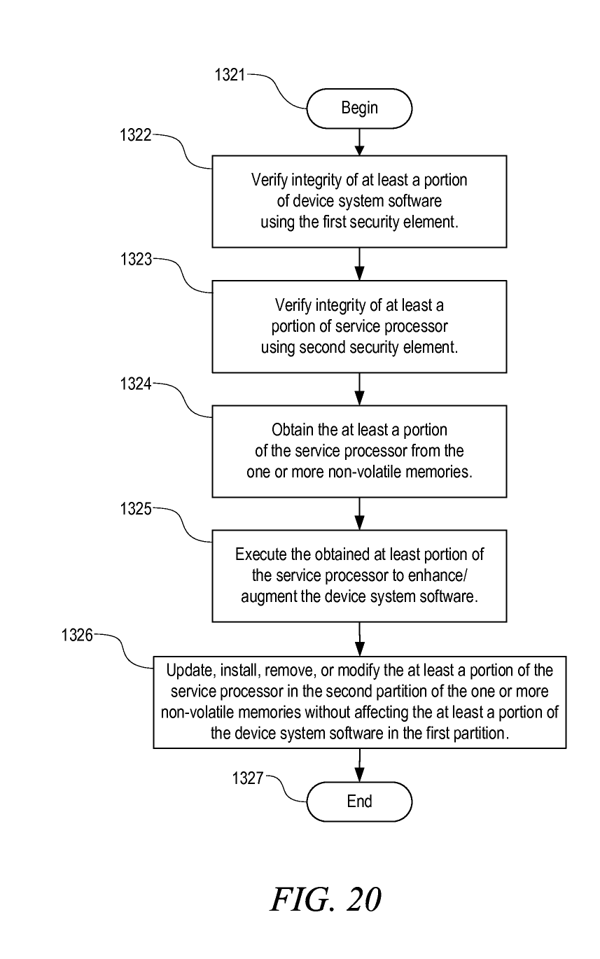

FIG. 20 illustrates operations of one or more processors 930 of communications device 100 in accordance with some embodiments. Flow begins at 1321. At 1322, one or more processors 930 verify the integrity of at least a portion of device system software 1338 using a first security element (not shown). At 1323, one or more processors 930 verify the integrity of at least a portion of service processor 115 using a second security element (not shown). At 1324, one or more processors 930 obtain the at least a portion of service processor 115 from one or more non-volatile memories 910. At 1325, one or more processors 930 execute the obtained at least a portion of service processor 115, thereby enhancing or augmenting device system software 1338. At 1326, one or more processors 930 update, install, remove, or modify the at least a portion of service processor 115 in second partition 1340B of one or more non-volatile memories 910 without affecting system software 1338 stored in first partition 1340A of one or more non-volatile memories 910.

It is to be appreciated that many of the operations illustrated in FIG. 20 can be performed in a different order, except where a particular order is required. For example, the operation at 1323 can be performed before the operation at 1322; the operations at 1324 and 1325 can be performed before or after the operation at 1322; the operations at 1324 and 1325 can be performed before or after the operation at 1323; the operation at 1326 can be performed before or after the operation at 1322, before or after the operation at 1323, before or after the operation at 1324, or before or after the operation at 1325.

It is to be appreciated that the phrase “one or more objects” may mean a single object or a plurality of objects, and that in the case of a plurality of objects, the individual objects within the plurality may be referred to as a first object and a second object. Likewise, a particular object within one or more objects may be referred to as a particular object.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A communications device, comprising:
one or more non-volatile memories capable of being partitioned into at least a first partition and a second partition, the first partition for storing at least a portion of device system software, the at least a portion of device system software being associated with a first security element, the second partition for storing at least a portion of a service processor, the at least a portion of the service processor having one or more system execution properties enabling the at least a portion of the service processor to enhance or augment the device system software, the at least a portion of the service processor being associated with a second security element; and
one or more processors configured to execute one or more instructions that, when executed by the one or more processors, cause the one or more processors to:
verify an integrity of the at least a portion of device system software using the first security element,
verify an integrity of the at least a portion of the service processor using the second security element,
obtain the at least a portion of the service processor from the one or more non-volatile memories,
execute the obtained at least a portion of the service processor, thereby enhancing or augmenting the device system software, and
update, install, remove, or modify the at least a portion of the service processor in the second partition of the one or more non-volatile memories without affecting the at least a portion of the device system software in the first partition.

2. The communications device recited in claim 1, wherein the first security element or the second security element comprises a certificate, a key, a hash, a chained hash, a credential, or a signature.

3. The communications device recited in claim 1, wherein the one or more non-volatile memories are configured to store the first security element or the second security element.

4. The communications device recited in claim 1, wherein the first security element and the second security element are stored in a system file.

5. The communications device recited in claim 1, wherein the first security element and the second security element are managed by or associated with an original equipment manufacturer (OEM), a carrier, a system installation function, a recovery function, or a combination of these.

6. The communications device recited in claim 1, wherein the service processor comprises a kernel or framework component.

7. The communications device recited in claim 1, wherein a service processor component is associated with a system user identifier (ID), a system group ID, or a combination of these.

8. The communications device recited in claim 1, wherein the second partition has lower security than the first partition.

9. The communications device recited in claim 1, wherein the second partition is a subpartition of the first partition.

10. The communications device recited in claim 1, wherein, when executed by the one or more processors, the one or more instructions further cause the one or more processors to create the second partition during an installation of the at least a portion of the service processor.

11. The communications device recited in claim 1, wherein the first partition contains a symlink to the second partition.

12. The communications device recited in claim 1, wherein the first partition and the second partition are associated using one or more hooks, one or more callbacks, one or more symlinks, or based on software code instructions.

13. The communications device recited in claim 1, wherein the first partition is part of a system partition, and wherein the second partition is associated with a service provider, a carrier, a mobile virtual network operator (MVNO), or a mobile virtual network enabler (MVNE).

14. The communications device recited in claim 1, wherein the second partition is associated with a service provider, a carrier, a mobile virtual network operator (MVNO), or a mobile virtual network enabler (MVNE).

15. The communications device recited in claim 1, wherein the second partition is at least a portion of a carrier partition or at least a portion of an OEM partition.

16. The communications device recited in claim 1, wherein the second partition is at least a portion of a user partition or is at least a portion of a data partition.

17. The communications device recited in claim 1, wherein the at least a portion of the service processor is a first portion of the service processor, and wherein the one or more non-volatile memories are further capable of being partitioned into a third partition, the third partition for storing a second portion of the service processor.

18. The communications device recited in claim 17, wherein the second portion of the service processor is associated with a third security element.

19. The communications device recited in claim 17, wherein, when executed by the one or more processors, the one or more instructions further cause the one or more processors to update, install, remove, or modify the second portion of the service processor in the third partition of the one or more non-volatile memories without affecting the first portion of the service processor in the second partition.

20. The communications device recited in claim 1, wherein the at least a portion of the service processor at least assists in implementing a service policy or a service plan.

21. The communications device recited in claim 20, wherein the service policy or a service plan at least assists to manage at least an aspect of the communications device, monitor usage of a network or of a service by the communications device, account for usage of the network or of the service by the communications device, control usage of the network or of the service by the communications device, provide a notification through a user interface of the communications device, or a combination of these.

22. The communications device recited in claim 1, wherein, when executed by the one or more processors, the one or more instructions further cause the one or more processors to update or modify the at least a portion of device system software using the first security element.

23. The communications device recited in claim 1, wherein verify the integrity of the at least a portion of the service processor using the second security element comprises sign, encrypt, decrypt, or hash the at least a portion of the service processor using the second security element.

24. The communications device recited in claim 1, wherein verify the integrity of the at least a portion of the service processor using the second security element comprises verify the integrity of the at least a portion of the service processor using the second security element before, during, or after a download of the at least a portion of the service processor.

25. The communications device recited in claim 1, wherein verify the integrity of the at least a portion of the service processor using the second security element comprises verify the integrity of the at least a portion of the service processor using the second security element before, during, or after an installation of the at least a portion of the service processor.

26. The communications device recited in claim 1, wherein verify the integrity of the at least a portion of the service processor using the second security element comprises verify the integrity of the at least a portion of the service processor using the second security element before, during, or after an update of the at least a portion of the service processor.

27. The communications device recited in claim 1, wherein verify the integrity of the at least a portion of the service processor using the second security element comprises verify the integrity of the at least a portion of the service processor using the second security element before, during, or after a launch, a load, or an execution of the at least a portion of the service processor.

28. The communications device recited in claim 1, wherein update, install, remove, or modify the at least a portion of the service processor in the second partition of the one or more non-volatile memories without affecting the at least a portion of the device system software in the first partition comprises update or modify a first version of the service processor to provide a second version of the service processor without updating or modifying the system software.

29. The communications device recited in claim 1, wherein update, install, remove, or modify the at least a portion of the service processor in the second partition of the one or more non-volatile memories without affecting the at least a portion of the device system software in the first partition comprises install or remove the at least a portion of the service processor or a second portion of the service processor without updating or modifying the system software.

30. A non-transitory computer-readable storage medium storing one or more machine-executable instructions that, when executed by one or more processors of a communications device, cause the one or more processors to:
verify an integrity of at least a portion of device system software using a first security element, the at least a portion of the device system software being stored in a first partition of one or more non-volatile memories;
verify an integrity of at least a portion of a service processor using a second security element, the at least a portion of the service processor being stored in a second partition of the one or more non-volatile memories, the at least a portion of the service processor having one or more system execution properties enabling the at least a portion of the service processor to enhance or augment the device system software;
obtain the at least a portion of the service processor from the one or more non-volatile memories;
execute the obtained at least a portion of the service processor, thereby enhancing or augmenting the device system software; and
update, install, remove, or modify the at least a portion of the service processor in the second partition of the one or more non-volatile memories without affecting the at least a portion of the device system software in the first partition.
